(19) United States
(12) Patent Application Publication
(10) Pub. No.: US 2014/0156573 A1
(43) Pub. Date: Jun. 5, 2014

(54) METHODS FOR GENERATING PREDICTIVE MODELS FOR EPITHELIAL OVARIAN CANCER AND METHODS FOR IDENTIFYING EOC

(71) Applicants: Thomas Szyperski, Amherst, NY (US); Christopher Andrews, Orchard Park, NY (US); Dinesh K. Sukumaran, East Amherst, NY (US); Adekunle Odunsi, Williamsville, NY (US)

(72) Inventors: Thomas Szyperski, Amherst, NY (US); Christopher Andrews, Orchard Park, NY (US); Dinesh K. Sukumaran, East Amherst, NY (US); Adekunle Odunsi, Williamsville, NY (US)

(73) Assignee: The Research Foundation of State University of New York, Amherst, NY (US)

(21) Appl. No.: 14/234,728

(22) PCT Filed: Jul. 27, 2012
(86) PCT No.: PCT/US2012/048711

§ 371 Date: Jan. 24, 2014

Related U.S. Application Data
(60) Provisional application No. 61/512,208, filed on Jul. 27, 2011.

(51) Int. Cl. G06F 19/00

(52) U.S. Cl. CPC G06F 19/345
USPC 706/12

(57) ABSTRACT

A method for generating a model for epithelial ovarian cancer is presented, comprising the steps of obtaining a mass spectrum for each of a plurality of samples, segmenting each of the mass spectra into “bins,” and determining a plurality of relationships between two or more bins. One are more statistically significant factors are identified according to the determined plurality of relationships, and a predictive model is generated as a function of the one or more identified factors. A method of the present invention may further comprise the step of obtaining one or more nuclear magnetic resonance spectra of each of the samples, which are segmented into a plurality of bins. Combinations of mass spectra and NMR spectra may be used to determine the plurality of relationships. In other embodiments, methods for identifying the presence of EOC indicated by a biological sample of an individual are presented.

### CROSS-REFERENCE TO RELATED APPLICATIONS

This application claims priority to U.S. Provisional Application No. 61/512,208, filed on Jul. 27, 2011, now pending, the disclosure of which is incorporated herein by reference.

### FIELD OF THE INVENTION

The invention relates methods for generating and using predictive models for identifying epithelial ovarian cancer.

### BACKGROUND OF THE INVENTION

Epithelial ovarian cancer (“EOC”) remains the leading cause of death arising from gynecologic malignancies. Since most woman are diagnosed at an advanced stage (III/IV), overall survival rates remain low in spite of modest therapeutic improvements in platinum based chemotherapy following surgery. Specifically, 5-year survival rates are only about 15-20% at advanced stage, while they are >90% at stage I. Thus, it has long been recognized that early detection is the most promising approach to reduce EOC related mortality. The lack of an efficient approach to detect EOC at an early stage is particularly devastating for women of high risk EOC populations with a familial history of cancer and/or increased cancer predisposition.

### BRIEF SUMMARY OF THE INVENTION

Based on these very promising findings, we initiated a broad follow-up study to identify the best suited (combination) of different types of NMR profiles with the specific objective to discriminate both early stage EOC specimens from healthy controls, and EOC specimens from specimens obtained from women with benign ovarian tumors. The resulting three-class statistical model, which discriminates early stage EOC, benign ovarian tumor, and healthy control specimens, is pivotal for the success of an NMR-based metabonomics approach in clinical use because of the comparable high prevalence of benign ovarian tumors in both the general and high risk EOC populations.

The present invention may be embodied as a method for generating a predictive model for diagnosing epithelial ovarian cancer (“EOC”) using biological samples of a number of individuals having known disease states. The method comprises the step of obtaining a mass spectrum for each of the samples in the plurality of samples, and segmenting each of the mass spectra into “bins” along the mass-to-charge axis. The method comprises the step of determining a plurality of relationships between two or more bins or groups of bins. In an embodiment, principal component analysis (“PCA”) is used to determine a set of components which mathematically reflect the variance in the bin data. One are more statistically significant factors are identified according to the determined plurality of relationships. For example, logistic regression may be used to identify the statistically relevant components as “factors.” Principal components (“PCs”) can be added into a logistic regression prediction model, in decreasing order of their represented variability, until a new addition is not statistically significant. The method comprises the step of generating a predictive model as a function of the one or more identified factors.

A method of the present invention may further comprise the step of obtaining one or more nuclear magnetic resonance (“NMR”) frequency domain spectra of each of the samples. NMR spectra data are segmented into a plurality of bins. Combinations of one or more mass spectra and one or more NMR spectra may be used to determine the plurality of relationships. Using embodiments of the present invention, combinations of mass spectra data and NMR spectra data have been shown to have surprising improvements in predictive accuracy over the use of either modality alone. For example, the first exemplary embodiment detailed below shows significant improvements using MS with particular NMR experiments over the use of either alone.

Information on biomarker concentration and/or other covariates may also be used to generate the model, which may further improve predictive accuracy. The model generated using the training samples may be confirmed using data from additional biological samples taken from individuals.

The present invention may be embodied as a method for identifying the presence (or absence) of EOC indicated by a biological sample of an individual. The method comprises the step of receiving a pre-determined predictive model capable of predicting whether biological samples indicate the presence of EOC. The method comprises the step of obtaining a mass spectrum of the biological sample, and segmenting along the mass-to-charge axis to provide a plurality of bins. NMR spectra may be obtained of the biological sample, and in embodiments using NMR, the NMR spectra are segmented along the frequency axis (ppm) to provide a plurality of NMR bins. The method comprises the step of applying the predictive factors of the pre-determined model to the binned spectra data.

### DESCRIPTION OF THE DRAWINGS

For a fuller understanding of the nature and objects of the invention, reference should be made to the following detailed description taken in conjunction with the accompanying drawings, in which:

FIG. 1A is a table indicating the predictive accuracy of mass spectra data using named and unnamed identified metabolites using a random forest analysis;

FIG. 1B shows an importance plot of the data used in the random forest analysis of FIG. 1A;

FIG. 2A is a table indicating the predictive accuracy of mass spectra data using named metabolites only using a random forest analysis;

FIG. 2B shows an importance plot of the data used in the random forest analysis of FIG. 2A;

FIG. 3 is an exemplary cost matrix used to generate a three-class predictive model according to an embodiment of the present invention;

FIG. 4A is a 1D NOESY ¹H NMR spectrum of a serum sample from a representative control (normal) patient;

FIG. 4B is a CPMG ¹H NMR spectrum of the sample of FIG. 4A;

FIG. 4C is a 1D NOESY ¹H NMR spectrum acquired for a serum sample from a representative early stage ovarian cancer patient;

FIG. 4D is a CPMG ¹H NMR spectrum of the sample of FIG. 4C;

FIG. 5 is a score plot of the first two principal components computed from 166 Pareto-scaled 1D NOESY NMR spectra;

FIG. 6 are representative 1D ¹H CPMG (top) and NOESY (bottom) spectra recorded for a serum specimen obtained from a patient diseased with early stage EOC;

FIGS. 7A-7C are score plots of first and second principal components obtained for (7A) Training Set, (7B) Test Set, and (7C) Validation Set, wherein early stage EOC patients (‘x’) and healthy controls (‘o’) are also separated in the third and fourth components (not shown);

FIGS. 8A-8C show the probability of early stage Epithelial Ovarian Cancer (“p-EOC”) calculated for each spectrum in (8A) Training, (8B) Test, and (8C) Validation Set;

FIGS. 9A-9B show Receiver Operator Characteristic (“ROC”) Curves for the three logistic regression models built with CPMG bin arrays (“CPMG” model), NOESY bin arrays (“NOESY” model), and concatenated CPMG and NOESY bin arrays (“joint”) as obtained for the Validation Set;

FIG. 10 is a method according to an embodiment of the present invention; and

FIG. 11 is a method according to another embodiment of the present invention.

### DETAILED DESCRIPTION OF THE INVENTION

The present invention may be embodied as a method 100 for generating a predictive model for diagnosing epithelial ovarian cancer (“EOC”)—particularly, yet not exclusively, early-stage EOC. The predictive model is generated through the use of the biological samples of a number of individuals having known disease states, including individuals having EOC, individuals having benign ovarian cysts, and healthy individuals (i.e., not having EOC or benign ovarian cysts). The biological samples may be, for example, serum samples, obtained from a population of individuals.

The method 100 comprises the step of obtaining 103 a mass spectrum (e.g., quantitative data of mass-to-charge ratios) by way of mass spectrometry. A mass spectrum is obtained 103 for each of the samples in the plurality of samples. The use of mass spectrometry to obtain 103 data may include other chromatographic separation techniques , such as, for example, liquid chromatography. The spectra are formatted as is known in the art—having mass-to-charge values (i.e., “m/z” values) on an x-axis and quantitative values (e.g., intensity) along a y-axis.

Any type of mass spectrometry may be utilized to obtain 103 the spectra. For example, the three primary components of an MS apparatus—ion source, mass analyzer, ion detector—may be selected according to known criteria. The type of ion source used include be electron and chemical ionization, gas discharge (e.g., inductively coupled plasma), desorptive ionization (e.g., fast atom bombardment, plasma, laser), spray ionization (e.g., positive or negative APCI, thermospray, electrospray (ESI)), and ambient ionization (e.g., desorption electrospray ionization, MALDI). Mass analyzers include, for example, sector instruments, time-of-flight, quadrupole mass filter, ion traps (e.g., linear ion trap), and Fourier transform. Ion detectors include, for example, Faraday cup, electron multiplier, and image current. It will be recognized by one skilled in the art that MS can be coupled with other analytical techniques for analysis of samples. For example, liquid chromatography (i.e., LCMS), gas chromatography (i.e., GCMS), ion mobility (i.e., IMMS), and the like. More than one MS experiment may be used and such use of multiple experiments is within the scope of the present invention.

The method 100 comprises the step of segmenting 106 each of the mass spectra into “bins” along the mass-to-charge axis—also referred to as binning The spectra may be segmented 106 into bins having arbitrary sizes, for example, where the x-axis data is divided into a number of equally sized bins. In other embodiments, the bins may be sized in order to weight particular portions of the x-axis data or to provide increased resolution to data in particular portions of the spectra. In other embodiments, the bins may be chosen to relate to particular compounds (e.g., metabolites). For example, the mass spectra may be segmented 106 into values for each metabolite. In another example, the mass spectra is segmented 106 according to recurring peaks in the spectra (each peak need not be assigned). Other configurations of bins may be used within the scope of the present invention. The mass spectrum of each sample should be similarly segmented 106 into bins such that each spectrum has a bin configuration that is the same as the other spectra.

The method 100 comprises the step of determining 109 a plurality of relationships between two or more bins. Statistical techniques are used to determine 109 relationships between bins. For example, techniques such as principal component analysis (“PCA”) may be used to determine a set of components which mathematically reflect the variance in the bin data. Other techniques can be used to determine 109 relationships in the data, such as, for example, partial least squares (“PLS”) regression. Depending on the data reduction technique, the data (bins and values for each sample) may first be scaled and/or otherwise treated. For example, the data may be treated by centering (e.g., mean centering, etc.), autoscaling, Pareto scaling, range scaling, variable stability (“VAST”) scaling, log transformation, and power transformation. In an embodiment, the data is pretreated by mean centering and Pareto scaling before using PCA to determine a set of components. Detailed descriptions of particular statistical analyses are provide below in the exemplary embodiments.

One are more statistically significant factors are identified 112. The one or more factors are based on the plurality of relationships. For example, where PCA is used to determine components, the number of determined 106 components may be large and logistic regression (or other techniques) may be used to identify 112 the statistically relevant components as “factors.” Principal components (“PCs”) can be added into a logistic regression prediction model, in decreasing order of their represented variability, until a new addition is not statistically significant.

The method 100 comprises the step of generating 115 a predictive model as a function of the one or more identified 112 factors. Three-class models, including healthy, EOC, and benign classes of data, may be produced by first considering the classes pairwise. In other embodiments, optimal statistical decision theory techniques, such as, misclassification cost reduction, etc., may be used to generate 115 the three-class model (additional detail is provided below in the exemplary embodiments).

A method 100 of the present invention may further comprise the step of obtaining 118 one or more nuclear magnetic resonance (“NMR”) frequency domain spectra of each of the samples.

In such embodiments of the method 100, NMR frequency domain spectra data are segmented 121 into a plurality of bins. The bins may be arbitrary in size, for example, where the spectra x-axis data are divided into bins of equal size (e.g., 0.004 ppm, etc.) The data may be segmented 121 in bins of different sizes, for example, to weight certain portions of the spectra. The data may be segmented 121 into bins according to metabolites assignment.

One or more types of NMR experiments may be used to obtain 118 the NMR spectra. The NMR experiments may be one or more 1-dimensional experiments, such as NOESY, DIRE, DOSY, skyline projections of 2D spectra, CPMG, etc. The NMR experiments may additionally or alternatively be one or more 2-dimensional experiments, such as 2D ¹H J-resolved, 2D [¹H,¹H] TOCSY, 2D [¹³C,¹H] HSQC spectra, etc. Combinations of mass spectra and one or more NMR spectra may be used to determine 109 the plurality of relationships (e.g., the principal components in PCA, or relationships corresponding to other statistical techniques). Using embodiments of the present invention, combinations of mass spectra data and NMR spectra data have been shown to have surprising improvements in predictive accuracy over the use of either modality alone. For example, the first exemplary embodiment detailed below shows significant improvements using MS with particular NMR experiments over the use of either alone.

Information on biomarker concentration (e.g., leptin, prolactin, osteopontin, insulin-like growth factor 2, macrophage inhibitory factor, CA125, etc.) may also be incorporated 124 into the model to further improve predictive accuracy. Additional covariates (e.g., clinical measurements) can be included 127 in model construction and evaluation. For example, in the case of a two-class model, logistic regression can include these covariates (biomarker, clinical, etc.) in addition to the reduced spectrometer data; in the case of a three-class model, these covariates can be included as additional dimensions in the reduced data space.

The model generated 115 using the set of samples (the “training” set) may be confirmed 124 using data from additional biological samples taken from individuals having a known disease state (the “test” or “validation” set). The quality of the generated 115 model can be determined by, for example, determining a Receiver Operating Characteristic (“ROC”) curve and performing an Area Under the ROC curve (“AUC”) analysis. Other techniques may be used, for example, as described in the exemplary embodiments below.

The present invention may be embodied as a method 200 for identifying the presence (or absence) of EOC indicated by a biological sample of an individual. The method 200 may be used to identify the presence or absence of early-stage EOC. The method 200 may identify whether the biological sample indicates EOC, benign ovarian cysts, or neither (i.e., healthy). The method 200 comprises the step of receiving 203 a pre-determined predictive model capable of predicting whether a biological sample indicates the presence of EOC (i.e., the presence of EOC in individuals). The predictive model may be a three-class model, able to determine (with a statistically relevant certainty) whether the sample indicates EOC, benign ovarian cysts, or healthy. The model may have been generated using any of the aforementioned methods and variations thereof, based on segmented bins of mass spectra data and/or NMR spectra data. The model includes a set of predictive factors (factors determined to have statistical significance). The step of receiving 203 a pre-determined predictive model may include providing data about the creation of the model, including, for example, the modalities used to create the model (mass spectrometry, NMR, etc.), the bin configuration used, other data (covariants) included with the model input matrix (e.g., biomarker concentration data, age data, etc.), the type(s) statistical analysis, and/or type(s) of data pretreatment used. It should be noted that, as a pre-determined model, the steps of generating the predictive model do not necessarily make up a step of the current method 200.

The method 200 comprises the step of obtaining 206 a mass spectrum of the biological sample. The mass spectrum is segmented 209 along the mass-to-charge axis to provide a plurality of bins. The configuration of the plurality of bins should correspond with the bin configuration used to generate the pre-determined predictive model. In embodiments where the obtained 203 predictive model was generated using NMR spectra data, the method 200 comprises the step of obtaining 221 one or more NMR frequency domain spectra of the biological sample. The NMR experiments used to obtain 221 the spectra should correspond to the experiments used in generating the predictive model. The obtained 221 NMR spectra are segmented 224 along the frequency axis (ppm) to provide a plurality of NMR bins. As in the case for MS spectra, the plurality of NMR bins should correspond with the bin configuration used to generate the received 203 predictive model. It will be recognized that the bins may be represented as a matrix or a “sample vector.”

The method 200 comprises the step of applying 227 the predictive factors of the pre-determined model to the sample vector. For example, if the predictive model was generated using PCA and logistic regression, the model may be in the form of a set of principal components and Beta coefficients. The model may be multiplied 230 by the sample vector in order to generate a result corresponding to the disease state indicated by the biological sample.

### FIRST EXEMPLARY EMBODIMENT

Serum Specimens

Serum specimens were obtained from Gynecologic Oncology Group (“GOG”) protocol 136, titled “acquisition of human ovarian and other tissue specimens and serum to be used in studying the causes, diagnosis, prevention and treatment of cancer.” A first set of specimens (˜200 μL each) contained 120 samples from early stage I/II EOC patients, 91 from patients with benign tumors, and 132 from healthy women. A second set of specimens (100 μL each; “validation” set) included 50 samples from stage I/II EOC patients and 50 from healthy women. All experimental protocols were approved by the Institutional Review Board at the State University of New York at Buffalo.

Mass Spectrometry (“MS”)

MS Sample Preparation

Out of the first set of 343 specimens, 40 samples from early stage I/II EOC patients, 40 from patients with benign tumors, and 40 from healthy women were selected to acquire MS profiles. For these 120 specimens, an aliquot of 100 μL of each NMR sample was taken, frozen, and shipped to Metabolon, Inc. (Durham, N.C. USA) for MS data acquisition.

Each sample was accessioned into a Laboratory Information Management System (“LIMS”), assigned a unique identifier, and stored at −70 ° C. To remove protein, dissociate small molecules bound to protein or trapped in the precipitated protein matrix, and to recover chemically diverse metabolites, proteins were precipitated with methanol, with vigorous shaking for 2 minutes (Glen Mills Genogrinder 2000). The sample was then centrifuged, supernatant removed (MicroLab STAR® robotics), and split into equal volumes for analysis on the LC+, LC−, and GC platforms; one aliquot was retained for backup analysis, if needed.

Liquid Chromatography/Mass Spectrometry (“LC/MS/MS”) and Gas Chromatography/Mass Spectrometry (“GC/MS”)

The LC/MS/MS portion of the platform incorporated a Waters Acquity UPLC system and a Thermo-Finnigan LTQ mass spectrometer, including an electrospray ionization (“ESI”) source and linear ion-trap (“LIT”) mass analyzer. Aliquots of the vacuum-dried sample were reconstituted, one each in acidic or basic LC-compatible solvents containing 8 or more injection standards at fixed concentrations (to both ensure injection and chromatographic consistency). Extracts were loaded onto columns (Waters UPLC BEH C18-2.1×100 mm, 1.7 μm) and gradient-eluted with water and 95% methanol containing 0.1% formic acid (acidic extracts) or 6.5 mM ammonium bicarbonate (basic extracts). Samples for GC/MS analysis were dried under vacuum desiccation for a minimum of 18 hours prior to being derivatized under nitrogen using bistrimethyl-silyl-trifluoroacetamide (“BSTFA”). The GC column was 5% phenyl dimethyl silicone and the temperature ramp was from 60° to 340° C. in a 17 minute period. All samples were then analyzed on a Thermo-Finnigan Trace DSQ fast-scanning single-quadrupole mass spectrometer using electron impact ionization. The instrument was tuned and calibrated for mass resolution and mass accuracy daily.

Quality Control (“QC”)

All columns and reagents were purchased in bulk from a single lot to complete all related experiments. For monitoring of data quality and process variation, multiple replicates of a pool of human plasma were injected throughout the run, interspersed among the experimental samples in order to serve as technical replicates for calculation of precision. In addition, process blanks and other quality control samples were spaced evenly among the injections for each day, and all experimental samples were randomly distributed throughout each day's run. In a preliminary human plasma sample analysis, median relative standard deviation (“RSD”) was 13% for technical replicates and 9% for internal standards.

Bioinformatics

The LIMS system encompassed sample accessioning, preparation, instrument analysis and reporting, and advanced data analysis. Additional informatics components included: data extraction into a relational database and peak-identification software; proprietary data processing tools for QC and compound identification; and a collection of interpretation and visualization tools for use by data analysts. The hardware and software systems were built on a web-service platform utilizing Microsoft's .NET technologies which run on high-performance application servers and fiber-channel storage arrays in clusters to provide active failover and load-balancing.

Compound Identification, Quantification, and Data Curation

Biochemicals were identified by comparison to library entries of purified standards. More than 2400 commercially available purified standards were registered into LIMS for distribution to both the LC and GC platforms for determination of their analytical characteristics. Chromatographic properties and mass spectra allowed matching to the specific compound or an isobaric entity using visualization and interpretation software. Additional recurring entities may be identified as needed via acquisition of a matching purified standard or by classical structural analysis. Peaks were quantified using area under the curve. Subsequent QC and curation processes were designed to ensure accurate, consistent identification, and to minimize system artifacts, mis-assignments, and background noise. Library matches for each compound are verified for each sample.

MS Statistical Analysis

Missing values (if any) were assumed to be below the level of detection. Given the multiple comparisons inherent in analysis of metabolites, between-group relative differences were assessed using both Student's t-tests (p-value) and false discovery rate analysis (q-value). Pathways were assigned for each metabolite, also allowing examination of overrepresented pathways. Initial classification utilized random forest analyses, providing estimate of ability to classify individuals in a new data set. A set of classification trees, based on continual sampling of the experimental units and compounds, was created, and each observation was classified based on the majority votes from all classification trees.

Validation and Absolute Quantification

Selected biomarker candidates obtained from analysis can be further validated by targeted fully quantitative assays using LC/MS/MS (triple stage quadruple MS) and/or GC/MS. Quantitation was performed against calibration standards that cover an appropriate calibration range. Stable isotopically-labeled forms of the analytes were used as internal standards where commercially available (Isotope Dilution MS).

MS Results

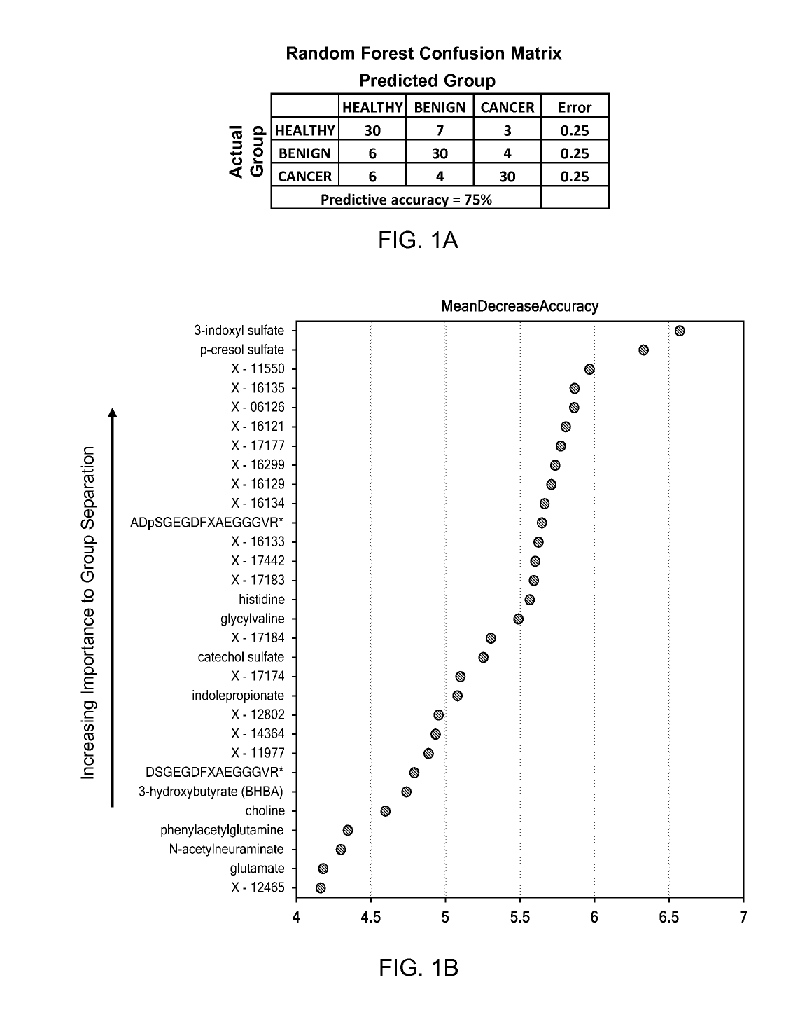

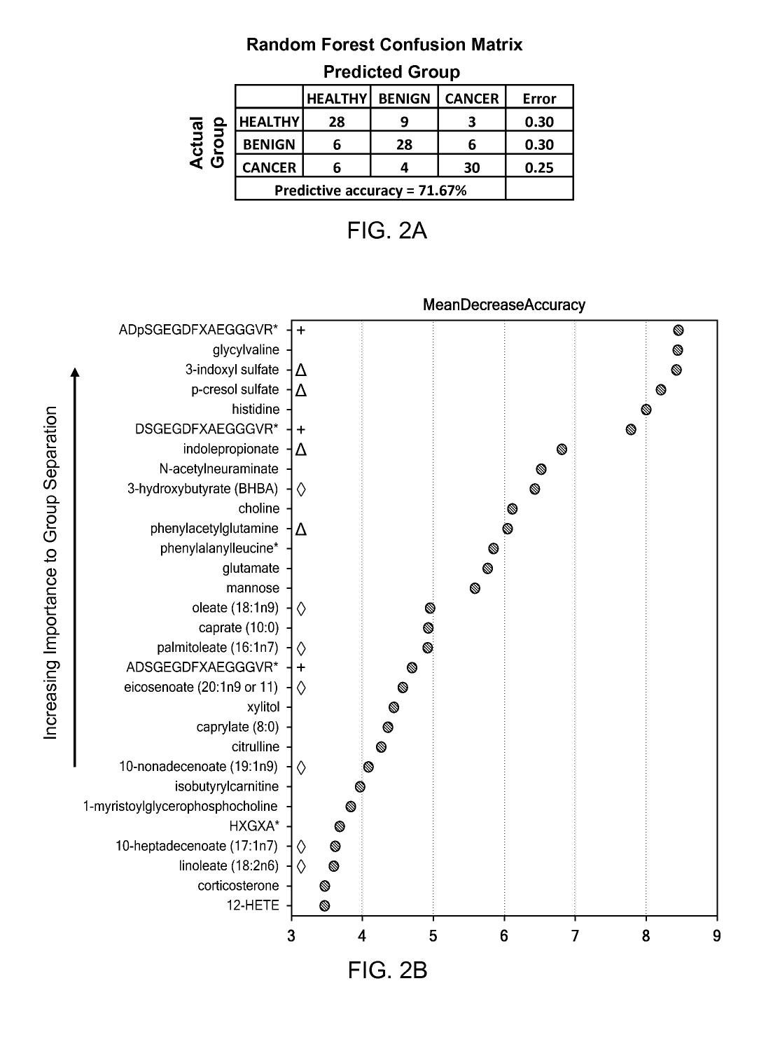

MS results are provided in Table 1, which provides average serum concentration ratios of metabolites, lipids, and macromolecular components. In Table 1, the ‘↑’ symbol indicates values that are significantly higher (p≦0.05) for the respective comparison and ‘↓’ indicates values that are significantly lower. Bolded values indicate 0.05<p<0.10. Random forest analysis resulted in a predictive accuracy of 75% for classification of samples across three serum groups (compared to 33% by random chance alone) using named and unnamed detected metabolites (see FIG. 1A). The importance plot of FIG. 1B ranks metabolites by strength of contribution to the classification. Random forest analysis resulted in a predictive accuracy of 71.67% for classification of samples across three serum groups using only named metabolites (see FIG. 2A). In FIG. 2B, ‘Δ’ indicates gut microflora-related metabolites; ‘⋄’ indicates lipolysis and FA metabolism; and ‘+’ indicates fibrinogen cleavage peptides.

TABLE 1
Ratios of average serum concentrations of metabolites,
lipids, and macromolecular components derived by MS

| | | | | Statistical Value | | |
|---|---|---|---|---|---|---|
| | | | | Welch's | | |
| | Fold of Change | | | Two-Sample t-Test | | |
| | Benign | Cancer | Cancer | B/H | C/H | C/B |
| BIOCHEMICAL NAME | Healthy | Healthy | Benign | p-Value | p-Value | p-Value |
| glycine | 0.89 | 0.88 | 0.99 | 0.1585 | 0.1192 | 0.8520 |
| dimethylglycine | 0.90 | 1.02 | 1.13 | 0.3830 | 0.4306 | 0.0614 |
| N-acetylglycine | 1.41↑ | 1.40 | 0.99 | 0.0261 | 0.1958 | 0.3871 |
| beta-hydroxypyruvate | 1.01 | 1.09 | 1.08 | 0.9173 | 0.3905 | 0.4494 |
| serine | 1.03 | 1.01 | 0.98 | 0.5906 | 0.8558 | 0.7193 |
| N-acetylserine | 1.06 | 1.08 | 1.02 | 0.5865 | 0.4315 | 0.8163 |
| threonine | 0.87↓ | 0.80↓ | 0.92 | 0.0426 | 0.0026 | 0.3403 |
| N-acetylthreonine | 0.93 | 0.88 | 0.94 | 0.2034 | 0.0724 | 0.6802 |
| betaine | 0.91 | 1.22↑ | 1.33↑ | 0.2364 | 0.0074 | <0.001 |
| aspartate | 1.15 | 0.95 | 0.82↓ | 0.0633 | 0.2470 | 0.0075 |
| asparagine | 0.95 | 0.90 | 0.96 | 0.3068 | 0.0640 | 0.2993 |
| beta-alanine | 0.68↓ | 0.72↓ | 1.05 | 0.0175 | 0.0387 | 0.7984 |
| N-acetyl-beta-alanine | 0.63↓ | 0.82 | 1.30↓ | <0.001 | 0.1806 | 0.0366 |
| alanine | 0.82↓ | 0.66↓ | 0.81↓ | 0.0162 | <0.001 | 0.0039 |
| glutamate | 1.48↑ | 1.24↑ | 0.84↓ | <0.001 | 0.0054 | 0.0178 |
| glutamine | 0.89↓ | 0.89↓ | 1.00 | 0.0043 | 0.0015 | 0.8624 |
| pyroglutamine* | 1.14 | 1.06 | 0.93 | 0.6240 | 0.6920 | 0.8990 |
| histidine | 0.85↓ | 0.71↓ | 0.84↓ | <0.001 | <0.001 | <0.001 |
| trans-urocanate | 0.85 | 0.89 | 1.05 | 0.8591 | 0.6281 | 0.6823 |
| lysine | 1.00 | 0.84↓ | 0.84↓ | 0.7722 | <0.001 | 0.0028 |
| pipecolate | 0.87 | 0.60↓ | 0.69 | 0.0829 | <0.001 | 0.0752 |
| N6-acetyllysine | 1.05 | 1.02 | 0.97 | 0.3431 | 0.8615 | 0.4799 |
| glutaroyl carnitine | 1.05 | 0.97 | 0.93 | 0.6360 | 0.5533 | 0.3048 |
| phenyllactate (PLA) | 0.87 | 0.86 | 0.98 | 0.2109 | 0.0502 | 0.4255 |
| phenylalanine | 1.07 | 0.87↓ | 0.81↓ | 0.2977 | 0.0133 | <0.001 |
| phenylacetate | 0.61↓ | 0.64↓ | 1.06 | <0.001 | <0.001 | 0.8010 |
| p-cresol sulfate | 0.18↓ | 0.21↓ | 1.20 | <0.001 | <0.001 | 0.9211 |
| tyrosine | 0.87 | 0.79↓ | 0.91 | 0.0559 | <0.001 | 0.0606 |
| 3-(4-hydroxyphenyl)lactate | 0.90 | 0.82↓ | 0.92 | 0.1769 | 0.0130 | 0.2469 |
| 4-hydroxyphenylacetate | 0.78 | 0.68 | 0.87 | 0.1866 | 0.0519 | 0.5457 |
| 3-methoxytyrosine | 2.39 | 1.08 | 0.45 | 0.3201 | 0.4779 | 0.5944 |
| phenylacetylglutamine | 0.36↓ | 0.30↓ | 0.85 | <0.001 | <0.001 | 0.0986 |
| 3-(3-hydroxyphenyl)propionate | 0.84 | 0.81 | 0.96 | 0.1912 | 0.1029 | 0.7041 |
| 3-phenylpropionate (hydrocinnamate) | 0.50↓ | 0.38↓ | 0.75↓ | 0.0088 | <0.001 | 0.0081 |
| phenol sulfate | 0.78 | 0.54↓ | 0.70↓ | 0.2481 | 0.0012 | 0.0240 |
| kynurenate | 0.84 | 0.92 | 1.10 | 0.1094 | 0.3755 | 0.5041 |
| kynurenine | 0.87 | 0.87 | 1.00 | 0.0544 | 0.0580 | 0.9729 |
| tryptophan | 0.82↓ | 0.70↓ | 0.85↓ | 0.0022 | <0.001 | 0.0088 |
| indolelactate | 0.68↓ | 0.63↓ | 0.93 | <0.001 | <0.001 | 0.4081 |
| indoleacetate | 0.79↓ | 0.61↓ | 0.78 | 0.0014 | <0.001 | 0.0623 |
| tryptophan betaine | 0.89 | 0.61 | 0.69 | 0.7546 | 0.0725 | 0.1153 |
| serotonin (5HT) | 1.32 | 0.80 | 0.61↓ | 0.0849 | 0.0713 | 0.0011 |
| N-acetyltryptophan | 1.00 | 1.00 | 1.00 | | | |
| C-glycosyltryptophan* | 1.29↑ | 1.29↑ | 1.00 | <0.001 | <0.001 | 0.7851 |
| 3-indoxyl sulfate | 0.30↓ | 0.25↓ | 0.83↓ | <0.001 | <0.001 | 0.0348 |
| indolepropionate | 0.40↓ | 0.31↓ | 0.78 | <0.001 | <0.001 | 0.1407 |
| 3-methyl-2-oxobutyrate | 1.19↑ | 1.00 | 0.84↓ | 0.0207 | 0.9729 | 0.0193 |
| 3-methyl-2-oxovalerate | 0.96 | 0.94 | 0.98 | 0.3370 | 0.1961 | 0.7618 |
| levulinate (4-oxovalerate) | 0.90 | 0.85↓ | 0.95 | 0.1540 | 0.0276 | 0.3836 |
| beta-hydroxyisovalerate | 1.16 | 1.37↑ | 1.19 | 0.3789 | 0.0089 | 0.1269 |
| isoleucine | 0.98 | 1.04 | 1.06 | 0.8129 | 0.7679 | 0.6056 |
| leucine | 1.01 | 0.96 | 0.95 | 0.7581 | 0.3786 | 0.2343 |
| valine | 0.96 | 0.90↓ | 0.93 | 0.4622 | 0.0304 | 0.1037 |
| 2-hydroxyisobutyrate | 1.11 | 0.90 | 0.81↓ | 0.3523 | 0.0859 | 0.0216 |
| 3-hydroxyisobutyrate | 1.08 | 0.97 | 0.90 | 0.8795 | 0.5312 | 0.4663 |
| 4-methyl-2-oxopentanoate | 0.96 | 0.84↓ | 0.88 | 0.2992 | 0.0104 | 0.2324 |
| alpha-hydroxyisovalerate | 1.12 | 1.11 | 1.00 | 0.2276 | 0.4114 | 0.7682 |
| isobutyrylcarnitine | 0.52↓ | 0.49↓ | 0.94 | <0.001 | <0.001 | 0.5003 |
| 2-methylbutyroylcarnitine | 0.84 | 0.86 | 1.03 | 0.1842 | 0.2931 | 0.7371 |
| isovalerylcarnitine | 0.91 | 0.80↓ | 0.88 | 0.4335 | 0.0257 | 0.1003 |
| hydroxyisovaleroyl carnitine | 0.98 | 1.31↑ | 1.34↑ | 0.8432 | 0.0331 | 0.0224 |
| tiglyl carnitine | 0.87 | 0.75↓ | 0.86 | 0.2212 | 0.0038 | 0.0620 |
| methylglutaroylcarnitine | 0.89 | 0.83 | 0.92 | 0.5020 | 0.4488 | 0.9608 |
| cysteine | 0.95 | 0.88 | 0.94 | 0.8395 | 0.4561 | 0.5644 |
| S-methylcysteine | 0.94 | 0.93 | 1.00 | 0.3334 | 0.3034 | 0.9485 |
| N-formylmethionine | 0.97 | 0.91 | 0.94 | 0.7028 | 0.1352 | 0.2297 |
| methionine | 0.91↓ | 0.84↓ | 0.92 | 0.0363 | <0.001 | 0.0701 |
| N-acetylmethionine | 1.04 | 1.29↑ | 1.24↑ | 0.9375 | 0.0227 | 0.0418 |
| alpha-ketobutyrate | 1.20 | 1.52↑ | 1.27 | 0.6013 | 0.0273 | 0.1236 |
| 2-hydroxybutyrate (AHB) | 1.78↑ | 1.87↑ | 1.05 | <0.001 | <0.001 | 0.7122 |
| dimethylarginine (SDMA + ADMA) | 1.07 | 1.10 | 1.02 | 0.1730 | 0.1432 | 0.7986 |
| arginine | 0.88↓ | 0.86↓ | 0.98 | 0.0128 | 0.0078 | 0.8289 |
| ornithine | 1.49↑ | 1.13 | 0.76↓ | 0.0075 | 0.4685 | 0.0474 |
| urea | 0.68↓ | 0.57↓ | 0.83 | <0.001 | <0.001 | 0.2689 |
| proline | 0.94 | 0.82↓ | 0.87 | 0.4580 | 0.0118 | 0.0567 |
| citrulline | 0.77↓ | 0.66↓ | 0.87 | <0.001 | <0.001 | 0.0589 |
| N-acetylornithine | 0.85 | 0.80 | 0.94 | 0.1699 | 0.0533 | 0.5626 |
| N-methyl proline | 0.83 | 0.95 | 1.15 | 0.0546 | 0.0900 | 0.8761 |
| trans-4-hydroxyproline | 1.19 | 1.05 | 0.88 | 0.1415 | 0.8363 | 0.1437 |
| creatine | 0.88 | 1.04 | 1.18 | 0.2995 | 0.5937 | 0.1000 |
| creatinine | 1.08 | 1.05 | 0.98 | 0.1607 | 0.4834 | 0.5895 |
| 2-aminobutyrate | 1.00 | 1.16 | 1.16 | 0.8086 | 0.3714 | 0.3065 |
| 4-acetamidobutanoate | 1.00 | 0.97 | 0.97 | 0.8497 | 0.5961 | 0.7580 |
| 5-oxoproline | 1.19 | 0.92 | 0.78↓ | 0.0702 | 0.1212 | 0.0037 |
| glycylvaline | 1.20 | 0.56↓ | 0.46↓ | 0.1420 | <0.001 | <0.001 |
| glycylphenylalanine | 0.68↓ | 0.85 | 1.25 | <0.001 | 0.0997 | 0.0571 |
| aspartylphenylalanine | 0.85 | 1.19 | 1.39↑ | 0.1240 | 0.4389 | 0.0288 |
| leucylleucine | 1.06 | 0.99 | 0.93 | 0.3650 | 0.7179 | 0.5495 |
| pro-hydroxy-pro | 1.07 | 1.17↓ | 1.09 | 0.4692 | 0.0483 | 0.2399 |
| threonylphenylalanine | 0.98 | 1.03 | 1.06 | 0.6102 | 0.4790 | 0.2228 |
| phenylalanylphenylalanine | 0.86 | 1.00 | 1.16 | 0.2147 | 0.9685 | 0.2133 |
| pyroglutamylglycine | 1.18 | 1.05 | 0.89 | 0.1159 | 0.5470 | 0.2957 |
| cyclo(leu-pro) | 0.66↓ | 0.60↓ | 0.91 | 0.0091 | 0.0014 | 0.4984 |
| aspartylleucine | 1.62↑ | 1.18 | 0.73 | 0.0046 | 0.2098 | 0.0902 |
| leucylalanine | 0.92 | 1.03 | 1.11 | 0.2311 | 0.5384 | 0.0704 |
| leucylglycine | 1.29 | 1.08 | 0.83 | 0.8489 | 0.5519 | 0.5060 |
| leucylphenylalanine | 0.50↓ | 0.57↓ | 1.15 | <0.001 | 0.0021 | 0.1731 |
| phenylalanylleucine* | 0.69↓ | 1.17 | 1.70↑ | <0.001 | 0.5421 | <0.001 |
| phenylalanylserine | 0.64↓ | 0.87 | 1.36 | <0.001 | 0.1176 | 0.0888 |
| serylleucine | 1.41 | 0.98 | 0.69↓ | 0.0509 | 0.6816 | 0.0268 |
| gamma-glutamylvaline | 1.20 | 0.97 | 0.81 | 0.2452 | 0.4911 | 0.0919 |
| gamma-glutamylleucine | 1.09 | 0.98 | 0.90 | 0.4242 | 0.5450 | 0.1964 |
| gamma-glutamylisoleucine* | 1.09 | 1.12 | 1.03 | 0.5493 | 0.3182 | 0.7128 |
| gamma-glutamylmethionine | 0.85↓ | 0.86↓ | 1.01 | 0.0260 | 0.0273 | 0.8197 |
| gamma-glutamylglutamate | 1.37↑ | 1.52↑ | 1.11 | 0.0156 | 0.0197 | 0.8506 |
| gamma-glutamylglutamine | 0.76↓ | 0.88 | 1.16↑ | <0.001 | 0.0630 | 0.0298 |
| gamma-glutamylphenylalanine | 1.10 | 0.89 | 0.81 | 0.6220 | 0.1954 | 0.1158 |
| gamma-glutamyltyrosine | 0.88 | 0.82 | 0.94 | 0.4381 | 0.0782 | 0.1932 |
| gamma-glutamylalanine | 0.64↓ | 0.60↓ | 0.95 | <0.001 | <0.001 | 0.4911 |
| bradykinin, des-arg(9) | 2.15 | 1.30 | 0.60 | 0.7292 | 0.3424 | 0.6513 |
| HXGXA* | 2.09↑ | 2.40↑ | 1.15 | <0.001 | <0.001 | 0.2570 |
| HWESASXX* | 1.79↑ | 1.63↑ | 0.91 | 0.0220 | <0.001 | 0.3218 |
| ADSGEGDFXAEGGGVR* | 1.20 | 1.98↑ | 1.64↑ | 0.2968 | <0.001 | <0.001 |
| DSGEGDFXAEGGGVR* | 1.00 | 4.51↑ | 4.52↑ | 0.7425 | <0.001 | <0.001 |
| ADpSGEGDFXAEGGGVR* | 1.26 | 3.05↑ | 2.42↑ | 0.9506 | <0.001 | <0.001 |
| erythronate* | 1.10 | 0.89 | 0.81↓ | 0.3029 | 0.0776 | 0.0118 |
| N-acetylneuraminate | 1.38↑ | 1.84↑ | 1.34↑ | <0.001 | <0.001 | 0.0012 |
| fucose | 1.02 | 1.03 | 1.02 | 0.8184 | 0.7047 | 0.8797 |
| fructose | 0.84 | 0.83 | 0.98 | 0.2269 | 0.1203 | 0.5977 |
| maltose | 1.15 | 1.97↑ | 1.71 | 0.2277 | 0.0491 | 0.3139 |
| mannitol | 0.67 | 1.15 | 1.71 | 0.8434 | 0.1269 | 0.1740 |
| mannose | 1.54↑ | 1.80↑ | 1.17 | <0.001 | <0.001 | 0.0761 |
| sorbitol | 1.38↑ | 1.02 | 0.74 | 0.0484 | 0.9458 | 0.0637 |
| methyl-beta-glucopyranoside | 1.04 | 1.02 | 0.98 | 0.7703 | 0.6084 | 0.8344 |
| 1,5-anhydroglucitol (1,5-AG) | 0.92 | 1.04 | 1.14 | 0.2983 | 0.4002 | 0.0873 |
| glycerate | 0.88 | 0.80↓ | 0.91 | 0.1720 | 0.0346 | 0.5030 |
| glucose | 1.23↑ | 1.21↑ | 0.99 | 0.0013 | <0.001 | 0.9706 |
| 1,6-anhydroglucose | 0.45↓ | 0.50↓ | 1.11 | <0.001 | <0.001 | 0.9454 |
| pyruvate | 1.08 | 0.97 | 0.89 | 0.6356 | 0.9095 | 0.6788 |
| lactate | 1.28↑ | 1.08 | 0.84 | 0.0132 | 0.3186 | 0.1030 |
| oxalate (ethanedioate) | 0.61↓ | 0.62↓ | 1.02 | 0.0017 | 0.0032 | 0.7921 |
| threitol | 1.09 | 0.88 | 0.81↓ | 0.3482 | 0.3076 | 0.0434 |
| gluconate | 1.22 | 40.08↑ | 32.91 | 0.0714 | 0.0320 | 0.1311 |
| ribose | 1.28 | 0.89 | 0.70 | 0.3669 | 0.2819 | 0.0788 |
| ribulose | 1.62↑ | 1.17 | 0.72 | 0.0103 | 0.5611 | 0.0562 |
| xylitol | 2.55↑ | 2.62↑ | 1.02 | <0.001 | <0.001 | 0.9406 |
| arabinose | 0.85 | 1.07 | 1.25 | 0.4357 | 0.5432 | 0.1562 |
| xylose | 0.67 | 0.74 | 1.11 | 0.3041 | 0.3900 | 0.8941 |
| xylulose | 1.84↑ | 2.32↑ | 1.26 | <0.001 | <0.001 | 0.2938 |
| citrate | 1.14 | 0.88 | 0.77↓ | 0.1774 | 0.0596 | 0.0041 |
| alpha-ketoglutarate | 1.26 | 0.83 | 0.66 | 0.0867 | 0.8192 | 0.1131 |
| succinate | 1.98↑ | 1.73↑ | 0.88 | <0.001 | 0.0476 | 0.1987 |
| succinylcarnitine | 1.16 | 1.00 | 0.86 | 0.0868 | 0.9117 | 0.0863 |
| fumarate | 0.99 | 0.89 | 0.90 | 0.7345 | 0.1148 | 0.2500 |
| malate | 1.13 | 0.85↓ | 0.76↓ | 0.1575 | 0.0342 | 0.0015 |
| acetylphosphate | 0.95 | 0.89↓ | 0.94 | 0.1596 | 0.0128 | 0.4447 |
| phosphate | 0.95 | 0.89↓ | 0.93 | 0.2685 | 0.0198 | 0.2773 |
| pyrophosphate (PPi) | 1.01 | 0.86↓ | 0.85 | 0.4440 | 0.0291 | 0.3356 |
| linoleate (18:2n6) | 1.34↑ | 1.43↑ | 1.07 | <0.001 | <0.001 | 0.4199 |
| linolenate [alpha or gamma; (18:3n3 or 6)] | 1.28↑ | 1.38↑ | 1.08 | 0.0080 | 0.0027 | 0.5394 |
| dihomo-linolenate (20:3n3 or n6) | 1.27↑ | 1.04 | 0.82↓ | <0.001 | 0.4297 | 0.0025 |
| eicosapentaenoate (EPA; 20:5n3) | 1.00 | 0.90 | 0.90 | 0.9616 | 0.1762 | 0.1668 |
| docosapentaenoate (n3 DPA; 22:5n3) | 1.26↑ | 1.25↑ | 1.00 | 0.0126 | 0.0182 | 0.9236 |
| docosapentaenoate (n6 DPA; 22:5n6) | 1.09 | 0.72↓ | 0.66↓ | 0.9291 | 0.0106 | 0.0243 |
| docosahexaenoate (DHA; 22:6n3) | 1.03 | 0.99 | 0.96 | 0.5886 | 0.9468 | 0.5342 |
| valerate | 1.05 | 0.93 | 0.89 | 0.7735 | 0.4230 | 0.6487 |
| isocaproate | 1.28↑ | 1.46↑ | 1.14 | 0.0153 | 0.0017 | 0.3596 |
| caproate (6:0) | 0.83↓ | 0.79↓ | 0.95 | 0.0053 | <0.001 | 0.5547 |
| heptanoate (7:0) | 0.81↓ | 0.78↓ | 0.95 | 0.0087 | 0.0014 | 0.3173 |
| caprylate (8:0) | 0.65↓ | 0.67↓ | 1.03 | <0.001 | <0.001 | 0.8942 |
| pelargonate (9:0) | 0.82↓ | 0.79↓ | 0.95 | 0.0086 | 0.0013 | 0.3825 |
| caprate (10:0) | 0.75↓ | 0.70↓ | 0.93 | <0.001 | <0.001 | 0.2299 |
| undecanoate (11:0) | 1.01 | 0.96 | 0.95 | 0.9893 | 0.5182 | 0.5413 |
| 10-undecenoate (11:1n1) | 0.96 | 0.74↓ | 0.76↓ | 0.8102 | 0.0069 | 0.0097 |
| laurate (12:0) | 0.89 | 0.88 | 0.98 | 0.4016 | 0.2878 | 0.7853 |
| 5-dodecenoate (12:1n7) | 1.07 | 1.01 | 0.94 | 0.1353 | 0.8387 | 0.1847 |
| myristate (14:0) | 1.17↑ | 1.10 | 0.94 | 0.0189 | 0.1281 | 0.3356 |
| myristoleate (14:1n5) | 1.31↑ | 1.19↑ | 0.91 | 0.0020 | 0.0361 | 0.2162 |
| pentadecanoate (15:0) | 1.07 | 1.12 | 1.04 | 0.2844 | 0.2615 | 0.8788 |
| palmitate (16:0) | 1.33↑ | 1.30↑ | 0.98 | <0.001 | <0.001 | 0.6600 |
| palmitoleate (16:1n7) | 1.70↑ | 1.61↑ | 0.95 | <0.001 | <0.001 | 0.2996 |
| margarate (17:0) | 1.41↑ | 1.32↑ | 0.93 | <0.001 | <0.001 | 0.2100 |
| 10-heptadecenoate (17:1n7) | 1.70↑ | 1.53↑ | 0.90 | <0.001 | <0.001 | 0.1652 |
| stearate (18:0) | 1.24↑ | 1.20↑ | 0.97 | <0.001 | 0.0013 | 0.4611 |
| oleate (18:1n9) | 1.70↑ | 1.71↑ | 1.00 | <0.001 | <0.001 | 0.7465 |
| cis-vaccenate (18:1n7) | 1.61↑ | 1.51↑ | 0.94 | <0.001 | 0.0015 | 0.3195 |
| stearidonate (18:4n3) | 1.17 | 0.93 | 0.79 | 0.2099 | 0.8814 | 0.1260 |
| nonadecanoate (19:0) | 1.22↑ | 1.22↑ | 1.00 | 0.0015 | 0.0047 | 0.8890 |
| 10-nonadecenoate (19:1n9) | 1.72↑ | 1.59↑ | 0.93 | <0.001 | <0.001 | 0.2654 |
| eicosenoate (20:1n9 or 11) | 1.78↑ | 1.82↑ | 1.02 | <0.001 | <0.001 | 0.9651 |
| dihomo-linoleate (20:2n6) | 1.52↑ | 1.53↑ | 1.00 | <0.001 | <0.001 | 0.8969 |
| arachidonate (20:4n6) | 1.19↑ | 0.98 | 0.82↓ | 0.0054 | 0.6844 | 0.0016 |
| docosadienoate (22:2n6) | 1.47↑ | 1.49↑ | 1.02 | <0.001 | <0.001 | 0.8911 |
| adrenate (22:4n6) | 1.21↑ | 1.04 | 0.86↓ | 0.0087 | 0.6068 | 0.0376 |
| palmitate, methyl ester | 1.07 | 0.76↓ | 0.72 | 0.1407 | 0.0329 | 0.8053 |
| 3-hydroxydecanoate | 1.14 | 1.09 | 0.96 | 0.0822 | 0.3587 | 0.4270 |
| 16-hydroxypalmitate | 1.18 | 1.29↑ | 1.09 | 0.0747 | 0.0048 | 0.3077 |
| 2-hydroxystearate | 0.89 | 0.85↓ | 0.95 | 0.0564 | 0.0075 | 0.3791 |
| 2-hydroxypalmitate | 0.99 | 1.00 | 1.01 | 0.4294 | 0.8817 | 0.5288 |
| 3-hydroxysebacate | 1.40 | 2.18↑ | 1.56 | 0.0886 | 0.0021 | 0.1231 |
| 13-NODE + 9-NODE | 1.14↑ | 1.28↑ | 1.12 | 0.0493 | 0.0107 | 0.3737 |
| adipate | 1.87↑ | 2.02↑ | 1.08 | 0.0460 | 0.0026 | 0.3493 |
| 2-hydroxyglutarate | 0.91 | 1.02 | 1.13 | 0.3002 | 0.4516 | 0.8587 |
| sebacate (decanedioate) | 6.83↑ | 4.10↑ | 0.60 | 0.0081 | <0.001 | 0.2727 |
| azelate (nonanedioate) | 1.53 | 3.24 | 2.13 | 0.6228 | 0.3683 | 0.6329 |
| dodecanedioate | 0.72↓ | 0.97 | 1.35↑ | 0.0102 | 0.8978 | 0.0155 |
| tetradecanedioate | 0.77 | 1.00 | 1.29 | 0.8384 | 0.7637 | 0.6116 |
| hexadecanedioate | 1.06↑ | 1.45↑ | 1.37 | 0.0217 | 0.0011 | 0.1359 |
| octadecanedioate | 1.19 | 1.48↑ | 1.24 | 0.0673 | 0.0018 | 0.1105 |
| undecanedioate | 0.86 | 1.86 | 2.17 | 0.1527 | 0.6028 | 0.0830 |
| 3-carboxy-4-methyl-5-propyl-2- | 0.58↓ | 0.95 | 1.62 | 0.0486 | 0.4591 | 0.2623 |
| furanpropanoate (CMPF) | | | | | | |
| 15-methylpalmitate (isobar with 2- | 1.14↑ | 1.07 | 0.94 | 0.0289 | 0.2127 | 0.3014 |
| methylpalmitate) | | | | | | |
| 17-methylstearate | 1.40↑ | 1.22↑ | 0.87↓ | <0.001 | 0.0181 | 0.0448 |
| 12-HETE | 2.70↑ | 4.26↑ | 1.58 | <0.001 | <0.001 | 0.2354 |
| propionylcarnitine | 0.63↓ | 0.67↓ | 1.06 | <0.001 | 0.0022 | 0.9146 |
| butyrylcarnitine | 0.97 | 1.07 | 1.10 | 0.8234 | 0.9775 | 0.8564 |
| isovalerate | 0.81↓ | 0.90 | 1.12 | 0.0019 | 0.0183 | 0.7825 |
| deoxycarnitine | 0.87↓ | 0.87↓ | 1.00 | 0.0140 | 0.0158 | 0.9596 |
| carnitine | 1.03 | 0.95 | 0.92↓ | 0.2835 | 0.2230 | 0.0254 |
| 3-dehydrocarnitine* | 0.84↓ | 0.75↓ | 0.90 | 0.0307 | <0.001 | 0.1647 |
| acetylcarnitine | 1.27↑ | 1.36↑ | 1.07 | <0.001 | <0.001 | 0.6856 |
| hexanoylcarnitine | 1.02 | 1.01 | 0.99 | 0.3947 | 0.8194 | 0.5499 |
| octanoylcarnitine | 0.72 | 0.55↓ | 0.76 | 0.1665 | 0.0027 | 0.0570 |
| decanoylcarnitine | 0.56↓ | 0.44↓ | 0.78 | 0.0216 | 0.0018 | 0.4101 |
| cis-4-decenoyl carnitine | 0.75 | 0.64↓ | 0.85 | 0.1334 | 0.0245 | 0.3830 |
| laurylcarnitine | 0.67 | 0.74 | 1.10 | 0.1249 | 0.2694 | 0.6248 |
| palmitoylcarnitine | 1.03 | 1.25 | 1.21 | 0.8303 | 0.1438 | 0.2176 |
| stearoylcarnitine | 0.89 | 1.00 | 1.13 | 0.3284 | 0.8971 | 0.4234 |
| oleoylcarnitine | 1.04 | 1.10 | 1.06 | 0.4748 | 0.5323 | 0.9783 |
| cholate | 0.34 | 0.36↓ | 1.04 | 0.0723 | 0.0131 | 0.3135 |
| glycocholate | 0.81 | 0.44↓ | 0.55 | 0.2169 | 0.0042 | 0.1146 |
| taurocholate | 1.19 | 0.52↓ | 0.43↓ | 0.6450 | 0.0039 | 0.0287 |
| glycodeoxycholate | 0.55↓ | 0.54↓ | 0.97 | 0.0084 | 0.0035 | 0.7448 |
| 7-ketodeoxycholate | 1.00 | 1.00 | 1.00 | | | |
| glycochenodeoxycholate | 0.88 | 0.68↓ | 0.78 | 0.2389 | 0.0147 | 0.2298 |
| glycolithocholate sulfate* | 0.98 | 0.65↓ | 0.66 | 0.0803 | 0.0117 | 0.6552 |
| taurolithocholate 3-sulfate | 1.09 | 0.66↓ | 0.61 | 0.9541 | 0.0414 | 0.0514 |
| glycocholenate sulfate* | 1.29 | 1.28 | 0.99 | 0.1724 | 0.2948 | 0.7292 |
| taurocholenate sulfate* | 1.38 | 1.40 | 1.01 | 0.2514 | 0.1175 | 0.7304 |
| glycoursodeoxycholate | 1.19 | 1.29↑ | 1.09 | 0.0783 | 0.0038 | 0.3417 |
| glycerol | 1.41↑ | 1.37↑ | 0.97 | <0.001 | 0.0020 | 0.4663 |
| choline | 1.51↑ | 1.21↑ | 0.80↓ | <0.001 | 0.0300 | 0.0020 |
| glycerol 3-phosphate (G3P) | 1.44 | 0.79↓ | 0.55 | 0.8088 | 0.0012 | 0.0581 |
| trimethylamine N-oxide | 1.00 | 1.00 | 1.00 | | | |
| myo-inositol | 1.17 | 1.16↑ | 0.99 | 0.0568 | 0.0423 | 0.9852 |
| chiro-inositol | 0.46 | 0.48 | 1.04 | 0.1054 | 0.2288 | 0.6550 |
| inositol 1-phosphate (I1P) | 1.05 | 0.81↓ | 0.77↓ | 0.8178 | 0.0113 | 0.0122 |
| 3-hydroxybutyrate (BHBA) | 2.17↑ | 4.98↑ | 2.29↑ | <0.001 | <0.001 | 0.0480 |
| 1,2-propanediol | 1.95↑ | 1.63 | 0.83 | 0.0242 | 0.1573 | 0.4742 |
| 1-palmitoylglycerophosphoethanolamine | 1.06 | 0.80↓ | 0.76↓ | 0.5383 | 0.0039 | <0.001 |
| 2-palmitoylglycerophosphoethanolamine* | 1.06 | 0.79↓ | 0.74↓ | 0.7410 | 0.0053 | 0.0034 |
| 1-stearoylglycerophosphoethanolamine | 1.10 | 0.80↓ | 0.73↓ | 0.2713 | 0.0118 | <0.001 |
| 1-oleoylglycerophosphoethanolamine | 0.90 | 0.71↓ | 0.79↓ | 0.3727 | <0.001 | 0.0052 |
| 2-oleoylglycerophosphoethanolamine* | 0.83 | 0.67↓ | 0.80↓ | 0.0781 | <0.001 | 0.0185 |
| 1-linoleoylglycerophosphoethanolamine* | 0.77↓ | 0.74↓ | 0.97 | 0.0048 | 0.0014 | 0.7545 |
| 2-linoleoylglycerophosphoethanolamine* | 0.73↓ | 0.74↓ | 1.02 | 0.0122 | 0.0127 | 0.9405 |
| 1-arachidonoylglycerophosphoethanolamine* | 1.01 | 0.99 | 0.99 | 0.9072 | 0.6511 | 0.7502 |
| 2-arachidonoylglycerophosphoethanolamine* | 0.80 | 0.68↓ | 0.85 | 0.0764 | 0.0019 | 0.1102 |
| 2- | 0.84 | 0.80 | 0.96 | 0.2394 | 0.0875 | 0.5498 |
| docosahexaenoylglycerophosphoethanolamine* | | | | | | |
| 1-myristoylglycerophosphocholine | 0.57↓ | 0.41↓ | 0.71↓ | <0.001 | <0.001 | 0.0090 |
| 1-pentadecanoylglycerophosphocholine* | 0.86 | 0.70↓ | 0.81 | 0.1053 | <0.001 | 0.0647 |
| 1-palmitoylglycerophosphocholine | 1.00 | 0.89↓ | 0.88 | 0.8501 | 0.0338 | 0.0661 |
| 2-palmitoylglycerophosphocholine* | 0.92 | 0.79↓ | 0.86 | 0.5706 | 0.0222 | 0.0665 |
| 1-palmitoleoylglycerophosphocholine* | 0.95 | 0.68↓ | 0.71↓ | 0.5120 | <0.001 | 0.0058 |
| 2-palmitoleoylglycerophosphocholine* | 1.12 | 0.88 | 0.79 | 0.9476 | 0.3217 | 0.4259 |
| 1-heptadecanoylglycerophosphocholine | 0.84 | 0.71↓ | 0.85 | 0.1072 | 0.0039 | 0.1795 |
| 1-stearoylglycerophosphocholine | 0.74 | 0.69↓ | 0.94 | 0.0815 | 0.0203 | 0.5007 |
| 2-stearoylglycerophosphocholine* | 0.78 | 0.72↓ | 0.93 | 0.0925 | 0.0127 | 0.3380 |
| 1-oleoylglycerophosphocholine | 0.85 | 0.72↓ | 0.85 | 0.0649 | <0.001 | 0.1668 |
| 2-oleoylglycerophosphocholine* | 0.86 | 0.71↓ | 0.83 | 0.1736 | 0.0024 | 0.0857 |
| 1-linoleoylglycerophosphocholine | 0.69↓ | 0.68↓ | 0.99 | <0.001 | <0.001 | 0.8119 |
| 2-linoleoylglycerophosphocholine* | 0.60↓ | 0.60↓ | 0.99 | <0.001 | <0.001 | 0.9744 |
| 1-eicosadienoylglycerophosphocholine* | 0.81 | 0.63↓ | 0.77 | 0.0650 | <0.001 | 0.0888 |
| 1-eicosatrienoylglycerophosphocholine* | 0.92 | 0.68↓ | 0.74↓ | 0.3473 | <0.001 | 0.0133 |
| 1-arachidonoylglycerophosphocholine* | 0.95 | 0.82↓ | 0.87 | 0.3495 | 0.0155 | 0.1871 |
| 2-arachidonoylglycerophosphocholine* | 0.83 | 0.80 | 0.96 | 0.1939 | 0.1400 | 0.8868 |
| 1-docosapentaenoylglycerophosphocholine* | 1.02 | 0.82 | 0.81 | 0.8332 | 0.0604 | 0.1177 |
| 1-docosahexaenoylglycerophosphocholine* | 0.91 | 0.96 | 1.05 | 0.1993 | 0.2715 | 0.8089 |
| 1-palmitoylglycerophosphoinositol* | 0.89 | 0.74↓ | 0.83 | 0.2482 | 0.0080 | 0.1410 |
| 1-stearoylglycerophosphoinositol | 0.94 | 0.89 | 0.95 | 0.2896 | 0.0930 | 0.6347 |
| 1-arachidonoylglycerophosphoinositol* | 1.06 | 1.06 | 1.00 | 0.6715 | 0.7307 | 0.9497 |
| 1-palmitoylplasmenylethanolamine* | 0.87 | 0.69↓ | 0.79↓ | 0.0648 | <0.001 | 0.0128 |
| 1-palmitoylglycerol (1-monopalmitin) | 1.14 | 1.12 | 0.98 | 0.9338 | 0.7080 | 0.7031 |
| 1-stearoylglycerol (1-monostearin) | 0.78↓ | 1.19 | 1.52↑ | 0.0116 | 0.6729 | 0.0157 |
| 1-oleoylglycerol (1-monoolein) | 1.75 | 1.20 | 0.68 | 0.3614 | 0.4849 | 0.1646 |
| 1-linoleoylglycerol (1-monolinolein) | 1.32 | 1.24 | 0.94 | 0.3448 | 0.4620 | 0.8649 |
| sphingosine | 0.80 | 0.73↓ | 0.91 | 0.1166 | 0.0374 | 0.6108 |
| erythro-sphingosine-1-phosphate | 0.81 | 1.07 | 1.32 | 0.2294 | 0.9648 | 0.2237 |
| palmitoyl sphingomyelin | 0.95 | 0.92 | 0.97 | 0.2251 | 0.1507 | 0.9489 |
| stearoyl sphingomyelin | 1.18 | 1.30↑ | 1.10 | 0.1405 | 0.0027 | 0.2028 |
| lathosterol | 1.11 | 0.81 | 0.73 | 0.6561 | 0.1781 | 0.0878 |
| cholesterol | 1.00 | 0.92 | 0.92 | 0.7203 | 0.1007 | 0.2595 |
| dihydrocholesterol | 1.09 | 1.28 | 1.18 | 0.8035 | 0.1444 | 0.2478 |
| 7-beta-hydroxycholesterol | 1.23 | 0.99 | 0.81 | 0.3844 | 0.9529 | 0.4023 |
| dehydroisoandrosterone sulfate (DHEA-S) | 0.82↓ | 1.08 | 1.33 | 0.0256 | 0.9336 | 0.0724 |
| epiandrosterone sulfate | 0.93 | 1.45 | 1.56↑ | 0.5943 | 0.1072 | 0.0346 |
| androsterone sulfate | 1.09 | 1.83↑ | 1.68↑ | 0.9525 | 0.0118 | 0.0148 |
| estrone 3-sulfate | 0.94 | 1.02 | 1.09 | 0.6053 | 0.8419 | 0.4668 |
| cortisol | 1.47↑ | 1.53↑ | 1.04 | 0.0094 | <0.001 | 0.4198 |
| corticosterone | 2.16↑ | 2.16↑ | 1.00 | <0.001 | <0.001 | 0.8953 |
| cortisone | 0.86↓ | 0.87↓ | 1.02 | 0.0132 | 0.0229 | 0.6679 |
| beta-sitosterol | 1.16 | 1.14 | 0.99 | 0.7478 | 0.6939 | 0.5076 |
| campesterol | 0.82 | 1.01 | 1.24 | 0.1540 | 0.9513 | 0.1803 |
| 7-alpha-hydroxy-3-oxo-4-cholestenoate (7- | 0.91 | 0.75↓ | 0.83↓ | 0.8243 | 0.0277 | 0.0198 |
| Hoca) | | | | | | |
| 4-androsten-3beta,17beta-diol disulfate 1* | 0.97 | 1.77 | 1.83↑ | 0.3141 | 0.1122 | 0.0227 |
| 4-androsten-3beta,17beta-diol disulfate 2* | 1.13 | 1.54↑ | 1.37 | 0.6799 | 0.0229 | 0.0792 |
| 5alpha-androstan-3beta,17beta-diol disulfate | 1.07 | 2.41↑ | 2.26↑ | 0.9896 | 0.0107 | 0.0120 |
| 5alpha-pregnan-3beta,20alpha-diol disulfate | 2.53 | 2.86↑ | 1.13 | 0.2528 | <0.001 | 0.0628 |
| 5alpha-pregnan-3alpha,20beta-diol disulfate 1* | 1.20 | 1.96↑ | 1.63↑ | 0.1416 | <0.001 | 0.0146 |
| pregnen-diol disulfate* | 3.64 | 3.26↑ | 0.90↓ | 0.1693 | <0.001 | 0.0218 |
| pregn steroid monosulfate* | 1.98 | 1.88↑ | 0.95 | 0.0877 | <0.001 | 0.3253 |
| andro steroid monosulfate 2* | 1.22 | 1.73↑ | 1.42 | 0.6466 | 0.0239 | 0.0952 |
| 21-hydroxypregnenolone disulfate | 2.26 | 1.91↑ | 0.85 | 0.2400 | <0.001 | 0.0966 |
| 5alpha-androstan-3beta,17alpha-diol disulfate | 0.96 | 1.00 | 1.04 | 0.8098 | 0.7432 | 0.5599 |
| 5alpha-androstan-3alpha,17beta-diol disulfate | 1.00 | 1.45↑ | 1.45↑ | 0.9992 | 0.0446 | 0.0445 |
| pregnenolone sulfate | 2.43↑ | 2.26↑ | 0.93 | 0.0013 | <0.001 | 0.3714 |
| xanthine | 1.57↑ | 1.27 | 0.81↓ | <0.001 | 0.0630 | 0.0340 |
| hypoxanthine | 1.99↑ | 1.39↑ | 0.70 | 0.0185 | 0.0474 | 0.4789 |
| inosine | 0.76↓ | 0.88 | 1.16↑ | <0.001 | 0.2786 | 0.0048 |
| N1-methyladenosine | 1.03 | 1.05 | 1.02 | 0.5729 | 0.2246 | 0.6299 |
| 7-methylguanine | 1.06 | 1.27↑ | 1.20 | 0.2856 | 0.0347 | 0.1922 |
| guanosine | 0.53↓ | 0.89 | 1.66 | 0.0012 | 0.2488 | 0.0526 |
| N1-methylguanosine | 0.93 | 1.10 | 1.18↑ | 0.3492 | 0.1870 | 0.0227 |
| N2,N2-dimethylguanosine | 0.91 | 0.82↓ | 0.91 | 0.4982 | 0.0381 | 0.0623 |
| N6-carbamoylthreonyladenosine | 1.42↑ | 1.14 | 0.80 | 0.0064 | 0.0558 | 0.1965 |
| urate | 1.05 | 1.04 | 0.99 | 0.4020 | 0.4736 | 0.8915 |
| allantoin | 0.83 | 1.25 | 1.50 | 0.5568 | 0.3848 | 0.1363 |
| N4-acetylcytidine | 1.21 | 1.09 | 0.90 | 0.0984 | 0.2716 | 0.4976 |
| uracil | 1.15 | 1.38 | 1.20 | 0.2669 | 0.1813 | 0.7731 |
| uridine | 1.05 | 1.04 | 0.99 | 0.1651 | 0.4296 | 0.6260 |
| pseudouridine | 1.10 | 1.07 | 0.98 | 0.0535 | 0.2111 | 0.5768 |
| 5-methyluridine (ribothymidine) | 0.87 | 0.95 | 1.09 | 0.1561 | 0.5566 | 0.4106 |
| methylphosphate | 0.89↓ | 0.78↓ | 0.88 | 0.0397 | <0.001 | 0.1677 |
| threonate | 0.43↓ | 0.50↓ | 1.15 | <0.001 | <0.001 | 0.3095 |
| heme* | 3.47↑ | 2.04↑ | 0.59↓ | <0.001 | 0.0120 | 0.0343 |
| L-urobilin | 1.04 | 0.55 | 0.52 | 0.4708 | 0.0555 | 0.2891 |
| D-urobilin | 1.96 | 1.57 | 0.80 | 0.0516 | 0.4004 | 0.2777 |
| bilirubin (Z,Z) | 0.40↓ | 0.46↓ | 1.17 | <0.001 | 0.0011 | 0.5563 |
| bilirubin (E,E)* | 0.60↓ | 0.59↓ | 0.99 | <0.001 | <0.001 | 0.9619 |
| bilirubin (E,Z or Z,E)* | 0.69↓ | 0.59↓ | 0.86 | 0.0377 | 0.0012 | 0.1786 |
| biliverdin | 1.09 | 1.00 | 0.92 | 0.6379 | 0.8056 | 0.4994 |
| nicotinamide | 1.36↑ | 1.15 | 0.84↓ | 0.0041 | 0.5886 | 0.0445 |
| pantothenate | 1.32 | 1.07 | 0.81 | 0.2621 | 0.6472 | 0.4598 |
| riboflavin (Vitamin B2) | 0.87 | 0.70↓ | 0.81 | 0.3540 | 0.0197 | 0.1420 |
| alpha-tocopherol | 1.14 | 0.84↓ | 0.73 | 0.6714 | 0.0255 | 0.2265 |
| beta-tocopherol | 1.59 | 1.09 | 0.69 | 0.1426 | 0.4140 | 0.4383 |
| gamma-tocopherol | 1.08 | 1.01 | 0.94 | 0.7859 | 0.9352 | 0.8513 |
| gamma-CEHC | 0.54↓ | 0.67↓ | 1.23 | 0.0015 | 0.0010 | 0.6485 |
| alpha-CEHC glucuronide* | 1.06 | 0.85 | 0.80↓ | 0.5893 | 0.0844 | 0.0278 |
| pyridoxate | 0.53↓ | 0.58↓ | 1.09 | <0.001 | <0.001 | 0.9494 |
| hippurate | 1.67 | 1.44 | 0.86 | 0.0912 | 0.9950 | 0.1957 |
| 2-hydroxyhippurate (salicylurate) | 0.49 | 0.10↓ | 0.21 | 0.0902 | 0.0095 | 0.4042 |
| 3-hydroxyhippurate | 0.55↓ | 0.35↓ | 0.64 | <0.001 | <0.001 | 0.5011 |
| 4-hydroxyhippurate | 2.10↑ | 1.42 | 0.68 | 0.0365 | 0.6219 | 0.1425 |
| catechol sulfate | 0.26↓ | 0.24↓ | 0.92 | <0.001 | <0.001 | 0.1066 |
| benzoate | 0.96 | 0.93 | 0.97 | 0.2831 | 0.0961 | 0.5536 |
| 4-ethylphenylsulfate | 0.34↓ | 0.18↓ | 0.53↓ | <0.001 | <0.001 | 0.0033 |
| 4-vinylphenol sulfate | 0.32↓ | 0.13↓ | 0.41 | <0.001 | <0.001 | 0.0526 |
| glycolate (hydroxyacetate) | 1.15 | 1.02 | 0.88 | 0.0508 | 0.8606 | 0.0874 |
| glycerol 2-phosphate | 1.35 | 0.93 | 0.69 | 0.7177 | 0.5399 | 0.3876 |
| heptaethylene glycol | 1.01 | 1.04 | 1.03 | 0.3235 | 0.2142 | 0.3622 |
| hexaethylene glycol | 1.14 | 2.42 | 2.12 | 0.6163 | 0.0714 | 0.1617 |
| 2-ethylhexanoate | 0.82↓ | 0.74↓ | 0.90 | 0.0090 | <0.001 | 0.2899 |
| bisphenol A monosulfate | 1.10 | 0.94 | 0.86 | 0.7871 | 0.2554 | 0.2900 |
| ofloxacin | 0.97 | 1.42 | 1.47 | 0.3235 | 0.4952 | 0.3235 |
| salicylate | 0.54 | 0.14 | 0.26 | 0.2945 | 0.0980 | 0.5441 |
| salicyluric glucuronide* | 0.12 | 0.08↓ | 0.65 | 0.0740 | 0.0204 | 0.3381 |
| 4-acetaminophen sulfate | 0.32 | 0.35 | 1.08 | 0.8197 | 0.3980 | 0.5266 |
| 4-acetamidophenol | 0.57 | 0.60 | 1.04 | 0.9411 | 0.4413 | 0.4592 |
| p-acetamidophenylglucuronide | 0.26 | 0.41 | 1.56 | 0.7700 | 0.3670 | 0.5224 |
| 2-hydroxyacetaminophen sulfate* | 0.21 | 0.18 | 0.88 | 0.6222 | 0.6546 | 0.9546 |
| 2-methoxyacetaminophen sulfate* | 0.42 | 0.39 | 0.92 | 0.7749 | 0.7334 | 0.9578 |
| 3-(cystein-S-yl)acetaminophen* | 0.92 | 1.11 | 1.22 | 0.3846 | 0.1756 | 0.6015 |
| ibuprofen | 0.24 | 1.05 | 4.42 | 0.0929 | 0.4922 | 0.3548 |
| naproxen | 0.43↓ | 0.43↓ | 1.00 | 0.0477 | 0.0477 | |
| desmethylnaproxen sulfate* | 0.56 | 0.52 | 0.92 | 0.2236 | 0.1003 | 0.3235 |
| lidocaine | 5.69↑ | 2.19↑ | 0.38 | 0.0046 | 0.0463 | 0.3145 |
| metformin | 1.00 | 1.00 | 1.00 | | | |
| metoprolol | 0.85 | 1.15 | 1.34 | 0.3235 | 0.8533 | 0.3235 |
| metoprolol acid metabolite* | 0.71 | 1.29 | 1.81 | 0.3235 | 0.8837 | 0.3235 |
| N-ethylglycinexylidide* | 1.90↑ | 1.38 | 0.73 | 0.0467 | 0.0998 | 0.6568 |
| fluoxetine | 0.97 | 0.97 | 1.00 | 0.6882 | 0.6882 | 1.0000 |
| norfluoxetine* | 1.02 | 1.06 | 1.04 | 0.3235 | 0.1880 | 0.4022 |
| topiramate | 1.00 | 1.00 | 1.00 | | | |
| 1-hydroxy-2-naphthalenecarboxylate | 0.71 | 0.71 | 1.00 | 0.1641 | 0.1641 | |
| celecoxib | 1.00 | 1.00 | 1.00 | | | |
| diphenhydramine | 1.00 | 1.00 | 1.00 | | | |
| ibuprofen acyl glucuronide | 1.00 | 1.00 | 1.00 | | | |
| ranitidine | 1.52 | 1.73 | 1.14 | 0.2546 | 0.3074 | 0.9465 |
| tubocurarine | 1.19↑ | 2.19↑ | 1.85 | 0.0124 | 0.0123 | 0.1827 |
| hydrochlorothiazide | 1.31 | 1.17 | 0.90 | 0.6724 | 0.5027 | 0.8603 |
| gabapentin | 1.00 | 1.00 | 1.00 | | | |
| paroxetine | 0.82 | 1.00 | 1.21 | 0.1661 | 0.8155 | 0.0853 |
| atenolol | 1.00 | 1.00 | 1.00 | | | |
| omeprazole | 1.00 | 1.00 | 1.00 | | | |
| Gentamycin* | 1.00 | 1.00 | 1.00 | | | |
| escitalopram | 1.00 | 1.00 | 1.00 | 0.3235 | | 0.3235 |
| doxycycline | 1.00 | 1.00 | 1.00 | | | |
| sertraline | 1.00 | 1.00 | 1.00 | | | |
| indoleacrylate | 1.04 | 0.86 | 0.83 | 0.9265 | 0.0731 | 0.0909 |
| saccharin | 1.02 | 0.93 | 0.91 | 0.4368 | 0.3700 | 0.9259 |
| quinate | 0.34↓ | 0.48↓ | 1.40 | 0.0196 | 0.0016 | 0.3166 |
| piperine | 0.50↓ | 0.29↓ | 0.58 | 0.0018 | <0.001 | 0.1923 |
| N-(2-furoyl)glycine | 0.23↓ | 0.39↓ | 1.70 | <0.001 | <0.001 | 0.5947 |
| stachydrine | 0.87 | 0.97 | 1.12 | 0.1400 | 0.4799 | 0.4744 |
| homostachydrine* | 1.26 | 0.88 | 0.70 | 0.9238 | 0.1092 | 0.2316 |
| vanillin | 0.88↓ | 0.86↓ | 0.98 | 0.0411 | 0.0211 | 0.6859 |
| cinnamoylglycine | 0.60↓ | 0.65↓ | 1.10 | 0.0190 | 0.0497 | 0.6743 |
| caffeine | 0.30↓ | 0.28↓ | 0.94↓ | <0.001 | <0.001 | 0.0473 |
| paraxanthine | 0.44↓ | 0.35↓ | 0.79 | <0.001 | <0.001 | 0.0945 |
| theobromine | 0.33↓ | 0.26↓ | 0.78 | <0.001 | <0.001 | 0.0698 |
| theophylline | 0.26↓ | 0.19↓ | 0.75↓ | <0.001 | <0.001 | 0.0319 |
| 1-methylurate | 0.81 | 0.59↓ | 0.73↓ | 0.4192 | 0.0074 | 0.0376 |
| 1,7-dimethylurate | 0.74↓ | 0.45↓ | 0.61↓ | 0.0300 | <0.001 | 0.0093 |
| 1,3,7-trimethylurate | 0.40↓ | 0.37↓ | 0.90 | 0.0017 | <0.001 | 0.1297 |
| 1-methylxanthine | 0.63 | 0.56↓ | 0.89 | 0.0618 | 0.0080 | 0.3322 |
| 3-methylxanthine | 0.43↓ | 0.50↓ | 1.16 | <0.001 | <0.001 | 0.6908 |
| 7-methylxanthine | 0.50↓ | 0.46↓ | 0.92 | <0.001 | <0.001 | 0.8327 |
| cotinine | 1.94↑ | 1.22 | 0.63 | 0.0054 | 0.1981 | 0.0652 |
| hydroxycotinine | 3.70↑ | 1.19 | 0.32 | 0.0090 | 0.3388 | 0.0528 |
| erythritol | 1.08 | 0.97 | 0.90 | 0.4421 | 0.5778 | 0.2090 |
| 2-phenylpropionate | 1.00 | 1.00 | 1.00 | | | |
| X-01911 | 0.66 | 0.51↓ | 0.76 | 0.0844 | 0.0035 | 0.1951 |
| X-02249 | 0.63↓ | 0.58↓ | 0.93 | <0.001 | <0.001 | 0.3340 |
| X-02269 | 0.51↓ | 0.70↓ | 1.37 | 0.0075 | 0.0398 | 0.7263 |
| X-02973 | 1.02 | 0.96 | 0.95 | 0.8147 | 0.2182 | 0.1924 |
| X-03002 | 1.62 | 1.62 | 1.00 | 0.2934 | 0.0623 | 0.4842 |
| X-03003 | 0.95 | 1.01 | 1.07 | 0.2953 | 0.3913 | 0.9404 |
| X-03056 | 1.92↑ | 1.55↑ | 0.81 | <0.001 | <0.001 | 0.8536 |
| X-03088 | 0.87 | 0.78↓ | 0.89 | 0.0509 | 0.0018 | 0.3695 |
| X-03094 | 0.98 | 0.72↓ | 0.73↓ | 0.5343 | <0.001 | <0.001 |
| X-04272 | 1.00 | 1.09 | 1.09 | 0.8847 | 0.0869 | 0.0804 |
| X-04357 | 1.26 | 0.92 | 0.73 | 0.4991 | 0.6275 | 0.2880 |
| X-04494 | 0.95 | 0.90 | 0.95 | 0.7059 | 0.3454 | 0.5528 |
| X-04495 | 1.37 | 1.26 | 0.92 | 0.0593 | 0.0709 | 0.8122 |
| X-04498 | 0.69↓ | 0.66↓ | 0.96 | 0.0297 | 0.0147 | 0.9376 |
| X-04499 | 1.12 | 1.18↑ | 1.06 | 0.2611 | 0.0436 | 0.3889 |
| X-05415 | 0.74↓ | 0.68↓ | 0.92 | 0.0464 | 0.0151 | 0.6897 |
| X-05426 | 0.31↓ | 0.54↓ | 1.72 | <0.001 | 0.0033 | 0.4874 |
| X-05907 | 0.78↓ | 0.66↓ | 0.86 | 0.0114 | <0.001 | 0.1030 |
| X-06126 | 0.23↓ | 0.14↓ | 0.59 | <0.001 | <0.001 | 0.3501 |
| X-06227 | 0.86↓ | 0.68↓ | 0.79↓ | 0.0490 | <0.001 | 0.0179 |
| X-06246 | 0.73↓ | 0.60↓ | 0.81 | 0.0066 | <0.001 | 0.0617 |
| X-06267 | 0.56↓ | 0.45↓ | 0.80 | 0.0018 | <0.001 | 0.3156 |
| X-06307 | 0.83↓ | 1.39↑ | 1.68↑ | 0.0180 | 0.0060 | <0.001 |
| X-06350 | 0.79↓ | 0.69↓ | 0.86 | 0.0068 | <0.001 | 0.2423 |
| X-06351 | 0.82 | 0.72↓ | 0.87 | 0.1843 | 0.0139 | 0.2335 |
| X-06667 | 1.48↑ | 1.89↑ | 1.28 | <0.001 | <0.001 | 0.1522 |
| X-07765 | 1.48 | 2.22 | 1.51 | 0.2745 | 0.3622 | 0.9628 |
| X-08402 | 0.88↓ | 0.71↓ | 0.81↓ | 0.0395 | <0.001 | 0.0409 |
| X-08766 | 0.99 | 0.84 | 0.84 | 0.7010 | 0.1720 | 0.3622 |
| X-08889 | 0.98 | 0.94 | 0.96 | 0.9776 | 0.9600 | 0.9837 |
| X-08893 | 0.94 | 0.99 | 1.06 | 0.1843 | 0.9001 | 0.2266 |
| X-09108 | 1.13 | 1.10 | 0.97 | 0.1669 | 0.2326 | 0.7920 |
| X-09286 | 0.80 | 0.84 | 1.05 | 0.2397 | 0.1282 | 0.6347 |
| X-09706 | 0.86↓ | 0.81↓ | 0.95 | 0.0490 | 0.0090 | 0.6378 |
| X-09789 | 0.35↓ | 0.34↓ | 0.98 | <0.001 | <0.001 | 0.1438 |
| X-10346 | 5.10↑ | 4.03↑ | 0.79 | <0.001 | <0.001 | 0.6463 |
| X-10395 | 0.77↓ | 0.62↓ | 0.80↓ | 0.0017 | <0.001 | 0.0070 |
| X-10429 | 0.86 | 0.63↓ | 0.73↓ | 0.9132 | 0.0098 | 0.0027 |
| X-10439 | 0.86 | 0.79 | 0.92 | 0.1121 | 0.0780 | 0.9319 |
| X-10474 | 0.99 | 0.73↓ | 0.74↓ | 0.7565 | 0.0135 | 0.0380 |
| X-10500 | 0.98 | 0.93 | 0.95 | 0.5966 | 0.1637 | 0.4417 |
| X-10503 | 1.05 | 0.95 | 0.90 | 0.9909 | 0.5827 | 0.5886 |
| X-10510 | 0.95 | 0.82↓ | 0.86 | 0.1901 | 0.0020 | 0.1339 |
| X-10511 | 1.08 | 1.07 | 0.99 | 0.3852 | 0.1887 | 0.6499 |
| X-10593 | 1.39↑ | 1.64↑ | 1.18↑ | 0.0187 | <0.001 | 0.0386 |
| X-10810 | 1.14 | 1.22 | 1.07 | 0.8696 | 0.9274 | 0.9489 |
| X-10830 | 1.10 | 1.16 | 1.05 | 0.7142 | 0.1177 | 0.2729 |
| X-10876 | 1.13 | 1.23↑ | 1.08 | 0.4535 | 0.0117 | 0.1442 |
| X-11204 | 0.94 | 0.82↓ | 0.87 | 0.4531 | 0.0118 | 0.0617 |
| X-11247 | 0.81↓ | 0.64↓ | 0.79 | 0.0117 | 0.0046 | 0.9688 |
| X-11261 | 0.91 | 1.09 | 1.19 | 0.9605 | 0.7806 | 0.7904 |
| X-11299 | 0.75↓ | 0.47↓ | 0.63 | 0.0424 | <0.001 | 0.1026 |
| X-11308 | 0.87 | 0.78↓ | 0.89 | 0.1285 | 0.0203 | 0.5509 |
| X-11315 | 0.84↓ | 0.93 | 1.10 | 0.0234 | 0.3326 | 0.1649 |
| X-11327 | 0.92 | 0.84 | 0.91 | 0.4828 | 0.0561 | 0.1710 |
| X-11334 | 0.97 | 0.71↓ | 0.73↓ | 0.1508 | <0.001 | 0.0320 |
| X-11372 | 0.85↓ | 0.67↓ | 0.79 | 0.0344 | <0.001 | 0.1062 |
| X-11378 | 0.83↓ | 0.70↓ | 0.85 | 0.0320 | <0.001 | 0.1332 |
| X-11381 | 0.99 | 0.86↓ | 0.87↓ | 0.9074 | 0.0212 | 0.0079 |
| X-11412 | 0.92 | 0.80↓ | 0.87↓ | 0.6642 | 0.0314 | 0.0407 |
| X-11423 | 1.01 | 0.98 | 0.97 | 0.7288 | 0.6358 | 0.9407 |
| X-11429 | 1.23↑ | 1.12 | 0.91 | 0.0020 | 0.0864 | 0.1546 |
| X-11437 | 3.43↑ | 2.61↑ | 0.76 | <0.001 | 0.0027 | 0.1208 |
| X-11438 | 0.84 | 0.86 | 1.03 | 0.5170 | 0.2622 | 0.5358 |
| X-11440 | 1.86 | 2.64↑ | 1.42↑ | 0.1647 | <0.001 | 0.0281 |
| X-11441 | 0.79↓ | 0.93↓ | 1.18 | 0.0139 | 0.0018 | 0.2440 |
| X-11442 | 0.74↓ | 0.61↓ | 0.83 | 0.0038 | <0.001 | 0.1171 |
| X-11444 | 1.43 | 1.26 | 0.89 | 0.1257 | 0.0608 | 0.9664 |
| X-11452 | 0.50↓ | 0.37↓ | 0.74 | <0.001 | <0.001 | 0.2626 |
| X-11469 | 0.49↓ | 0.67 | 1.36 | 0.0054 | 0.0509 | 0.4512 |
| X-11470 | 1.96↑ | 1.69↑ | 0.86 | 0.0312 | 0.0041 | 0.7242 |
| X-11478 | 0.93 | 1.11 | 1.19 | 0.4664 | 0.2625 | 0.0737 |
| X-11483 | 0.93 | 0.72↓ | 0.78 | 0.4631 | 0.0216 | 0.1254 |
| X-11485 | 0.59↓ | 0.47↓ | 0.79 | 0.0094 | <0.001 | 0.1601 |
| X-11491 | 0.86 | 0.54↓ | 0.62↓ | 0.9841 | 0.0195 | 0.0132 |
| X-11516 | 1.00 | 1.00 | 1.00 | | | |
| X-11521 | 0.93 | 0.81↓ | 0.87 | 0.1169 | 0.0174 | 0.4468 |
| X-11529 | 1.09 | 0.76 | 0.70 | 0.8373 | 0.1463 | 0.0949 |
| X-11530 | 0.56↓ | 0.50↓ | 0.90 | <0.001 | <0.001 | 0.1786 |
| X-11533 | 1.01 | 1.01 | 1.00 | 0.7318 | 0.7928 | 0.9370 |
| X-11537 | 0.74↓ | 0.61↓ | 0.83 | 0.0344 | 0.0014 | 0.2806 |
| X-11538 | 1.02 | 1.26↑ | 1.23 | 0.5338 | 0.0351 | 0.1269 |
| X-11540 | 0.77 | 0.68↓ | 0.88 | 0.0538 | 0.0025 | 0.2036 |
| X-11541 | 0.98 | 0.39↓ | 0.40↓ | 0.1426 | <0.001 | 0.0183 |
| X-11542 | 0.93 | 0.93 | 1.00 | 0.1419 | 0.1230 | 0.7411 |
| X-11549 | 0.57↓ | 0.53↓ | 0.92 | <0.001 | <0.001 | 0.7175 |
| X-11550 | 0.68↓ | 0.87↓ | 1.28↑ | <0.001 | 0.0155 | <0.001 |
| X-11561 | 0.84 | 0.71↓ | 0.84 | 0.1021 | 0.0033 | 0.1907 |
| X-11564 | 1.02 | 0.92 | 0.90 | 0.8614 | 0.1992 | 0.1588 |
| X-11593 | 1.09 | 1.07 | 0.99 | 0.3491 | 0.4545 | 0.8730 |
| X-11687 | 1.24↑ | 1.16↑ | 0.93 | <0.001 | 0.0366 | 0.2322 |
| X-11787 | 1.02 | 0.88↓ | 0.86↓ | 0.4768 | 0.0332 | 0.0021 |
| X-11793 | 0.98 | 1.16 | 1.19 | 0.8288 | 0.2925 | 0.2058 |
| X-11795 | 1.04 | 0.97 | 0.93 | 0.4526 | 0.5047 | 0.1732 |
| X-11799 | 0.71↓ | 0.85 | 1.19 | 0.0297 | 0.0714 | 0.5856 |
| X-11805 | 0.76↓ | 0.90 | 1.18↑ | 0.0151 | 0.6463 | 0.0235 |
| X-11818 | 0.83 | 0.78↓ | 0.95 | 0.0844 | 0.0287 | 0.6379 |
| X-11827 | 1.19 | 0.84 | 0.71 | 0.0739 | 0.3489 | 0.3490 |
| X-11837 | 0.43↓ | 0.45↓ | 1.06 | <0.001 | <0.001 | 0.6846 |
| X-11838 | 1.11 | 1.45 | 1.31 | 0.3622 | 0.3441 | 0.9136 |
| X-11843 | 0.22↓ | 0.18↓ | 0.81 | 0.0024 | 0.0010 | 0.7712 |
| X-11844 | 3.51↑ | 1.54 | 0.44 | 0.0404 | 0.0721 | 0.5126 |
| X-11845 | 0.91 | 0.99 | 1.09 | 0.5934 | 0.7635 | 0.3701 |
| X-11847 | 0.71 | 1.10 | 1.55 | 0.2454 | 0.6286 | 0.1097 |
| X-11849 | 0.55 | 0.96 | 1.75 | 0.1665 | 0.6494 | 0.0689 |
| X-11850 | 0.39↓ | 0.28↓ | 0.71 | 0.0050 | <0.001 | 0.5349 |
| X-11852 | 0.51 | 0.42↓ | 0.83 | 0.0847 | 0.0274 | 0.5956 |
| X-11858 | 0.72 | 0.65 | 0.91 | 0.5338 | 0.8351 | 0.6317 |
| X-11871 | 0.73↓ | 0.70↓ | 0.97 | 0.0403 | 0.0286 | 0.9239 |
| X-11880 | 0.84↓ | 0.64↓ | 0.76 | 0.0160 | <0.001 | 0.1043 |
| X-11905 | 0.93 | 1.19↑ | 1.29 | 0.3933 | 0.0484 | 0.1855 |
| X-11977 | 1.63↑ | 2.95↑ | 1.81↑ | <0.001 | <0.001 | 0.0016 |
| X-12010 | 0.80↓ | 0.75↓ | 0.94 | 0.0092 | 0.0118 | 0.6874 |
| X-12029 | 1.01 | 1.02 | 1.01 | 0.5757 | 0.5693 | 0.9247 |
| X-12039 | 0.11↓ | 0.20↓ | 1.88 | <0.001 | <0.001 | 0.5364 |
| X-12051 | 0.83 | 0.79 | 0.96 | 0.5094 | 0.1547 | 0.3970 |
| X-12056 | 2.08 | 1.98 | 0.95 | 0.3145 | 0.1364 | 0.6683 |
| X-12092 | 0.91 | 0.86 | 0.94 | 0.4067 | 0.2538 | 0.7955 |
| X-12095 | 0.97 | 0.80↓ | 0.83 | 0.4419 | 0.0264 | 0.2195 |
| X-12100 | 1.06 | 1.25↑ | 1.18 | 0.4881 | 0.0185 | 0.0822 |
| X-12101 | 0.93 | 1.65↑ | 1.77↑ | 0.6899 | 0.0056 | 0.0014 |
| X-12104 | 1.19 | 1.31↑ | 1.10 | 0.0976 | <0.001 | 0.1153 |
| X-12116 | 1.17 | 0.86 | 0.73 | 0.8407 | 0.2159 | 0.3813 |
| X-12128 | 1.43↑ | 1.70↑ | 1.19 | <0.001 | <0.001 | 0.2717 |
| X-12189 | 0.40↓ | 0.43↓ | 1.09 | <0.001 | <0.001 | 0.4795 |
| X-12216 | 0.56↓ | 0.49↓ | 0.88 | <0.001 | <0.001 | 0.2180 |
| X-12230 | 0.11↓ | 0.38↓ | 3.38 | <0.001 | <0.001 | 0.6949 |
| X-12231 | 0.54↓ | 0.45↓ | 0.83 | <0.001 | <0.001 | 0.3619 |
| X-12244 | 0.88 | 0.83↓ | 0.94 | 0.1353 | 0.0288 | 0.4351 |
| X-12257 | 0.48 | 0.41↓ | 0.85 | 0.1153 | 0.0396 | 0.5746 |
| X-12293 | 1.00 | 1.00 | 1.00 | | | |
| X-12306 | 0.67 | 0.66 | 0.98 | 0.6503 | 0.5248 | 0.6989 |
| X-12329 | 0.15↓ | 0.23↓ | 1.59 | <0.001 | <0.001 | 0.2171 |
| X-12339 | 0.88 | 0.92 | 1.05 | 0.2280 | 0.2177 | 0.8735 |
| X-12407 | 0.55↓ | 0.59↓ | 1.07 | <0.001 | 0.0034 | 0.3554 |
| X-12411 | 0.73 | 0.74 | 1.02 | 0.0909 | 0.1085 | 0.9267 |
| X-12419 | 1.37 | 2.87 | 2.09 | 0.3127 | 0.0670 | 0.3057 |
| X-12423 | 1.39 | 0.91 | 0.65 | 0.9515 | 0.4190 | 0.4408 |
| X-12443 | 0.99 | 0.81 | 0.82 | 0.8362 | 0.5414 | 0.4088 |
| X-12462 | 0.97 | 0.91 | 0.93 | 0.4999 | 0.0915 | 0.3274 |
| X-12465 | 2.61↑ | 3.36↑ | 1.29 | <0.001 | <0.001 | 0.8187 |
| X-12468 | 1.00 | 1.00 | 1.00 | | | |
| X-12510 | 1.16 | 0.56↓ | 0.48↓ | 0.0993 | <0.001 | 0.0413 |
| X-12511 | 1.20↑ | 0.53↓ | 0.45↓ | 0.0311 | <0.001 | 0.0417 |
| X-12644 | 1.07 | 1.14 | 1.07 | 0.2627 | 0.0696 | 0.4178 |
| X-12645 | 1.04 | 1.20 | 1.15 | 0.5574 | 0.1234 | 0.2967 |
| X-12730 | 0.39↓ | 0.43↓ | 1.09 | <0.001 | 0.0014 | 0.2841 |
| X-12734 | 0.40↓ | 0.35↓ | 0.88 | <0.001 | <0.001 | 0.2874 |
| X-12738 | 0.46↓ | 0.49↓ | 1.08 | <0.001 | 0.0023 | 0.1919 |
| X-12741 | 1.13 | 1.00 | 0.88 | 0.3235 | | 0.3235 |
| X-12742 | 1.53↑ | 3.60↑ | 2.36↑ | <0.001 | <0.001 | 0.0010 |
| X-12748 | 1.46↑ | 2.12↑ | 1.45↑ | 0.0126 | <0.001 | 0.0227 |
| X-12749 | 0.93 | 1.05 | 1.13 | 0.4333 | 0.6524 | 0.8643 |
| X-12766 | 1.18 | 1.12 | 0.96 | 0.2545 | 0.6873 | 0.4955 |
| X-12776 | 0.94 | 0.99 | 1.05 | 0.0530 | 0.6163 | 0.1282 |
| X-12798 | 0.87 | 0.75↓ | 0.87 | 0.1793 | 0.0079 | 0.1501 |
| X-12802 | 2.12↑ | 3.26↑ | 1.54 | <0.001 | <0.001 | 0.0873 |
| X-12804 | 1.10 | 1.03 | 0.93 | 0.1831 | 0.7041 | 0.3494 |
| X-12816 | 0.40↓ | 0.24↓ | 0.58 | 0.0018 | <0.001 | 0.5594 |
| X-12824 | 1.97↑ | 2.71↑ | 1.37 | <0.001 | <0.001 | 0.2569 |
| X-12830 | 0.57↓ | 0.46↓ | 0.81 | 0.0035 | <0.001 | 0.4083 |
| X-12833 | 0.96↓ | 0.96↓ | 1.00 | 0.0486 | 0.0335 | 0.6492 |
| X-12844 | 1.04 | 0.89 | 0.85 | 0.7600 | 0.3761 | 0.2021 |
| X-12846 | 1.38↑ | 1.19 | 0.86 | 0.0405 | 0.2231 | 0.3922 |
| X-12847 | 0.89 | 0.83 | 0.94 | 0.4337 | 0.0974 | 0.3528 |
| X-12849 | 0.76 | 1.04↑ | 1.37 | 0.1264 | 0.0467 | 0.5536 |
| X-12850 | 1.82 | 1.77 | 0.97 | 0.5276 | 0.7370 | 0.7940 |
| X-12851 | 0.75 | 0.46 | 0.61 | 0.8857 | 0.3221 | 0.2452 |
| X-12855 | 1.29↑ | 1.78↑ | 1.38↑ | 0.0257 | <0.001 | 0.0139 |
| X-12875 | 0.92 | 0.77 | 0.84 | 0.9491 | 0.1916 | 0.1586 |
| X-12940 | 4.79 | 1.70 | 0.36 | 0.1523 | 0.2137 | 0.6753 |
| X-13152 | 0.86 | 0.85 | 0.99 | 0.1404 | 0.2030 | 0.7306 |
| X-13212 | 6.77↑ | 2.16 | 0.32 | 0.0073 | 0.0629 | 0.1959 |
| X-13215 | 0.74↓ | 0.66↓ | 0.88 | <0.001 | <0.001 | 0.2443 |
| X-13255 | 1.00 | 1.00 | 1.00 | | | |
| X-13342 | 1.00 | 1.00 | 1.00 | | | |
| X-13368 | 1.00 | 1.00 | 1.00 | | | |
| X-13425 | 0.87 | 0.56↓ | 0.64↓ | 0.6429 | 0.0014 | 0.0036 |
| X-13429 | 1.03 | 0.57↓ | 0.55 | 0.1209 | 0.0015 | 0.1715 |
| X-13435 | 0.76 | 0.66↓ | 0.87 | 0.1055 | 0.0183 | 0.4337 |
| X-13447 | 1.46 | 1.36 | 0.93 | 0.3995 | 0.3510 | 0.9777 |
| X-13449 | 2.81↑ | 1.93↑ | 0.69 | 0.0092 | 0.0334 | 0.5881 |
| X-13457 | 3.05 | 0.83↓ | 0.27 | 0.2921 | 0.0049 | 0.7802 |
| X-13553 | 1.16 | 1.02 | 0.88 | 0.1649 | 0.9415 | 0.1676 |
| X-13619 | 0.89↓ | 0.97 | 1.08 | 0.0277 | 0.4407 | 0.1723 |
| X-13658 | 5.30↑ | 1.96↑ | 0.37 | <0.001 | 0.0171 | 0.0929 |
| X-13668 | 1.01 | 0.91 | 0.90 | 0.6369 | 0.4349 | 0.7971 |
| X-13671 | 1.02 | 0.94 | 0.92 | 0.6212 | 0.6215 | 0.2837 |
| X-13687 | 1.23 | 1.21 | 0.98 | 0.1990 | 0.1747 | 0.9554 |
| X-13689 | 1.27 | 0.91 | 0.71 | 0.4543 | 0.0549 | 0.0768 |
| X-13699 | 1.00 | 1.00 | 1.00 | | | |
| X-13722 | 1.50↑ | 1.98↑ | 1.33 | 0.0030 | <0.001 | 0.1787 |
| X-13727 | 0.96 | 0.95↓ | 0.99 | 0.0995 | 0.0438 | 0.7728 |
| X-13730 | 0.64 | 0.56↓ | 0.88 | 0.0518 | 0.0172 | 0.6126 |
| X-13741 | 0.23↓ | 0.24↓ | 1.06 | <0.001 | <0.001 | 0.3761 |
| X-13742 | 0.53↓ | 0.54↓ | 1.03 | <0.001 | 0.0017 | 0.6736 |
| X-13844 | 0.71 | 0.65↓ | 0.91 | 0.1349 | 0.0421 | 0.5038 |
| X-13848 | 0.35↓ | 0.32↓ | 0.93 | 0.0226 | 0.0113 | 0.5739 |
| X-13866 | 0.76 | 0.91 | 1.20 | 0.0785 | 0.4551 | 0.3337 |
| X-13891 | 1.07 | 1.48 | 1.38 | 0.8518 | 0.1073 | 0.1522 |
| X-13994 | 1.00 | 1.00 | 1.00 | | | |
| X-14007 | 1.00 | 1.00 | 1.00 | | | |
| X-14015 | 1.00 | 1.00 | 1.00 | | | |
| X-14056 | 1.11 | 1.02 | 0.92 | 0.2731 | 0.8356 | 0.3775 |
| X-14072 | 2.29 | 1.14 | 0.50 | 0.2050 | 0.2418 | 0.5087 |
| X-14073 | 1.00 | 1.00 | 1.00 | | | |
| X-14086 | 0.83 | 1.77↑ | 2.13↑ | 0.1045 | 0.0022 | <0.001 |
| X-14095 | 1.54↑ | 1.05 | 0.68↓ | 0.0171 | 0.7466 | 0.0372 |
| X-14192 | 0.87 | 0.77 | 0.88 | 0.6581 | 0.1595 | 0.3009 |
| X-14234 | 2.05↑ | 1.71↑ | 0.84 | <0.001 | 0.0033 | 0.2245 |
| X-14272 | 1.21↑ | 0.96 | 0.79 | 0.0232 | 0.3014 | 0.1725 |
| X-14302 | 1.28↑ | 0.89 | 0.69↓ | 0.0439 | 0.7305 | 0.0487 |
| X-14314 | 1.54↑ | 1.02 | 0.66↓ | 0.0051 | 0.5593 | 0.0185 |
| X-14364 | 2.72↑ | 2.18↑ | 0.80 | <0.001 | <0.001 | 0.0698 |
| X-14384 | 1.19 | 1.65↑ | 1.39↑ | 0.0952 | <0.001 | 0.0328 |
| X-14473 | 0.72 | 0.62↓ | 0.86 | 0.1536 | 0.0155 | 0.2470 |
| X-14567 | 0.85↓ | 0.77↓ | 0.92 | 0.0018 | <0.001 | 0.1868 |
| X-14575 | 1.42↑ | 3.77↑ | 2.65 | <0.001 | 0.0023 | 0.7148 |
| X-14588 | 1.05↑ | 1.05 | 1.00 | 0.0399 | 0.0857 | 0.8773 |
| X-14596 | 0.75↓ | 0.97 | 1.30 | 0.0373 | 0.4336 | 0.2146 |
| X-14662 | 1.51 | 2.04 | 1.35 | 0.1488 | 0.2913 | 0.8056 |
| X-14939 | 0.89 | 0.98 | 1.10 | 0.5749 | 0.7561 | 0.3515 |
| X-15222 | 0.85↓ | 0.84↓ | 0.98 | 0.0193 | 0.0081 | 0.5912 |
| X-15245 | 1.47↑ | 1.01 | 0.68 | 0.0153 | 0.3068 | 0.0919 |
| X-15301 | 0.84 | 0.77 | 0.91 | 0.3347 | 0.1589 | 0.6819 |
| X-15439 | 1.00 | 1.00 | 1.00 | | | |
| X-15455 | 1.90 | 1.00 | 0.52 | 0.5325 | 0.7024 | 0.3550 |
| X-15486 | 1.12 | 1.13 | 1.01 | 0.1361 | 0.1621 | 0.9522 |
| X-15492 | 1.95↑ | 1.68↑ | 0.87 | 0.0041 | <0.001 | 0.7718 |
| X-15523 | 1.69 | 1.22 | 0.72 | 0.7328 | 0.2171 | 0.4117 |
| X-15572 | 1.04 | 1.19 | 1.15 | 0.9959 | 0.5742 | 0.5856 |
| X-15576 | 8.77↑ | 7.79↑ | 0.89 | 0.0061 | <0.001 | 0.4248 |
| X-15595 | 5.43 | 1.56 | 0.29 | 0.1503 | 0.3285 | 0.5572 |
| X-15601 | 4.02↑ | 3.78↑ | 0.94 | 0.0041 | <0.001 | 0.6617 |
| X-15606 | 2.12 | 0.02 | 0.01 | 0.6919 | 0.9327 | 0.6256 |
| X-15609 | 1.47↑ | 1.46 | 1.00 | 0.0351 | 0.3122 | 0.2936 |
| X-15664 | 1.04 | 0.89 | 0.85 | 0.8564 | 0.2427 | 0.3773 |
| X-15674 | 1.00 | 1.00 | 1.00 | | | |
| X-15689 | 2.24 | 4.40 | 1.97 | 0.0712 | 0.1075 | 0.9650 |
| X-15707 | 1.00 | 1.09 | 1.09 | | 0.3235 | 0.3235 |
| X-15708 | 1.00 | 1.60 | 1.60 | | 0.0873 | 0.0873 |
| X-15728 | 0.76 | 0.42↓ | 0.55 | 0.1200 | 0.0010 | 0.0996 |
| X-15737 | 1.17 | 2.51 | 2.14 | 0.7820 | 0.9424 | 0.8715 |
| X-15824 | 1.00 | 1.00 | 1.00 | | | |
| X-16071 | 0.57↓ | 0.69↓ | 1.20 | <0.001 | <0.001 | 0.4845 |
| X-16083 | 1.59 | 2.68 | 1.68 | 0.2795 | 0.0512 | 0.3489 |
| X-16120 | 0.84↓ | 0.84↓ | 1.01 | 0.0057 | 0.0090 | 0.9670 |
| X-16121 | 1.09 | 2.90↑ | 2.66↑ | 0.5390 | <0.001 | <0.001 |
| X-16123 | 0.86↓ | 1.76↑ | 2.04↑ | 0.0208 | <0.001 | <0.001 |
| X-16124 | 0.54 | 0.44↓ | 0.82 | 0.0861 | 0.0187 | 0.2718 |
| X-16125 | 0.72 | 0.52↓ | 0.72 | 0.0802 | 0.0023 | 0.2028 |
| X-16128 | 1.26↑ | 1.57↑ | 1.25 | 0.0173 | 0.0067 | 0.6276 |
| X-16129 | 1.09 | 4.19↑ | 3.86↑ | 0.4746 | <0.001 | <0.001 |
| X-16130 | 0.76↑ | 0.80 | 1.04 | 0.0162 | 0.0547 | 0.5418 |
| X-16131 | 1.45 | 1.44↑ | 0.99 | 0.3942 | 0.0216 | 0.2661 |
| X-16132 | 1.61↑ | 1.30 | 0.81 | <0.001 | 0.0534 | 0.0946 |
| X-16133 | 1.00 | 4.11↑ | 4.10↑ | 0.3339 | <0.001 | <0.001 |
| X-16134 | 0.85 | 4.38↑ | 5.16↑ | 0.2741 | <0.001 | <0.001 |
| X-16135 | 1.02 | 4.75↑ | 4.66↑ | 0.5261 | <0.001 | <0.001 |
| X-16136 | 0.77↓ | 1.32↑ | 1.71↑ | 0.0140 | 0.0386 | <0.001 |
| X-16137 | 0.74 | 1.19 | 1.61↑ | 0.0661 | 0.2901 | 0.0037 |
| X-16138 | 1.34↑ | 1.65↑ | 1.24 | 0.0233 | <0.001 | 0.2003 |
| X-16140 | 0.89 | 1.59↑ | 1.78↑ | 0.0547 | <0.001 | <0.001 |
| X-16206 | 0.99 | 0.98 | 0.99 | 0.5979 | 0.4182 | 0.9024 |
| X-16245 | 0.48 | 1.45 | 3.05 | 0.8345 | 0.1376 | 0.1515 |
| X-16271 | 0.84 | 0.92 | 1.09 | 0.0682 | 0.4880 | 0.2066 |
| X-16288 | 0.55 | 0.38↓ | 0.69↓ | 0.9004 | 0.0108 | <0.001 |
| X-16299 | 1.68↑ | 1.06 | 0.63↓ | <0.001 | 0.3360 | <0.001 |
| X-16302 | 1.00 | 1.00 | 1.00 | | | |
| X-16336 | 1.03 | 0.90↓ | 0.87 | 0.5756 | 0.0470 | 0.3763 |
| X-16394 | 1.12 | 1.19 | 1.07 | 0.3499 | 0.2163 | 0.7252 |
| X-16397 | 1.38↑ | 1.42↑ | 1.03 | <0.001 | <0.001 | 0.6051 |
| X-16468 | 0.60 | 0.66 | 1.10 | 0.2030 | 0.3706 | 0.6507 |
| X-16480 | 0.86 | 1.11 | 1.29 | 0.4240 | 0.2963 | 0.0564 |
| X-16578 | 0.81↓ | 0.73↓ | 0.90 | 0.0439 | 0.0025 | 0.2919 |
| X-16649 | 0.76 | 0.29↓ | 0.39↓ | 0.2832 | 0.0024 | 0.0366 |
| X-16651 | 0.75↓ | 0.63↓ | 0.84 | 0.0066 | <0.001 | 0.1721 |
| X-16653 | 0.66↓ | 0.65↓ | 0.99 | <0.001 | <0.001 | 0.9727 |
| X-16654 | 0.93 | 0.71↓ | 0.77 | 0.3435 | 0.0185 | 0.2538 |
| X-16662 | 1.00 | 1.00 | 1.00 | | | |
| X-16664 | 1.00 | 1.00 | 1.00 | | | |
| X-16666 | 1.00 | 1.00 | 1.00 | | | |
| X-16668 | 1.00 | 1.00 | 1.00 | | | |
| X-16786 | 4.42↑ | 2.10↑ | 0.47↑ | <0.001 | <0.001 | 0.0306 |
| X-16803 | 1.08 | 1.03 | 0.95 | 0.1707 | 0.3235 | 0.4545 |
| X-16932 | 1.05 | 0.99 | 0.95 | 0.4996 | 0.9768 | 0.4722 |
| X-16935 | 0.92 | 0.81 | 0.89 | 0.3550 | 0.0600 | 0.3394 |
| X-16938 | 0.89↓ | 0.82↓ | 0.92 | 0.0145 | <0.001 | 0.1719 |
| X-16940 | 0.44↓ | 0.32↓ | 0.74 | 0.0145 | 0.0015 | 0.3492 |
| X-16943 | 0.86↓ | 0.83↓ | 0.97 | 0.0060 | <0.001 | 0.9772 |
| X-16944 | 0.95 | 1.05 | 1.11 | 0.4397 | 0.9292 | 0.4358 |
| X-16946 | 1.04 | 0.88 | 0.85 | 0.6902 | 0.2225 | 0.4860 |
| X-16947 | 0.85 | 1.10 | 1.29 | 0.4073 | 0.7337 | 0.2726 |
| X-16982 | 0.85 | 0.75↓ | 0.88 | 0.0711 | 0.0030 | 0.2240 |
| X-16986 | 0.75↓ | 0.71↓ | 0.94 | 0.0057 | <0.001 | 0.2843 |
| X-16990 | 1.00 | 1.09 | 1.09 | | 0.3235 | 0.3235 |
| X-17115 | 1.20 | 1.06 | 0.89 | 0.2799 | 0.8651 | 0.4066 |
| X-17137 | 1.02 | 0.84 | 0.82 | 0.9255 | 0.0537 | 0.0841 |
| X-17138 | 0.81↓ | 0.92 | 1.13 | 0.0298 | 0.1855 | 0.5069 |
| X-17145 | 0.44↓ | 0.23↓ | 0.53 | 0.0025 | <0.001 | 0.1578 |
| X-17146 | 2.35↑ | 1.14 | 0.48 | 0.0204 | 0.0505 | 0.1156 |
| X-17147 | 0.47↓ | 0.40↓ | 0.86 | <0.001 | <0.001 | 0.1009 |
| X-17150 | 1.57 | 1.01 | 0.65 | 0.7330 | 0.9456 | 0.6903 |
| X-17155 | 0.69↓ | 0.67↓ | 0.98 | 0.0012 | <0.001 | 0.8553 |
| X-17162 | 0.57 | 0.50 | 0.87 | 0.1576 | 0.1665 | 0.9366 |
| X-17174 | 1.14 | 3.80↑ | 3.33↑ | 0.2557 | <0.001 | <0.001 |
| X-17175 | 0.92 | 1.09 | 1.18 | 0.3546 | 0.6206 | 0.1677 |
| X-17177 | 0.86 | 3.96↑ | 4.62↑ | 0.3007 | <0.001 | <0.001 |
| X-17178 | 0.66↓ | 0.67↓ | 1.01 | 0.0019 | 0.0047 | 0.6141 |
| X-17179 | 0.94↓ | 1.82↓ | 1.93↑ | 0.0370 | <0.001 | <0.001 |
| X-17183 | 1.05 | 3.42↑ | 3.27↑ | 0.9432 | <0.001 | <0.001 |
| X-17184 | 1.11 | 3.02↑ | 2.72↑ | 0.5742 | <0.001 | <0.001 |
| X-17185 | 0.45↓ | 0.23↓ | 0.53 | 0.0228 | <0.001 | 0.0984 |
| X-17188 | 1.00 | 1.00 | 1.00 | | | |
| X-17189 | 0.95 | 1.04 | 1.09 | 0.1818 | 0.7097 | 0.3816 |
| X-17191 | 1.57 | 1.84↑ | 1.18 | 0.1135 | <0.001 | 0.1514 |
| X-17193 | 1.39 | 3.65↑ | 2.62↑ | 0.3991 | <0.001 | <0.001 |
| X-17254 | 0.93 | 0.74 | 0.79 | 0.9670 | 0.6037 | 0.5599 |
| X-17269 | 0.79↓ | 0.76↓ | 0.97 | 0.0015 | <0.001 | 0.6529 |
| X-17299 | 1.14 | 1.28↑ | 1.12 | 0.0958 | 0.0271 | 0.4123 |
| X-17314 | 2.14 | 2.06 | 0.96 | 0.1702 | 0.0955 | 0.8247 |
| X-17317 | 0.87 | 0.93 | 1.08 | 0.8754 | 0.7128 | 0.8254 |
| X-17318 | 0.88 | 0.87↓ | 0.99 | 0.0630 | 0.0500 | 0.9070 |
| X-17327 | 1.10 | 1.99↑ | 1.80↑ | 0.0707 | <0.001 | 0.0085 |
| X-17336 | 1.08 | 0.90 | 0.84 | 0.6796 | 0.2862 | 0.1426 |
| X-17337 | 0.72↓ | 0.68↓ | 0.95 | 0.0053 | 0.0028 | 0.9118 |
| X-17341 | 1.99↑ | 1.78↑ | 0.89 | 0.0031 | <0.001 | 0.6379 |
| X-17347 | 0.50↓ | 0.50↓ | 1.00 | 0.0020 | 0.0012 | 0.7909 |
| X-17348 | 0.53 | 0.50↓ | 0.94 | 0.0743 | 0.0355 | 0.3235 |
| X-17357 | 1.06 | 1.02 | 0.97 | 0.7917 | 0.7452 | 0.9698 |
| X-17378 | 1.01 | 1.00 | 0.99 | 0.2245 | 0.3235 | 0.2758 |
| X-17422 | 2.70↑ | 1.34 | 0.50 | 0.0061 | 0.0935 | 0.0856 |
| X-17438 | 0.90 | 1.26 | 1.39 | 0.3060 | 0.9853 | 0.3634 |
| X-17441 | 1.01 | 1.33↑ | 1.33↑ | 0.8630 | 0.0053 | 0.0046 |
| X-17442 | 0.82 | 2.73↑ | 3.33↑ | 0.2397 | <0.001 | <0.001 |
| X-17443 | 1.15 | 1.76↑ | 1.53 | 0.0695 | 0.0117 | 0.3053 |
| X-17445 | 1.25 | 1.36 | 1.08 | 0.1032 | 0.0605 | 0.7206 |
| X-17447 | 1.00 | 1.00 | 1.00 | | | |
| X-17453 | 1.67 | 1.01 | 0.60 | 0.7858 | 0.2659 | 0.4667 |
| X-17459 | 1.00 | 1.00 | 1.00 | | | |
| X-17463 | 0.20↓ | 1.34 | 6.67 | 0.0121 | 0.3379 | 0.1380 |
| X-17502 | 1.57↑ | 1.06 | 0.68 | 0.0153 | 0.2561 | 0.1073 |
| X-17612 | 1.05 | 0.94 | 0.89 | 0.5586 | 0.9377 | 0.4809 |
| X-17626 | 0.96 | 0.94 | 0.98 | 0.4286 | 0.1700 | 0.3235 |
| X-17630 | 1.00 | 1.00 | 1.00 | | | |
| X-17665 | 0.86 | 0.69↓ | 0.80↓ | 0.0783 | <0.001 | 0.0067 |

Nuclear Magnetic Resonance (“NMR”) Spectroscopy

NMR Sample Preparation

All specimens were stored at −80 ° C. and thawed at room temperature for sample preparation. For the first set of specimens, NMR samples were prepared by combining 119 μL of serum with 51 μL of a D₂O solution (containing 0.9% w/v NaCl) to enable “locking” of the spectrometer. The resulting solution was transferred into a thick-walled NMR tube (New Era Enterprises, Vineland, N.J.; catalog # NE-HP5-H-7) for data acquisition. Because of the smaller volume of the specimens of the validation set, corresponding NMR samples were prepared by combining 42 μL of serum with 18 μL of the D₂O solution containing 0.9% w/v NaCl. The resulting solution was transferred to a capillary tube (New Era Enterprises; catalog # NE-262-2) which was inserted into a regular 5 mm NMR tube (New Era Enterprises; catalog # NE-UPS-7) by use of an adapter (New Era Enterprises; catalog # NE-325-5/2). The void volume between the inner wall of the regular NMR tube and the outer wall of the capillary tube was filled with pure D₂O to further stabilize the “locking” of the spectrometer.

NMR Operator Certification

Before the start of NMR data acquisition, an operator was certified for data collection using an NMR spectrometer equipped with a cryogenic probe. For example, experiments performed by previously certified operators are repeated by a candidate operator using the same samples. Statistical analyses are performed to compare the spectra obtained by the candidate operator against the spectra previously obtained by the certified operator. Such comparisons are used to determine whether or not the candidate operator will be certified.

NMR Data Collection

After NMR sample preparation, 1D and 2D NMR spectra were acquired in random run order at 25° C. on an Agilent INOVA 600 spectrometer equipped with cryogenic probe following a standard operating procedure (“SOP”) using known techniques. For each sample, the following four types of one-dimensional (1D) ¹H NMR spectra were recorded: Nuclear Overhauser Enhancement Spectroscopy (“NOESY;” 100 ms mixing time; 512 scans with 3.5 s relaxation delay between scans and 1.4 s direct acquisition time resulting in a measurement time of 45 min), Carr-Purcell-Meiboom-Gill (“CPMG;” 80 ms spin-lock; 512 scans; 3.5 s relaxation delay; 1.4 s direct acquisition time; 45 min measurement time), Diffusion Ordered Spectroscopy (“DOSY;” 150 ms diffusion delay with 1 ms pulsed field gradient at 44 G/cm; 512 scans; 2.0 s relaxation delay, 1.4 s direct acquisition time; 32 min measurement time) and Diffusion and transverse Relaxation Edited spectroscopy (“DIRE;” 35 ms spin-lock and 400 ms diffusion delay with 1 ms pulsed field gradient at 24 G/cm; 256 scans; 2.0 s relaxation delay, 1.4 s direct acquisition time; 17 min measurement time). In addition, the following two types of two-dimensional (2D) NMR spectra were recorded: ¹H J-resolved [16 scans, 2.0 s relaxation delay; t_{1,max}=800 ms; t_{2,max}=1.365 s; spectral width (“sw”) 1=40 Hz, sw 2=12,000 Hz; 33 min measurement time], and [¹H, ¹H] Total Correlation Spectroscopy (“TOCSY;” mixing time 60 ms with spinlock field strength=8,400 Hz; 4 scans; 1.5 s relaxation delay, t_{1,max}=33 ms; t_{2,max}=683 ms, sw 1, 2=6,000 Hz, 60 min measurement time). This resulted in a total measurement time of 1,713 hours for the 443 samples.

The SOP for setting up the spectrometer was repeated after data collection for every 10 specimens, which included recording of 1D ¹H CPMG spectrum for a fetal bovine serum (“FBS”) test sample. Principal Component Analyses (“PCA”) validated that all test spectra acquired during the course of the data acquisition were statistically indistinguishable.

NMR Data Processing

Prior to Fourier Transformation (“FT”), time domain data of 1D spectra were (i) multiplied by an exponential window function resulting in a line broadening of 2.25 Hz for 1D ¹H NOESY and CPMG spectra, and of 4.0 Hz for 1D ¹H DOSY and 1D ¹H DIRE and (ii) zero-filled to 131,072 points. Subsequently, spectra were phase- and linearly baseline-corrected using the Agilent VNMRJ software package, calibrated relative to the formate resonance line at 8.444 ppm and spectral quality was validated using known techniques. 2D spectra were processed using the program NMRPipe. Time domain data of 2D ¹H J-resolved spectra were multiplied along t₂(¹H) by an exponential window function resulting in a line broadening of 1.4 Hz and then by a sine-bell window to eliminate any residual truncation effects, and along t₁(J) with a sine-bell function. After FT, a linear baseline correction was performed, the spectrum was tilted by a 45°, again linearly baseline corrected, and symmetrized about J=0 Hz. A skyline projection along ω₁(J) was calculated using the VNMRJ software package. The 2D J-resolved spectra and their skyline projections were calibrated to the peak arising from formate at (8.444, 0.000) and 8.444 ppm, respectively. The time domain data of the 2D [¹H,¹H]-TOCSY spectra were multiplied by a cosine-bell squared window function in both dimensions and zero-filled to 16,384 and 512 points along t₂ and t₁, respectively. After FT, the 2D spectra were phase- and baseline-corrected, and calibrated to the peak arising from formate at (8.444, 8.444) ppm.

Sensitivity Comparison of Microflow and Cryogenic probe

One-dimensional ¹H NMR spectra were acquired for a 27 mM solution of formate in D₂O containing 0.9% NaCl. 20 μL of this solution was used for an Agilent INOVA 600 spectrometer equipped with Protasis microflow probe (Protasis, Inc., Marlboro, Mass.) to acquire a 1D spectrum using known techniques, and 170 μL were filled in a heavy-walled NMR tube (New Era Enterprises; catalog # NE-HP5-H-7) to acquire a 1D spectrum on the Agilent INOVA 600 spectrometer equipped with cryogenic probe which was used for the present study. The spectra were collected with 7.0 s relaxation delay between scans, 2.73 s direct acquisition time, a spectral width of 6,000 Hz and 4 scans. Prior to FT, the spectra were zero-filled to 131,072 points (no window function was applied) and the S/N values of the formate resonance line were compared. This revealed an about 10-times higher sensitivity for the set-up with the cryogenic probe.

NMR Signal Assignment

Metabolite resonances observed in 1D CPMG spectra were assigned using known techniques. Briefly, information on chemical shifts from literature and the Human Metabolome database (http://www.hmdb.ca) were combined with the use of Statistical Total Correlation Spectroscopy (“STOCSY”). Additional broad lines observed in 1D NOESY, DIRE, and DOSY were assigned using the same protocol. Resonance assignments were confirmed by analysis of 2D ¹H J-resolved, 2D [¹H,¹H] TOCSY, and 2D [¹³C,¹H] HSQC spectra, and by spiking the corresponding metabolites in a healthy control serum specimen. A survey of the resonance assignments is provided in Tables 2 and 3.

TABLE 2
Resonance assignments for metabolites in human serum

| | | | ^{13 C δ} | J^{HH} |
|---|---|---|---|---|
| Metabolites | assignment | ^{1 H δ (ppm)} | (ppm) | (Hz) |
| acetate | CH₃ | 1.9075 † | | |
| acetoacetate | CH₃ | 2.2675 † | | |
| | CH₂ | 3.4325 | | |
| acetone | CH₃ | 2.2175 † | | |
| alanine | CH₃ | 1.4575†, 1.4725 | 17.10 | 7.2 |
| | CH | 3.7625 | | |
| arginine | γ-CH₂ | 1.6875 | | |
| | β-CH₂ | 1.9025 † | | |
| asparagine | β-CH₂ | 2.8375, 2.8475 | | |
| | β-CH₂ | 2.9125, 2.9225 | | |
| aspartate | β-CH₂ | 2.6525, 2.6825 | | |
| | β-CH₂ | 2.7825, 2.7925 | | |
| betaine | CH₂ | 3.8925 | | |
| | N(CH_{3 )3} | 3.2525 | | |
| carnitine | N(CH_{3 )3} | 3.2175 | | |
| | NCH₂ | 2.4075 | | |
| citrate | CH₂ | 2.6675 †, 2.6975 | | 15.8 |
| creatine | CH₃ | 3.0225 † | 37.58 | |
| | CH₂ | 3.9225 | | |
| creatinine | CH₃ | 3.0275 † | | |
| | CH₂ | 4.0525 | | |
| formate | CH | 8.4425 | 171.70 | |
| α-glucose | C —H4 | 3.3925 | 70.30 | |
| | C —H2 | 3.5225, 3.5325 | 72.22 | 9.8/3.8 |
| | C —H3 | 3.7225, 3.7325 | 61.50 | |
| | C —H5 | 3.8225 | 72.20 | |
| | C —H6 | 3.8275 | 61.30 | |
| | C —H1 | 5.2225 | 92.83 | |
| β-glucose | C —H2 | 3.2325 | | |
| | C —H4 | 3.3925 † | | |
| | C —H5 | 3.4675 | 76.60 | |
| | C —H3 | 3.4825, 3.4975 | | |
| | C —H6 | 3.8825, 3.9025 † | 61.50 | |
| | C —H1 | 4.6325, 4.6425 | | 12.5/2.5 |
| glutamate | β-CH₂ | 2.1225 | | |
| | γ-CH₂ | 2.3325 | | |
| glutamine | β-CH₂ | 2.1225 | | |
| | γ-CH₂ | 2.4475 † | 31.60 | |
| glycerol | CH₂ | 3.5575 , 3.5675 | | 11.8, 6.5 |
| | CH₂ | 3.6325, 3.6375 | 61.50 | 11.8, 4.3 |
| glycine | CH₂ | 3.5475 | 42.33 | |
| histidine | C4H | 7.0325 † | | |
| | C2H | 7.7425 | | |
| β-hydroxy- | CH₃ | 1.1825 , 1.1925 † | | 6.3 |
| butyrate | CH₂ | 2.3025 , 2.3125 | | |
| | CH | 4.1575 | | |
| isoleucine | δ-CH₃ | 0.9125, 0.9225 † | | 7.5 |
| | β-CH₃ | 0.9925, 1.0025 | 15.42 | 7.0 |
| lactate | CH₃ | 1.3125 , 1.3225 | 20.88 | 6.9 |
| | CH | 4.0875 , 4.0975 † | | 6.9 |
| leucine | δ-CH₃ | 0.9475 , 0.9575 † | | 6.0 |
| | CH₂ | 1.7025 | | |
| lysine | δ-CH₂ | 1.6925 | | |
| | β-CH₂ | 1.8875 † | | |
| | ε-CH₂ | 3.0125 | | |
| mannose | C—H1 | 5.1725 † | | 1.3 |
| methionine | S—CH₃ | 2.1275 | | |
| | S—CH₂ | 2.6275 †, 2.6175 | | 7.5 |
| myoinositol | H5 | 3.2725 | | |
| | H2 | 4.0525 | | |
| ornithine | γ-CH₂ | 1.8325 | | |
| | β-CH₂ | 1.9275 | | |
| | δ-CH₂ | 3.0425 | | |
| phenylalanine | H2/H6 | 7.3225 | | |
| | H4 | 7.3775 | | |
| proline | γ-CH₂ | 1.9875 | | |
| | β-CH₂ | 2.0625 | | |
| | β-CH₂ | 2.3375 | | |
| | δ-CH₂ | 3.3375 †, 3.3175 | | 14.0 |
| | α-CH | 4.1325 , 4.1475 | | 8.8 |
| pyruvate | CH₃ | 2.3575 | | |
| sarcosine | CH₂ | 3.6025 | | |
| serine | β-CH₂ | 3.9625 † | | |
| threonine | CH₃ | 1.3075 | | |
| | α-CH | 3.5575 | | |
| | β-CH | 4.2375 † | | |
| tyrosine | H3/H5 | 6.8725 , 6.8825 | | |
| | H2/H6 | 7.1675 †, 7.1825 | | |
| valine | β-CH | 2.2525 | | |
| | CH₃ | 0.9675 ,0.9825 | | 7.0 |
| | CH₃ | 1.0225 †, 1.0325 | | 7.0 |
| | α-CH | 3.5925 | 61.30 | 4.5 |
| urea | NH₂ | 5.7825 † | | |

In Table 2, chemical shifts corresponding to the center of the bin used to calculate the ratios of average concentrations (see Table 9). Values having a ‘t’ indicate the bins that were used for Table 8. Resonance assignments that were confirmed in 2D [¹H,¹H]-TOCSY and/or 2D [¹³C,¹H]-HSQC spectra are underlined. Resonance assignments for bins that were confirmed by ‘spiking’ are in bold. Resonance assignments for H (2^{nd} column) that were confirmed using STOCSY are in bold.

TABLE 3
Resonance assignments for lipids and macromolecular
components in human serum

| Lipids and | | | |
|---|---|---|---|
| macromolecular | | ^{13 C δ} | ^{1 H δ} |
| components | assignment | (ppm) | (ppm) |
| albumin lysyl-1 | ε-CH2 | 40.03 | 2.897(5) ^{†} |
| albumin lysyl-2 | ε-CH2 | 40.03 | 2.952(5) |
| albumin lysyl-3 | ε-CH2 | 40.03 | 3.002(5) |
| cholesterol-1 | C21 | 19.11 | 0.902(5) |
| cholesterol-2 | C26 and C27 | 23.20 | 0.832(5) |
| cholesterol (HDL) | C18—H | 12.41 | 0.652(5) |
| cholesterol (LDL) | C18—H | | 0.647(5)^{†} |
| cholesterol (VLDL) | C18—H | | 0.692(5)^{†} |
| choline (lipids) | NCH2 | 66.59 | 3.652(5) ^{†} |
| choline | +N(CH_{3 )} | | 3.207(5)^{†} |
| (phospholipids) | | | |
| choline and glycerol | H | | 3.892(5)^{†} |
| (phospholipids) | | | |
| glyceryl of lipids-1 | CH2OCOR | | 4.052(5) |
| glyceryl of lipids-2 | CHOCOR | | 5.197(5) |
| glycoprotein α1- | NHCOCH3 | 22.81 | 2.027(5) ^{†} |
| acids-1 | | | |
| glycoprotein α1- | NHCOCH3 | 23.16 | 2.062(5) |
| acids-2 | | | |
| lipid-1 | C H 3CH2 | | 0.927(5)^{†} |
| lipid-2 | CH2CO | 34.29 | 2.232(5) ^{†} |
| lipid-3 | CH3CH2C H 2 | 32.65 | 1.217(5) ^{†} |
| lipid-4 | C H 2CH2CH2CO | | 1.307(5) |
| lipid (mainly | C H 3(CH2)n | 14.72 | 0.827(5) ^{†} |
| LDL)-1 | | | |
| lipid (mainly | (CH2)n | 30.43 | 1.237(5) ^{†} |
| LDL)-2 | | | |
| lipid (mainly | CH2 | | 1.252(5) |
| LDL)-3 | | | |
| lipid (mainly | C H 2CH2CH2CO | | 1.282(5)^{†} |
| VLDL)-1 | | | |
| lipid (mainly | C H 2CH2CO | 25.45 | 1.567(5) ^{†} |
| VLDL)-2 | | | |
| unsaturated lipid-1 | C H 2CH2C═C | 27.11 | 1.687(5) ^{†} |
| unsaturated lipid-2 | C═CCH2C═C | 26.15 | 2.697(5) ^{†} |
| unsaturated lipid-3 | —CH═C H CH2C H ═CH— | 128.46 | 5.222(5) |
| unsaturated lipid-4 | —CH═C H CH2C H ═CH— | 128.46 | 5.252(5) ^{†} |
| unsaturated lipid-5 | ═C H CH2CH2 | | 5.262(5)^{†} |
| unsaturated lipid-6 | ═C H CH2CH2 | | 5.322(5) |
| unsaturated lipid-7 | ═C H CH2CH2 | | 5.302(5) |
| unsaturated lipid | C H 3CH2CH2C═C | | 0.857(5)^{†} |
| (mainly VLDL) | | | |

In the “Assignment” column of Table 3, H denotes the assigned proton. In the column labeled “¹H δ (ppm),” chemical shifts correspond to the center of the bin used to calculate the ratios of average concentrations (see Table 9). Values having a ‘t’ indicate the bins used for Table 8. Resonance assignments that were confirmed in 2D [¹³C,¹H]-HSQC spectrum are underlined. The chemical shifts for albumin lysyl group were confirmed by ‘spiking’ and are in bold.

Statistical Analysis

Two-Class Model Construction

Construction of two-class models was performed in a data dimension reduction step (e.g., PLS or PCA) followed by class prediction (e.g., discriminant analysis or logistic regression). Alternatively, two-class models can be constructed by extracting the relevant classes from the follow three-class model approach (or other techniques).

Three-Class Model Construction

Construction of the three-class model was performed in four steps: Derivation of a cost of misclassification matrix from surgical cost information, data reduction by PLS2, density estimation, and estimation of decision boundaries to minimize expected cost. Information on biomarker concentration (e.g., leptin, prolactin, osteopontin, insulin-like growth factor 2, macrophage inhibitory factor, CA125, etc.) can be incorporated in the model to improve predictive accuracy.

Cost Matrix

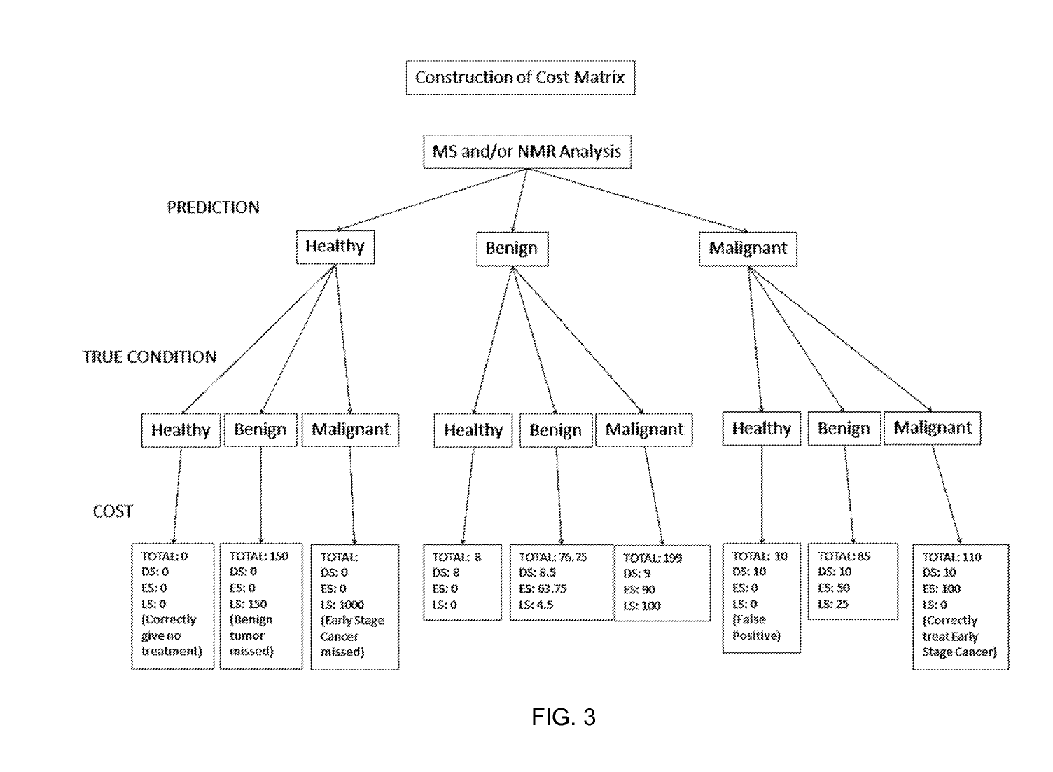

Estimates of treatment costs and probabilities of progression were used to estimate the expected cost of each treatment option for each class (FIG. 3; Table 4A). Briefly, if a healthy person is predicted to be healthy, no treatment cost is incurred. If an early stage cancer patient is predicted to be healthy, the definitive diagnosis is missed, the cancer progresses, and $1,000,000 is needed to treat the resulting late-stage cancer. If the early stage cancer had been predicted, it would have been confirmed by exploratory surgery and treated at an early stage: total cost $110,000. The opposite misclassification, predicting a healthy woman has early stage cancer, results in an unnecessary $10,000 diagnostic surgery.

Cases involving benign tumors or predictions of benign tumors are more complicated. Whereas a healthy prediction or a malignant prediction results in a definite treatment decision, a patient who receives a benign prediction (and her doctor) will base treatment on other factors (age, CA-125, desire to have children, etc.) Additionally, the progression of a benign tumor to an early stage malignant tumor is not well understood. Thus, costs for those cases are weighted averages over the possible treatment decisions.

Data Reduction

Two binary classification variables for benign and malignant tumor classes were created to distinguish the three classes. These response variables were used with the MS and/or NMR profiles in a multivariate PLS regression. The first PLS score vectors were used to represent the high dimensional data in just a few dimensions.

Density Estimation

For each of the three classes, the density of the reduced data was estimated by parametric (e.g., multivariate normality assumption) or nonparametric (e.g., kernel smoothing) methods.

Decision Boundaries

Decision rules were constructed to minimize expected cost. Using the densities just estimated and weighting by prior group membership probabilities that correspond to a high risk population (0.96 healthy, 0.02 benign, 0.02 early stage EOC), posterior probabilities of group membership are computed conditional on the MS and/or NMR data point. These probabilities are combined with the costs of misclassification to determine the expected cost of each action (i.e., predict healthy, predict benign, predict early stage). The decision rule is to choose the minimum cost at each reduced data point. That is, predict class k such that

$${\sum }_{i \neq k} {p}_{i} {c}_{ki} {f}_{i} ( z ) < {\sum }_{i \neq j} {p}_{i} {c}_{ji} {f}_{i} ( z )$$

holds for all j≠c and where pᵢ is the prior group membership probabilities, cₖᵢ is the cost of misclassifying an object in class i into class k, and fᵢ is the estimated density of the reduced spectral data for objects in class i. Costs have been standardized so that cᵢᵢ=0 (Table 4A).

TABLE 4A
Key figures of Cost Matrix (See also, FIG. 3)

| | | PREDICTION | | |
|---|---|---|---|---|
| COST | | Healthy | Benign | Malignant |
| TRUE | Healthy | 0 | 8 | 10 |
| STATUS | Benign | 150 | 76.75 | 85 |
| | Malignant | 1000 | 199 | 110 |

TABLE 4B
Costs standardized by subtracting diagonal elements. These represent
‘excess’ costs over the cost of a correct decision.

| | | PREDICTION | | |
|---|---|---|---|---|
| EXCESS COST | | Healthy | Benign | Malignant |
| TRUE | Healthy | 0 | 8 | 10 |
| STATUS | Benign | 73.25 | 0 | 8.25 |
| | Malignant | 890 | 89 | 0 |

Estimation of Performance

Data was initially split ⅔, ⅓ for model construction (training set) and model evaluation (test set). Each model was evaluated on the expected cost computed on the independent test set. In addition to expected cost, the sensitivity of detecting the presence of early stage ovarian cancer, the specificity of detecting absence of early stage ovarian cancer, and the positive predictive value of the model in a high risk population are reported.

Selection of Best Combination

To compare the predictive value of MS and the different types of NMR profiles, each was investigated separately and jointly with each other. Models built using profiles from more than one experiment used the concatenation of profiles, each normalized separately, as input to the two- or three-class model construction. The best model was chosen to be that with the lowest estimated expected cost. To evaluate fairly the performance of the best chosen model, a cross-validation loop within the training data was incorporated. Thus, the best model was chosen based on only the training set; its performance was then estimated on the test set.

Additional Covariates

Additional covariates (e.g., clinical measurements) can be included in model construction and evaluation. For example, in the case of a two-class model, logistic regression can include these covariates in addition to the reduced spectrometer data; in the case of a three-class model, these covariates can be included as additional dimensions in the reduced data space.

Prediction and Prognosis

With longitudinal data, alternative models (e.g., Cox proportional hazards, etc.) can be used to model time to disease (for currently healthy women) and time to death (for women with cancer) based on the reduced MS and/or NMR data.

Results and Discussion

Based on the cost structure outlined in FIG. 3 (see also, Tables 4A and 4B), if no screening is available, the average cost per woman in the high risk population is assumed to be $23,000. While no money is spent on healthy women, 2.3% eventually are treated for late stage cancer (“LS”). One alternative is to perform Diagnostic Surgery (“DS”) on all women in the high risk population. This reduces the average cost to $13,500 per women but has an unacceptably high rate of unnecessary surgery (2 malignant tumors found per 100 surgeries; PPV=2%). Methods finding fewer than 10 malignant tumors per 100 surgeries (PPV<10%) are often considered to be not practical.

MS Profiles from 120 specimens

Based on n=120 samples (n=80 training, n=40 test) for which MS profiles are available, the estimated cost per women in a high risk population is reduced to $8,300 (as compared to $23,000 in the absence of a screening test). Furthermore, the positive predictive value of a malignant tumor diagnosis is estimated to be 15% (see last row of Table 5).

Comparison of MS Profiles with Individual NMR Profiles from 120 Specimens

Based on n=120 samples (n=80 training, n=40 test), eight models were constructed from the eight types of profiles. The estimated cost per women in a high risk population is summarized in Table 5 along with other performance measures. Several offer low cost and desirable operating characteristics.

TABLE 5
Expected Cost and Operating Characteristics
of tests based on a single profile

| | | Sensitivity | Specificity | PPV for |
|---|---|---|---|---|
| | Expected | for | for Non- | Malignant |
| | Cost | Malignant Tumor | Malignant Tumor | Tumor |
| CPMG | 9.28 | 0.62 | 0.77 | 0.14 |
| DIRE | 9.57 | 0.62 | 0.83 | 0.08 |
| DOSY | 8.34 | 0.62 | 0.67 | 0.08 |
| NOESY | 8.49 | 0.62 | 0.83 | 0.66 |
| SKYLINE | 8.77 | 0.46 | 0.83 | 0.60 |
| TOCSY | 11.73 | 0.62 | 0.60 | 0.05 |
| 2DJ | 10.71 | 0.69 | 0.73 | 0.04 |
| MS | 8.26 | 0.77 | 0.53 | 0.15 |

Combination of the MS Profiles and Different Types of NMR Profiles from 120 Specimens

Based on n=120 samples (n=81 training, n=39 test), 255 models were constructed from all possible combinations of the eight types of profiles collected. The models were ranked based on 5-fold cross-validation within the training dataset. The best models were selected and their performances were evaluated on the test dataset. The estimated cost per women in a high risk population is summarized in Table 6 along with other performance measures. The performances of the top two models (MS+TOCSY and MS+SKYLINE) are comparable or improvements on the MS model alone. Additional models are included in Table 6 to illustrate the range of performance. Expected costs estimated from the Test Set ranged from 6.12 to 12.93 (median=8.37); PPV computed from the Test Set ranged from 0.77 to 0.03 (median=0.15).

TABLE 6
Expected Cost and Operating Characteristics
of tests based on combinations of profiles

| | | | Sensitivity | Specificity | |
|---|---|---|---|---|---|
| Rank in | | Ex- | for | for Non- | PPV for |
| Train- | | pected | Malignant | Malignant | Malignant |
| ing Set | Profiles Used | Cost | Tumor | Tumor | Tumor |
| 1 | MS + TOCSY | 8.50 | 0.62 | 0.63 | 0.13 |
| 2 | MS + | 7.64 | 0.69 | 0.80 | 0.65 |
| | SKYLINE | | | | |
| 3 | CPMG + DIRE + | 9.11 | 0.69 | 0.70 | 0.09 |
| | DOSY + NOESY | | | | |
| 103 | All 7 NMR | 10.70 | 0.62 | 0.73 | 0.06 |
| 114 | NOESY + | 12.93 | 0.69 | 0.70 | 0.05 |
| | TOCSY | | | | |
| 119 | MS | 8.26 | 0.77 | 0.53 | 0.15 |
| 235 | SKYLINE + | 8.85 | 0.54 | 0.67 | 0.07 |
| | TOCSY | | | | |
| 251 | 2DJ | 10.72 | 0.69 | 0.73 | 0.04 |

Combination of Different Types of NMR Profiles from 343 Specimens

Based on n=328 samples (n=214 training, n=114 test), 127 models were constructed from all possible combinations the eight types of profiles collected. The models were ranked based on 5-fold cross-validation within the training dataset. The best models were selected and their performances were evaluated on the test dataset. The estimated cost per women in a high risk population is summarized in Table 7 along with other performance measures. The performances of the top models exceed the performance of any one model. Additional models are included in Table 7 to illustrate the range of performance. Expected costs estimated from the Test Set ranged from 11.18 to 13.01 (median=12.13); PPV computed from the Test Set ranged from 0.31 to 0.07 (median=0.13).

TABLE 7
Expected Cost and Operating Characteristics of
tests based on combinations of NMR profiles

| | | | Sensitivity | Specificity | |
|---|---|---|---|---|---|
| Rank in | | Ex- | for | for Non- | PPV for |
| Train- | | pected | Malignant | Malignant | Malignant |
| ing Set | Profiles Used | Cost | Tumor | Tumor | Tumor |
| 1 | DIRE + | 11.99 | 0.55 | 0.77 | 0.10 |
| | SKYLINE + | | | | |
| | TOCSY + 2DJ | | | | |
| 2 | CPMG + DIRE + | 11.59 | 0.55 | 0.80 | 0.13 |
| | NOESY + | | | | |
| | SKYLINE + | | | | |
| | TOCSY + 2DJ | | | | |
| 3 | CPMG + DIRE + | 12.17 | 0.63 | 0.80 | 0.19 |
| | TOCSY + 2DJ | | | | |
| 25 | All 7 NMR | 12.09 | 0.58 | 0.84 | 0.11 |
| 70 | CPMG | 13.01 | 0.40 | 0.91 | 0.24 |
| 123 | 2DJ | 12.79 | 0.40 | 0.84 | 0.07 |

Changes of Metabolite Concentrations from NMR Profiles

The measurement of changes of metabolite concentrations (Tables 6 and 7) enables one to compare healthy and malignant metabolic phenotypes as manifested in serum. Changes of serum metabolite concentrations were determined for the three pairs of classes of serum specimens, that is, (i) healthy controls versus early stage EOC tumors, (ii) healthy controls versus benign ovarian tumors, and (iii) early stage EOC versus benign ovarian tumors.

Due to the complexity of metabolic regulation and compartmentalization in the human body, it is quite challenging to unambiguously relate these concentration changes to corresponding changes in specific organs, tissues, or even the tumor itself. Nonetheless, the phenotypic changes that were detected in serum upon onset of tumor growth can be compared with current knowledge of tumor metabolism in order to assess if phenotypic tumor features are reflected in the serum profiles, and changes of serum profiles described for other types of cancer employing NMR-based metabonomics.

TABLE 8
Significance analysis for metabolite, lipids and macromolecular
components concentration changes

| | EOC vs Healthy | | | | | Benign vs Healthy | | | | | EOC vs Benign | | | | |
|---|---|---|---|---|---|---|---|---|---|---|---|---|---|---|---|
| | I | O | S | C | N | I | O | S | C | N | I | O | S | C | N |
| Metabolites | | | | | | | | | | | | | | | |
| acetate | | | | | N | | | | | N^{†} | | | | | |
| acetoacetate^{a} | | | S^{‡} | C^{‡} | N^{†} | | | S^{†} | | | | | S | C^{‡} | N^{†} |
| acetone^{a} | | | S^{‡} | C^{‡} | N | | | S^{†} | C^{†} | N | | | | | |
| alanine^{a} | | | S | C^{‡} | N^{‡} | | | S^{‡} | C^{‡} | N^{‡} | | | | | |
| citrate | | | | C^{‡} | N^{†} | | | | | N^{†} | | | | | |
| creatine^{a} | | | S^{‡} | C^{‡} | | | | S^{‡} | C^{‡} | N^{‡} | | | | | |
| creatinine^{a} | | | | C^{‡} | | | | S^{†} | C^{‡} | | | | | | |
| glucose | | | S^{‡} | | N^{‡} | | | S^{‡} | | N^{‡} | | | | | |
| glutamine | | | S^{‡} | C^{‡} | N^{‡} | | | | C^{†} | N^{‡} | | | | | |
| histidine | | | S^{‡} | C^{‡} | N | | | | | N | | | | C | N^{†} |
| β-hydroxybutyrate^{a} | | | S^{‡} | C^{‡} | | | | S^{‡} | | | | | S^{†} | | |
| isoleucine | | | | C^{‡} | N^{‡} | | | | | | | | | C^{‡} | N^{†} |
| lactate | | | S^{‡} | | | | | S^{‡} | | | | | | | |
| leucine | | | | | N^{†} | | | | | | | | | | |
| lysine | | | | C^{‡} | N | | | | | N^{‡} | | | | | |
| mannose | | | S^{‡} | C | N | | | | C | N^{‡} | | | S^{†} | | |
| methionine | | | | | | | | | | N^{‡} | | | | | |
| proline | | | S | C^{‡} | | | | | C^{‡} | N^{‡} | | | | | |
| serine | | | S^{†} | | | | | S^{‡} | | | | | | | |
| threonine | | | S^{†} | C^{‡} | | | | | | | | | | | |
| tyrosine | | | | C^{‡} | N^{‡} | | | | | N^{‡} | | | | | |
| urea | | | | C | N | | | | | | | | | | |
| valine^{a} | | | S | C^{‡} | N^{‡} | | | S^{‡} | C^{‡} | N^{†} | | | | | |
| Lipids and | | | | | | | | | | | | | | | |
| macromolecular | | | | | | | | | | | | | | | |
| components | | | | | | | | | | | | | | | |
| albumin lysyl-1 | | O | | C^{‡} | N^{‡} | | O | | C^{‡} | N^{‡} | | | | | |
| cholesterol (LDL) | | O^{†} | | | N^{‡} | | O^{‡} | | | N^{‡} | | | | | |
| cholesterol (VLDL) | | | | | | | O^{‡} | | | N^{‡} | | | | | |
| choline (lipids) | | | | | | | | | | | | O | | | |
| choline (phospholipids)^{a} | I | O | | C | N | I | O^{‡} | | C | N | | | | | |
| choline and glycerol | I^{†} | O | | | | I | | | | | I^{†} | O^{‡} | | | |
| (phospholipids) | | | | | | | | | | | | | | | |
| glycoprotein α-lacids-1 | I^{‡} | O | S^{‡} | C^{‡} | N | | | S | | | I^{‡} | O | S | C^{‡} | N |
| lipid-1 | I | O^{‡} | | | | | | | | | I^{†} | | | | |
| lipid-2 | | | | | | I^{†} | O^{‡} | | | N^{†} | I^{‡} | O^{‡} | | | N^{‡} |
| lipid-3 | I | O | | | N | I^{‡} | | | | | | | | | |
| lipid (mainly LDL)-1^{a} | I | O^{‡} | | C | N | I^{‡} | O^{‡} | | C^{‡} | N | | | | C^{†} | |
| lipid (mainly LDL)-2 | | | | C^{‡} | | | | | | | | | | | |
| lipid (mainly VLDL)-1^{a} | | | | | | | O^{‡} | | | N^{‡} | I | O^{†} | | C | N |
| lipid (mainly VLDL)-2 | | | | | | I^{†} | O^{‡} | | | N^{†} | I^{‡} | O^{‡} | | C^{‡} | N^{‡} |
| unsaturated lipid-1 | | O^{‡} | | | | | | | | | | | | | |
| unsaturated lipid-2 | | | | | | I | O^{‡} | | | | | | | | |
| unsaturated lipid-4 | I^{‡} | O^{‡} | | | N | | O^{‡} | | | | | | | | N^{†} |
| unsaturated lipid-5^{a} | I^{‡} | | | C^{‡} | | | | | | | I^{†} | O^{‡} | | | |
| unsaturated lipid (mainly | | | | C^{‡} | | | | | | | | | | | |
| VLDL)^{a} | | | | | | | | | | | | | | | |

In Table 8, serum metabolites and lipid/macromolecular components for which significant concentration changes were detected in 1D CPMG spectra recorded on a microflow probe for serum specimens obtained from women with early stage EOC and healthy controls. A one-letter designation for different types of NMR spectra collected on a cryogenic probe was used as follows: I=‘DIRE,’ O=‘DOSY;’ S=skyline projection of 2D J-resolved, C=‘CPMG,’ N=‘NOESY.’ Letters in bold/regular indicate that a higher/lower concentration is observed in sera obtained from women with early stage EOC or from women with benign tumor when compared with the healthy controls, or higher/lower concentration is observed in sera of women with early stage EOC when compared to women with benign tumor. Letters having the symbol ‘‡’ indicate p-value≦10^{-3;} letters denoted with the ‘†’ symbol indicate p-value=10⁻⁴. Underlined letters indicate that p-value<10⁻³ was obtained from both univariate and multivariate data analysis.

TABLE 9
Ratios of average serum concentrations of metabolites,
lipids and macromolecular components derived by NMR

| | Cancer/ | | Benign/ | | Cancer/ | |
|---|---|---|---|---|---|---|
| | Healthy^{a} | | Healthy^{b} | | Benign^{c} | |
| | ratio | std dev | ratio | std dev | ratio | std dev |
| Metabolites | | | | | | |
| acetate | <1 | | <1 | | | |
| acetoacetate | 4.531 | 0.976 | 2.199 | 0.503 | 2.060 | 0.339 |
| acetone | 3.571 | 0.646 | 3.315 | 0.716 | | |
| alanine | 0.588 | 0.045 | 0.614 | 0.050 | | |
| citrate | <1 | | <1 | | | |
| creatine | 0.661 | 0.051 | 0.740 | 0.056 | | |
| creatinine | <1 | | 0.783 | 0.056 | | |
| glucose | 1.020 | 0.030 | 1.060 | 0.030 | | |
| glutamine | 0.646 | 0.060 | <1 | | | |
| histidine | 0.585 | 0.079 | <1 | | 0.658 | 0.066 |
| β-hydroxybutyrate | 5.150 | 1.153 | 2.719 | 0.623 | 1.894 | 0.319 |
| lactate | 1.744 | 0.201 | 1.911 | 0.231 | | |
| leucine | <1 | | | | | |
| lysine | 0.769 | 0.032 | <1 | | | |
| mannose | 1.539 | 0.113 | >1 | | 1.311 | 0.102 |
| methionine | | | <1 | | | |
| proline | 0.475 | 0.066 | 0.847 | 0.035 | | |
| serine | 0.721 | 0.067 | 0.716 | 0.058 | | |
| threonine | 0.488 | 0.088 | | | | |
| tyrosine | 0.796 | 0.040 | <1 | | | |
| urea | 0.473 | 0.049 | | | | |
| valine | 0.667 | 0.036 | 0.710 | 0.040 | | |
| Lipids and | | | | | | |
| macromolecular | | | | | | |
| components | | | | | | |
| albumin lysyl-1 | 0.863 | 0.024 | 0.829 | 0.030 | | |
| cholesterol (LDL) | <1 | | <1 | | | |
| cholesterol (VLDL) | | | 0.892 | 0.022 | | |
| choline (lipids) | | | | | >1 | |
| choline | 0.667 | 0.035 | 0.701 | 0.043 | | |
| (phospholipids) | | | | | | |
| choline and glycerol | 1.345 | 0.095 | 0.993 | 0.064 | 1.355 | 0.109 |
| (phospholipids) | | | | | | |
| glycoprotein α1- | | | 0.654 | 0.044 | >1 | |
| acids-1 | | | | | | |
| lipid-1 | >1 | | | | | |
| lipid-2 | | | 1.243 | 0.068 | 0.788 | 0.044 |
| lipid-3 | <1 | | <1 | | | |
| lipid (mainly LDL)-1 | <1 | | <1 | | <1 | |
| lipid (mainly LDL)-2 | <1 | | | | | |
| lipid (mainly VLDL)-1 | | | >1 | | <1 | |
| lipid (mainly VLDL)-2 | | | 1.151 | 0.041 | 0.861 | 0.031 |
| unsaturated lipid-1 | 0.956 | 0.023 | | | | |
| unsaturated lipid-2 | | | 0.861 | 0.025 | | |
| unsaturated lipid-4 | 0.884 | 0.022 | 0.904 | 0.022 | <1 | |
| unsaturated lipid-5 | 0.837 | 0.030 | | | 0.892 | 0.031 |
| unsaturated lipid | <1 | | | | | |
| (mainly VLDL) | | | | | | |

^{a}Concentration registered in sera of women diseased with early stage EOC over concentration registered in sera from healthy controls.
^{b}Concentration registered in sera of women diseased with benign ovarian tumor over concentration registered in sera from healthy controls.
^{c}Concentration registered in sera of women diseased with early stage EOC over concentration registered in sera from women diseased with benign ovarian tumor.

In Table 9, ratios and corresponding standard deviations are provided only for metabolites exhibiting well resolved signals in at least one of the NMR experiments. The standard deviations were calculated employing the ‘delta method.’ In cases where spectral overlap impeded accurate measurement of the ratio, only decrease (ratio<1) or increase (ratio>1) are indicated.

Comparison to Other Types of Cancers

TABLE 10
Concentration profile changes for metabolites, lipids, and macromolecular
components associated with different types of cancer/tumors investigated by
¹H NMR-based metabonomics of serum

| Metabolites, lipids and | | | | | | | | | | | | |
|---|---|---|---|---|---|---|---|---|---|---|---|---|
| macromolecular | | | | | | | | | | | | |
| components | C vs H^{a} | B vs H^{a} | C vs B^{a} | OrC | LC | HCC | PcC | RCC | CrC | RBC | EsC | PCa |
| acetate | ↑ | ↑ | — | ↑ | ↓ | ↓ | | ↓ | ↓ | | | |
| acetoacetate | ↓ | ↓ | ↓ | ↓ | ↑ | ↑ | | ↑ | ↓ | | | — |
| acetone | ↓ | ↓ | — | ↓ | | | ↓ | | ↓ | | | |
| alanine | ↑ | ↑ | — | ↑ | | | | ↓ | | | | |
| asparagine | — | — | — | ↓ | | | ↑ | | | | | |
| betaine | | | | ↓ | | | | | | | | |
| carnitine | — | — | — | | | | | | | | | |
| choline | | | | ↓ | ↑ | ↑ | | | | ↑ | | |
| citrate | ↑ | ↑ | — | ↑ | | | | | | | ↓ | |
| creatine | ↑ | ↑ | — | ↑ | | | ↑ | | | | | |
| creatinine | ↑ | ↑ | — | ↑ | | | | | | | ↓ | |
| ethanol | | | | ↑ | | | ↑ | | | | | |
| formate | — | — | — | ↑ | | | ↓ | | | ↑ | | ↓ |
| glucose | ↓ | ↓ | — | ↓ | | | ↓ | ↑ | ↑ | | ↓ | |
| glutamate | — | — | — | | | | ↓ | | | | | ↓ |
| glutamine | ↑ | ↑ | — | ↑ | ↓ | ↓ | ↑ | ↑ | | | ↓ | |
| glycerol | — | — | — | | ↓ | ↓ | ↑ | ↓ | | | | |
| glycine | — | — | — | ↑ | | | | | | | | |
| histidine | ↑ | ↑ | ↑ | | | | | | | ↑ | | |
| α-hydroxybutyrate | | | | | ↓ | | | | | | | |
| β-hydroxybutyrate | ↓ | ↓ | ↓ | ↓ | ↓ | | ↓ | | ↓ | — | ↓ | |
| isoleucine | — | — | — | ↑ | ↑ | — | | ↓ | | | | |
| α-ketoglutarate | | | | | ↓ | ↓ | | | | | | |
| lactate | ↓ | ↓ | — | ↑ | | | | ↓ | ↓ | — | ↓ | |
| leucine | ↑ | — | — | ↑ | ↑ | — | | ↓ | | | | |
| lysine | ↑ | ↑ | — | ↑ | | | ↑ | | | | ↓ | — |
| mannose | ↓ | ↓ | ↓ | | | | ↓ | | | | | |
| methionine | — | ↑ | — | | | | | | | | | |
| 1-methylhistidine | — | — | — | | ↓ | ↓ | | | | | | |
| ornithine | — | — | — | ↓ | | | | | | | | |
| phenylalanine | — | — | — | ↑ | ↓ | ↓ | ↓ | | | | | |
| proline | ↑ | ↑ | — | ↑ | | | ↑ | | | ↑ | | |
| pyruvate | — | — | — | ↓ | ↓ | ↓ | | | | | | |
| sarcosine | — | — | — | ↓ | | | | | | | | |
| serine | ↑ | ↑ | — | ↑ | | | | | | | | |
| taurine | | | | | ↓ | — | | | | | | |
| threonine | ↑ | — | — | ↑ | | | ↑ | | | | | |
| tyrosine | ↑ | ↑ | — | ↑ | ↓ | ↓ | | | | — | | — |
| urea | ↑ | — | — | | | | ↑ | | | | | |
| valine | ↑ | ↑ | — | ↑ | ↑ | ↑ | | ↓ | | | | |
| albumin lysyl-1 | ↑ | ↑ | — | | | | | | | | | |
| cholesterol | ↑ | ↑ | — | | | | | | | | | |
| choline | ↑ | ↑ | — | | | | | ↑ | | | | |
| (phospholipids) | | | | | | | | | | | | |
| glycoprotein α-1 | — | ↑ | ↓ | | ↓ | ↓ | | | | | | |
| acids-1 | | | | | | | | | | | | |
| saturated lipid | ↑ | ↑ | ↑ | | ↑ | ↑ | | | | | | ↓ |
| unsaturated lipid | ↑ | ↑ | ↑ | | ↑ | ↑ | | ↑ | | | | ↓ |

| | | | | | | | | | |
|---|---|---|---|---|---|---|---|---|---|
| Total number of concentration | 30 | 17 | 17 | 16 | 13 | 7 | 7 | 7 | 7 |
| changes observed | | | | | | | | | |
| Number of matches when compared | 17 | 4 | 4 | 10 | 4 | 4 | 2 | 3 | 0 |
| with EOC | | | | | | | | | |
| Number of mismatches when | 9 | 10 | 10 | 5 | 9 | 3 | 4 | 4 | 7 |
| compared with EOC | | | | | | | | | |

^{a}From Table 7.

In Table 10, ‘↑’ indicates higher concentration and ‘↓’ indicates lower concentration for this metabolite was registered in serum specimens from patients diseased with a given type of cancer when compared with healthy controls, or from women with early stage EOC compared to women with benign ovarian tumor (column 3). ‘—’ indicates that the metabolite concentration was measured but was found not to change significantly. No symbol indicates that the metabolite concentration change was not assessed. The headings in the table are abbreviated as follows: OrC: Oral Cancer; LC: Liver Cirrhosis; HCC: Hepatocellular carcinoma; PcC: Pancreatic Cancer; RCC: Renel Cell Carcinoma; CrC: Colorectal Cancer; RBC: Recurrent breast cancer; EsC: Esophageal cancer ; PCa: Prostate Cancer.

Second Exemplary Embodiment

NMR Sample Preparation

Serum specimens (stored at −80° C.) were thawed at room temperature. Subsequently, NMR samples were prepared by combining 27 μL of serum with 3 ρL of a D₂O solution required to lock the spectrometer. The D₂O solution contained the internal standard formate (27 mM) and NaCl (0.9% w/v). The resulting solution was filtered through a barrier tip (Catalog # 87001-866; VWR International, West Chester, Pa., USA) into a 12×32 mm glass screw neck vial (Waters Corp., Milford, USA) by centrifugation for 5 minutes at 5° C.

Operator Certification

Before the start of NMR data acquisition, an operator was certified for data collection using an NMR spectrometer equipped with a cryogenic probe. For example, experiments performed by previously certified operators are repeated by a candidate operator using the same samples. Statistical analyses are performed to compare the spectra obtained by the candidate operator against the spectra previously obtained by the certified operator. Such comparisons are used to determine whether or not the candidate operator will be certified.

NMR Data Collection

After NMR sample (˜20 μL volume) preparation, data were acquired following a standard operating procedure (“SOP”) at 25.0 ° C. on an Agilent INOVA 600 spectrometer equipped with a Protasis microflow probe (Protasis Inc., Marlboro, Mass.). NMR spectra were acquired for all specimens in a randomized order to minimize potential run-order effects affecting multivariate data analysis. For each sample, one-dimensional (1D) ¹H NOESY (100 ms mixing time) and ¹H Carr-Purcell-Meiboom-Gill (CPMG; 80 ms spin-lock eliminating the broad resonance lines of high molecular weight compounds in the serum specimens) spectra were recorded. For each spectrum, 256 scans were accumulated with 8.5 s relaxation delay and 1.4 s direct acquisition time (other acquisition parameters were similar to those published in ref 14; Supplementary Methods) in ˜45 min. This yielded a total measurement time of 528 hours for all 352 samples. Principal components analyses confirmed the absence of any run order effects. Furthermore, after every 10 serum samples, the entire SOP was repeated. This included the recording of a 1D NOESY spectrum for a fetal bovine serum test sample. Principal components analyses confirmed that the spectra recorded for the test sample spectra were statistically indistinguishable.

¹H Nuclear Magnetic Resonance (NMR) data were acquired on a Agilent Inova-600 spectrometer equipped with a Protasis flow probe. Samples were handled by use of a Protasis auto sampler, equipped with a refrigerated sample chamber maintained at 4° C. The spectral data collection was achieved through the Protasis One Minute NMR software interfaced to the Agilent VNMRJ software on the spectrometer.

NMR Spectral Data Collection

The serum samples for NMR measurement were prepared by thawing the sample from −80° C. to room temperature, and mixing an aliquot of 45 μL of serum with 5.0 μL of lock solution. The lock solution contains 27 mM formate in D₂O at physiological ionic strength (0.9% sodium chloride). A 20 μL portion of the resulting solution is used for NMR data acquisition, and the remainder of the sample is snap-frozen and kept at −80° C.

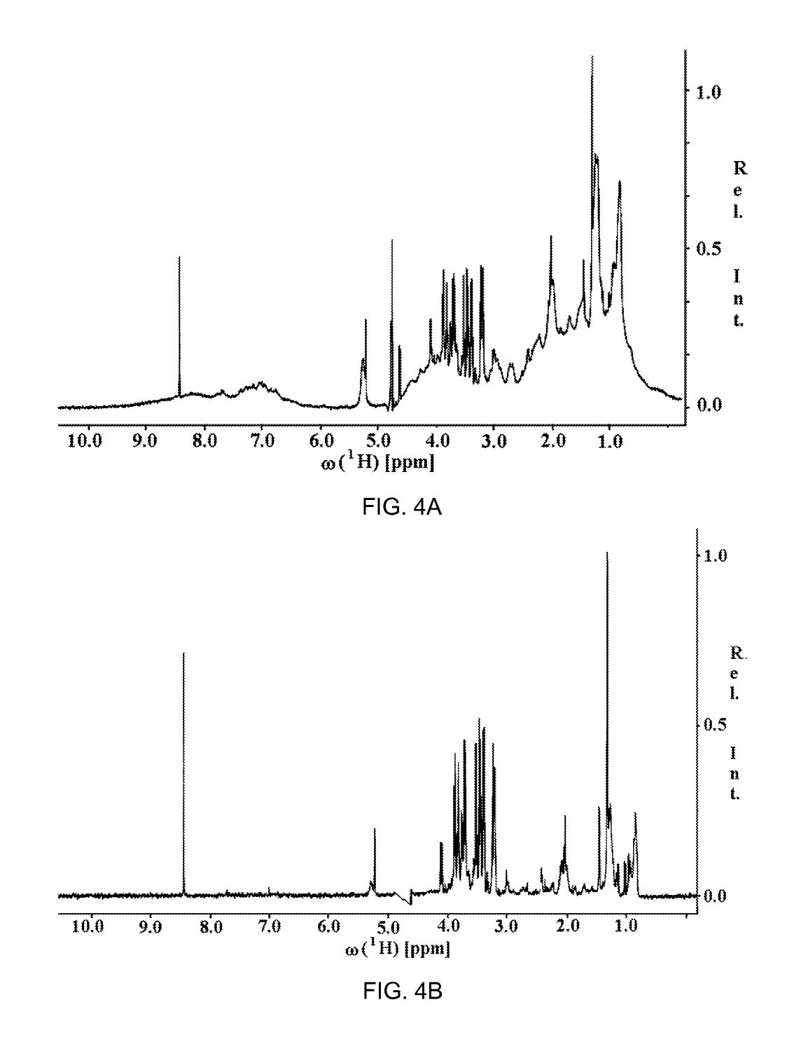

1D-NOESY and CPMG ¹H NMR spectra were recorded for each sample using solvent pre-saturation. FIG. 4A-4B shows a representative 1D-NOESY (FIG. 4A) and CPMG (FIG. 4B) spectra. All data were acquired at 298K. The NMR spectra of serum samples from early stage ovarian cancer patients show discernable difference compared to those from controls over NMR spectral range.

NMR Data Processing and Validation of Spectral Quality

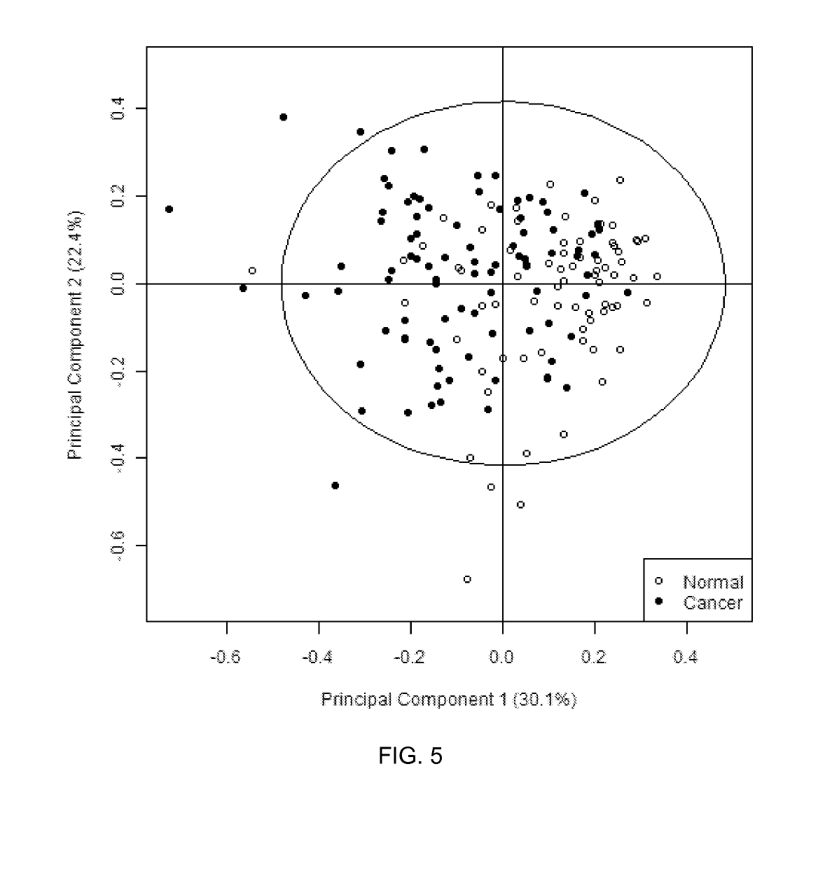

A SOP was defined for NMR data processing and quality validation. Time domain data were zero-filled four-fold to 131,072 points and multiplied by an exponential window function corresponding to a line broadening of 1.2 Hz prior to Fourier transformation. The spectra were phase- and linearly baseline-corrected using VNMRJ, and calibrated to the resonance line of the internal standard formate at 8.444 ppm. Representative NMR spectra are shown in FIG. 6. Prior to statistical analysis, the quality of each frequency domain spectrum was validated by (i) measuring the signal-to-noise (S/N) ratio and line width (at half height and 10% intensity) for the formate signal, (ii) inspecting the quality of the ‘water suppression’, and (iii) calculating specifically defined figures-of merit ensure unbiased baseline and phase correction.

Statistical Analysis

Statistical procedures were used (i) to build a predictive model for disease status based on the CPMG and NOESY spectra recorded for the first set of specimens (see above), and (ii) to compare their predictive accuracy. Spectra were normalized to unit integral and binned (0.004 ppm resolution) to reduce effects arising from slight variations of, respectively, total signal and signal positions. The resulting bin intensity arrays contained 3,620 variables and were ‘Pareto-scaled’ (i.e., mean centered and divided by square root of standard deviation). A principal component analysis was performed to obtain orthogonal linear combinations of bin intensities with maximal variation of variables. Principal components (“PCs”) were added in decreasing order of their represented variability into a logistic regression prediction model until a new addition was not statistically significant.

Results and Discussion

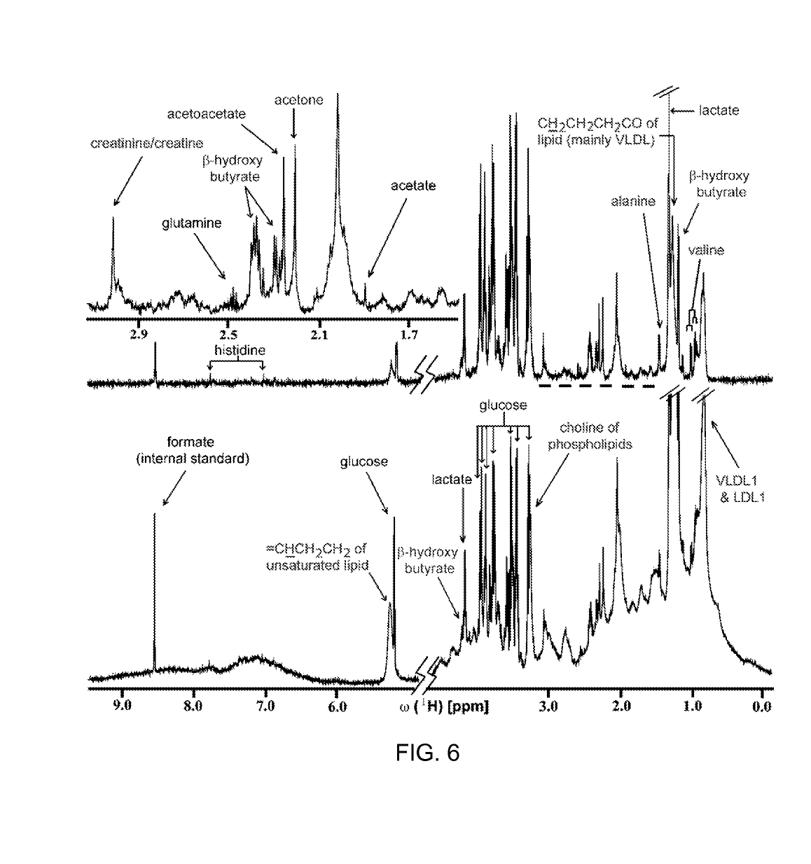

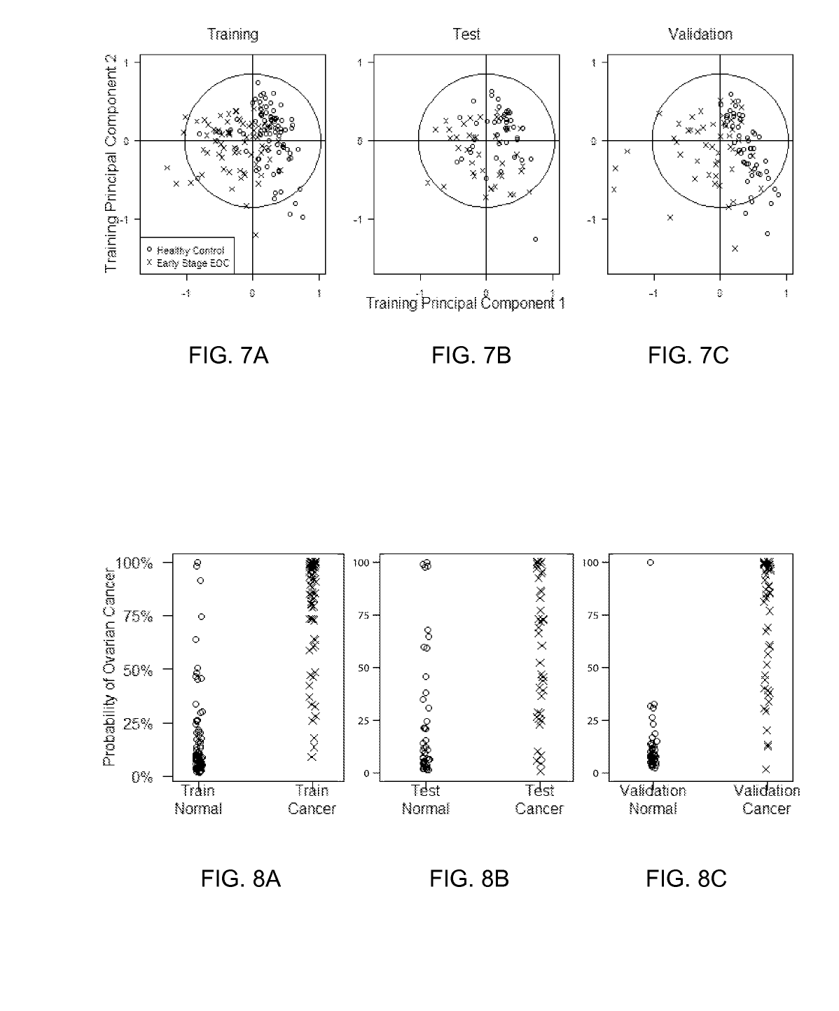

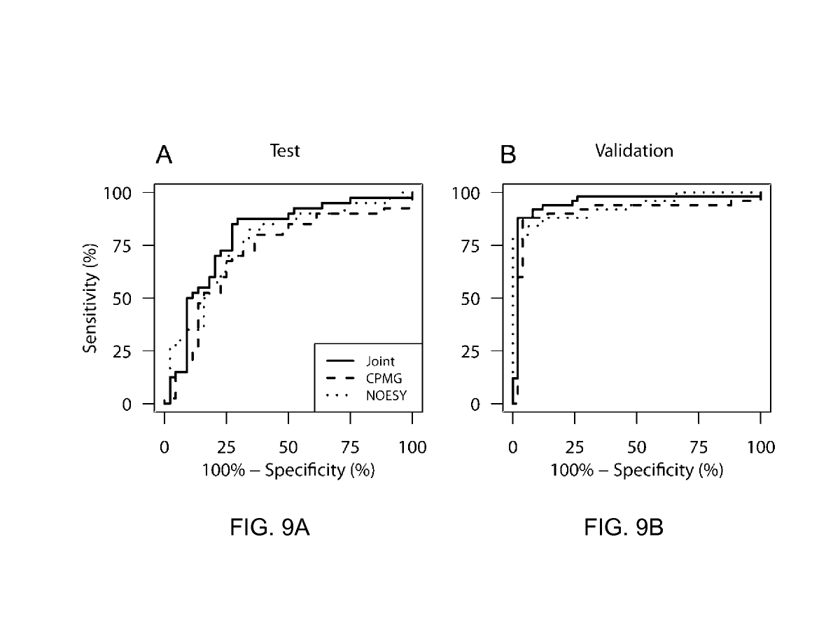

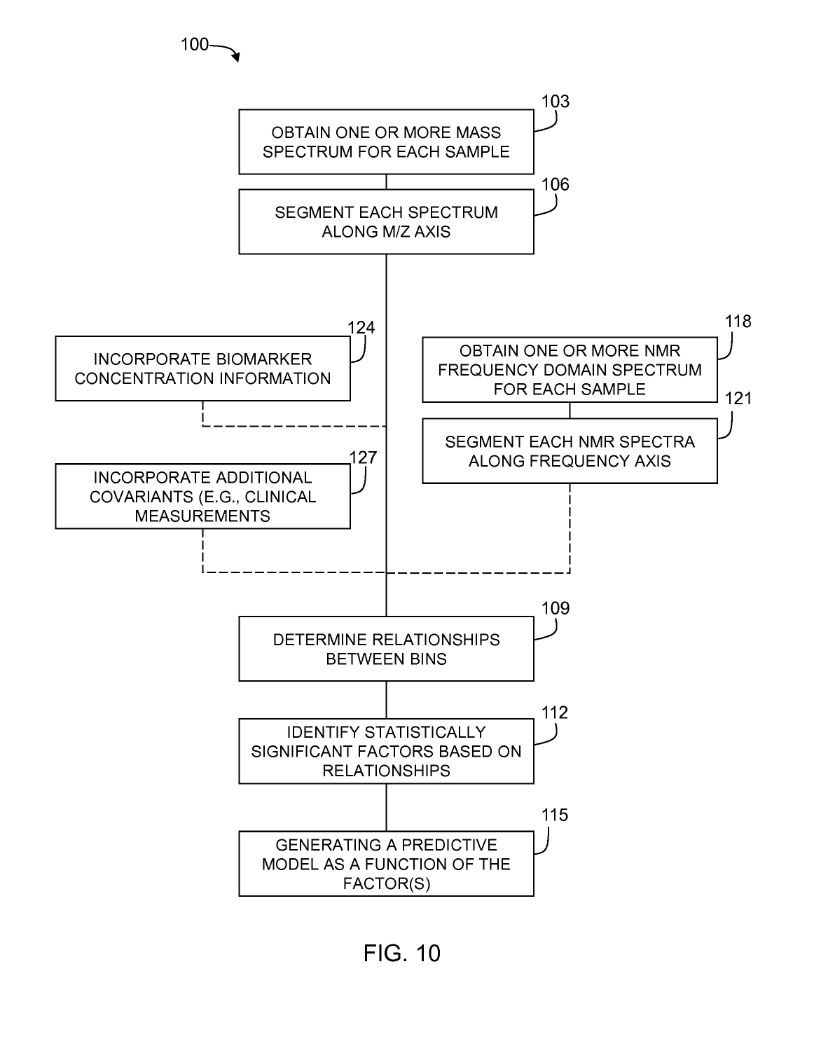

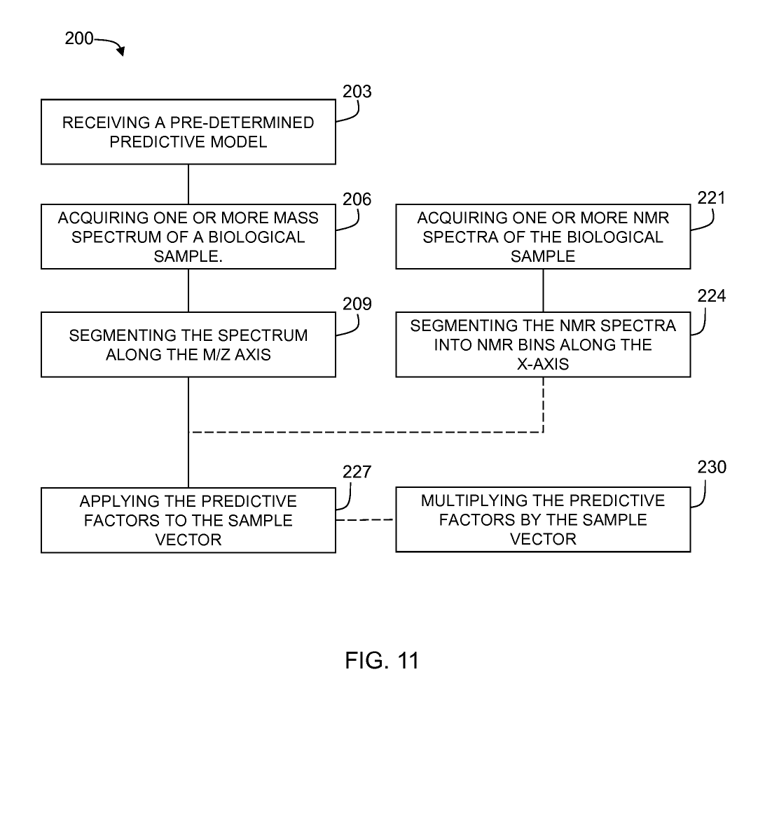

In order to build a predictive statistical model for diagnosis of early stage EOC, two thirds of the first set of specimens (i.e., 80 of 120 early stage EOC and 88 of 132 healthy controls) were randomly selected as the training set, and the remaining specimens formed the test set (FIGS. 7A, B). Out of the 168 training samples, the spectra of 11 EOC and 4 healthy controls exhibited ¹H lines which are generally not observed in serum spectra and were therefore deemed outliers. Thus, those were not considered for the training set used to build a predictive statistical model. Subsequently, three models were built with (a) CPMG or (b) NOESY bin intensity arrays, and (c) both types of bin arrays being concatenated (‘joint model’). Their accuracy for the test set was quite similar (i.e., predictions based on CPMG and NOESY bin arrays were consistent in nearly all cases), but the joint model was slightly superior for differentiating classes (Table 11; see also, FIG. 9A). For the joint model, four PCs were selected for prediction based on the training set (FIG. 8A) yielding a 4-variable logistic regression model with operating characteristics estimated for the test set (no outliers were excluded; FIG. 7B) at 82% specificity [95% confidence interval (CI): 65% to 90%], 63% sensitivity (95% CI: 46% to 77%), and an area under the Receiver Operator Characteristic Curve (“AUC”) of 0.796 (FIG. 9A). Importantly, the predictive model together with an a priori probability of EOC (‘prevalence’ in a population) can be used in a clinical setting to calculate the posterior probability, p-EOC, of early stage EOC based on the NMR profile (FIG. 8).

To independently validate the model, spectra for the second set of 100 samples, which we obtained after the predictive model was successfully built, were acquired. It was found that (i) serum samples from early stage EOC patients were well separated from healthy controls in PCA (FIG. 7C) and (ii) early stage EOC patients exhibited higher p-EOC values than healthy controls when employing our model (FIG. 8C). To confirm statistical robustness, potential outliers identified by our SOP among the spectra for the 100 specimens were not excluded for the independent validation (see above). The operating characteristics were estimated at 95% specificity (95% CI: 86% to 99.5%), 68% sensitivity (95% CI: 53% to 80%) and an AUC of 0.949 (FIG. 9B).

To test the specificity of the model on cancer type, the model was applied to spectra recorded with identical experimental protocols for 66 serum specimens (obtained from RPCI) from women with renal cancer carcinoma (“RCC”) and their controls. Ten false positives (15%) were identified, which is not significantly different (p=0.47) than for EOC (11% for combined test and validation sets). Hence, RCC NMR profiles were not incorrectly diagnosed as early stage EOC.

Metabolites were identified for which significant (p-value<0.02) changes in concentrations are observed when comparing the averaged spectra from EOC and healthy control specimens. ¹H resonance assignments for metabolites (see also, http://www.hmdb.ca) for which significantly lower or higher concentrations were observed when comparing the spectra from early stage EOC and healthy control specimens are shown in FIG. 6. Lower concentrations are observed, for alanine (p-value=3.48×10⁻¹⁸), the choline moiety of phospholipids (4.44×10⁻²²), creatine/creatinine (<2.0×10⁻⁹), ‘LDL1’ representing CH3(CH2)n of lipid mainly in LDL (1.13×10⁻²⁶), CH2CH2CH2CO of lipid mainly in VLDL (5.37×10⁻⁴), =CHCH2CH2 of unsaturated lipid (2.09×10⁻⁴), valine (6.64×10⁻⁹), ‘VLDL1’ representing CH3CH2CH2C= of lipid mainly in VLDL (8.71×10⁻⁶). Higher concentrations are observed for acetoacetate (1.16×10⁻⁹), acetone (1.69×10⁻⁵), and β-hydroxybutyrate (1.07×10⁻⁸).

Inspection of the loading plots of the principal components used to build the predictive model confirmed that the signals arising from these metabolites contribute significantly to class separation. Upon onset of EOC, decreased concentrations are registered, for alanine (resonance lines contribute to PC1 of the predictive model), CH3CH2CH2C= of lipid (mainly in very-low density lipoproteins, VLDL) (PC2), CH3(CH2)n of lipid (mainly in low-density lipoproteins, LDL) (PC2), valine (PC2), creatine/creatinine (PC2), choline of phospholipids (PC1), CH2CH2CH2CO of lipid (mainly in VLDL) (PC2) and =CHCH2CH2 of unsaturated lipid (PC2). On the other hand, higher concentrations are registered for β-hydroxybutyrate (PC1, 3, and 4), acetone (PC1, 3, and 4), and acetoacetate (PC1, 3, and 4). These preliminary findings can be qualitatively compared with concentration profile changes that were described for NMR-based metabonomic studies of serum specimens from patients with other types of cancer. As for early stage EOC, (i) lower VLDL and LDL serum concentrations were associated with human hepatocellular carcinoma and liver cirrhosis, (ii) lower alanine, valine and creatine serum concentrations were observed for oral cancer, and (iii) increased acetoacetate and β-hydroxybutyrate serum concentrations were associated with colorectal cancer. It has been suggested that increased ketone body concentrations in serum can be linked to lypolysis as an alternative route for energy production by tumor cells. It is evident that only a quantitative comparison can reveal to which extent which types of cancer are detected as false positives when a predictive model for a given type of cancer is employed. Remarkably, the instant model for EOC diagnosis did not identify patients with RCC as false positives, which is consistent with the fact that qualitatively different metabolite concentration changes were associated with RCC when compared with early stage EOC (e.g., the acetoacetate serum concentration was found to be lower than in healthy controls).

The detection of the early, asymptomatic invasive stage I/II of EOC has a profound impact on clinical outcome. While there are currently no screening strategies with proven efficacy for early stage EOC detection available, several ovarian cancer screening trials are on-going. Those are based on transvaginal ultrasound, or serum concentration of CA125 combined with transvaginal ultrasound as part of a multimodal screening strategy. Although the search for a single biomarker continues, it is more likely that either a panel of several biomarkers and/or a “fingerprint” of easily accessible biofluids will ultimately prove useful for early stage EOC detection. For example, the combination of six markers (leptin, prolactin, osteopontin, insulin-like growth factor 2, macrophage inhibitory factor and CA125) exhibited significantly better discrimination compared with CA125 alone.

Multi-Variate Data Analysis

Analysis of Spectra Recorded for Renal Cell Cancer (RCC) Samples

NMR spectra were acquired for 66 specimens from female RCC patients and processed as described above for the EOC study. The predictive EOC model was applied. Ten specimens (15%) resulted in positive tests: 2 of 29 healthy controls (7%) and 8 of 37 RCC patients (22%), which is not a statistically significant difference (Fisher p=0.17). The overall false positive rate (10 of 66, 15%) is not statistically significantly different (p=0.47) from the overall false positive rate in the EOC study (10 of 94, 11%).

Relationship Between Sensitivity (Sns), Specificity (Spc), Prevalence (Pry), and Positive Predictive Value (PPV)

Bayes Rule, a simple equation regarding conditional probabilities, relates these four quantities so that one can be determined from the other three: PPV=Spc*Pry/(Spc*Pry+(1−Sns)*(1−Pry)). The sensitivity (i.e., the probability of a positive test result given a sample from an early stage EOC patient) and the specificity (i.e., the probability of a negative test result given a sample from a healthy control) can be directly estimated from a case-control study. To compute the PPV it is necessary to know also the prevalence of the disease. Table 11 displays the PPV for a variety of combinations of sensitivity and specificity and three different risk populations. Standard confidence intervals for the sensitivity and specificity can be transformed to a confidence interval for PPV via the multivariate delta method. In a population at 20-fold risk of EOC (i.e. slightly less than the risk of BRCA2 carriers) over the general population ( 1/100) a test with 80% sensitivity and 90% specificity yields a PPV of 7.5% i.e. 13 positive screens per EOC. At even higher risks e.g. 3/100 (i.e., 67-fold over the general population, slightly less than BRCA1 carriers), even a test with 50% sensitivity and 86% specificity has a 10% PPV.

Table 11 shows the operating characteristics of predictive models built with (a) CPMG bin arrays (‘CPMG’), (b) NOESY bin arrays (‘NOESY’) alone, and (c) concatenated CPMG and NOESY bin arrays (‘joint’). The area under the ROC Curve (AUC) measures the quality of predictive model based on the p-EOC computed for each spectrum. AUC values are similar for the three predictive models with the joint model being slightly superior when compared with the separate models for both the Test Set and Validation Set. Alternatively we can dichotomize p-EOC at an arbitrary ‘cut-point’ to provide a binary (‘+’/‘−’) decision rule and compute the specificity (probability of correctly identifying a healthy control) and sensitivity (probability of correctly identifying an early stage EOC). For this table the prevalence of disease was used as the cut-point (40/88 in the Test Set; 50/100 in the Validation Set).

TABLE 11
Operating characteristics of predictive models

| CPMG | | NOESY | | Joint | |
|---|---|---|---|---|---|
| Healthy | Early | Healthy | Early | Healthy | Early |
| Control | Stage EOC | Control | Stage EOC | Control | Stage EOC |

Test Set

| AUC | .715 | | .763 | | .796 | |
|---|---|---|---|---|---|---|
| Healthy Control | 36 | 19 | 33 | 13 | 35 | 15 |
| Early Stage EOC | 8 | 21 | 11 | 27 | 9 | 25 |
| Specificity | 82% | | 75% | | 80% | |
| Sensitivity | | 53% | | 68% | | 63% |

Validation Set

| AUC | .905 | | .934 | | .949 | |
|---|---|---|---|---|---|---|
| Healthy Control | 48 | 16 | 50 | 17 | 49 | 13 |
| Early Stage EOC | 2 | 34 | 0 | 33 | 1 | 37 |
| Specificity | 96% | | 100% | | 98% | |
| Sensitivity | | 68% | | 66% | | 74% |

Table 12 shows the positive predictive value (PPV) as a function of incidence, specificity and sensitivity. PPVs below the solid line in the table are above the threshold of 10%, which is considered a lower bound for clinical applications.

TABLE 12
Positive predictive value

| | | Positive Predictive Value | | | | | | | | |
|---|---|---|---|---|---|---|---|---|---|---|
| Incidence Rate | | 45 | | | 100 | | | 3000 | | |
| (per 100,000) | | General Population | | | High Risk | | | Higher Risk | | |
| | Sensitivity | 50% | 80% | 100% | 50% | 80% | 100% | 50% | 80% | 100% |
| Specificity | 80% | 0.1% | 0.2% | 0.2% | 0.2% | 0.4% | 0.5% | 7.2% | 11.0% | 13.4% |
| | 90% | 0.2% | 0.4% | 0.4% | 0.5% | 0.8% | 1.0% | 13.4% | 19.8% | 23.6% |
| | 95% | 0.4% | 0.7% | 0.9% | 1.0% | 1.6% | 2.0% | 23.6% | 33.1% | 38.2% |
| | 97% | 0.7% | 1.2% | 1.5% | 1.6% | 2.6% | 3.2% | 34.0% | 45.2% | 50.8% |
| | 99% | 2.2% | 3.5% | 4.3% | 4.8% | 7.4% | 9.1% | 60.7% | 71.2% | 75.6% |
| | 99.6% | 5.3% | 8.3% | 10.1% | 11.1% | 16.7% | 20.0% | 79.4% | 86.1% | 88.5% |
| | 99.8% | 10.1% | 15.3% | 18.4% | 20.0% | 28.6% | 33.4% | 88.5% | 92.5% | 93.9% |

Multivariate Data Analysis—Set 2

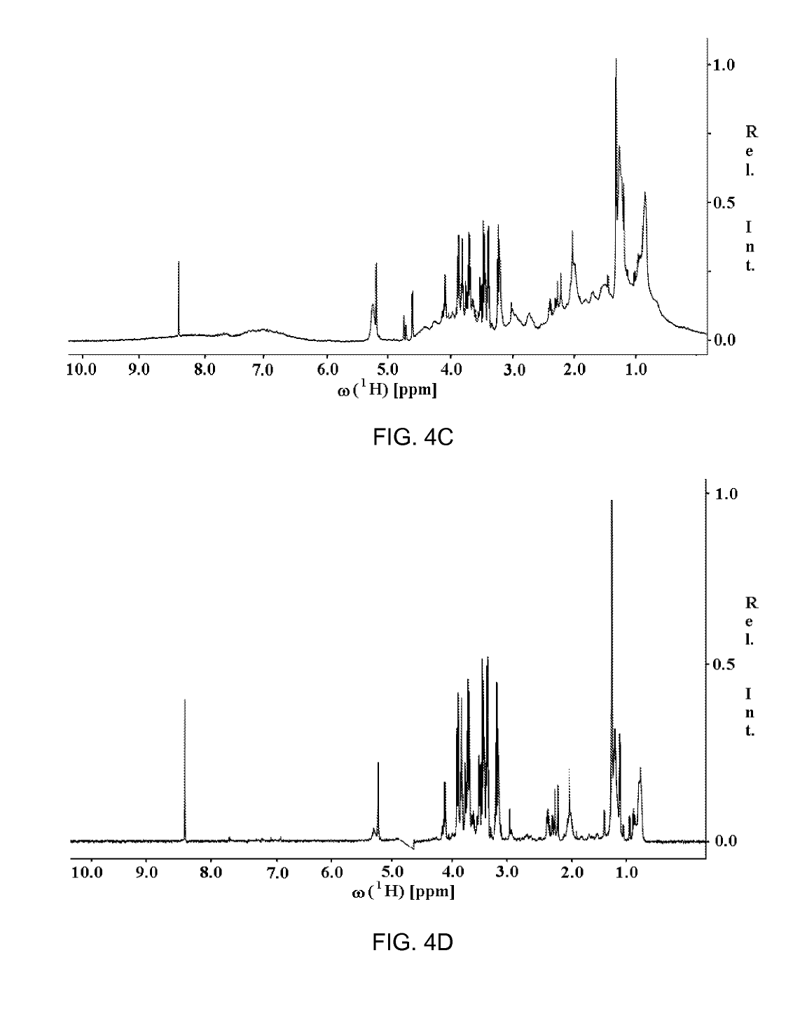

Multivariate Data Analysis was applied to the spectra to differentiate between healthy control women and cancer patients. As an example, FIG. 5 displays the score plot of the first two principal components computed from 166 ‘Pareto-scaled’ 1D-NOESY spectra. A score plot displays high dimensional data in the two dimensions of maximum variation. Visually, the Normals are on the right (positive first Principal Component) and the Cancers are on the left (negative first Principal Component). Simple models result in 70% classification accuracy in independent test data. 166 of 343 spectra were selected and analyzed by PCA and logistic regression. These 166 were all the Cancer samples and the Normal samples that did not have anomalous spectra. Spectra were binned to 0.004 ppm between 8.00 and 0.00 excluding the water peak (5.10, 4.34). Bins were mean centered and Pareto-scaled prior to PCA. Logistic regression models were used to predict class (Cancer, Normal) using the first k principal components. The number of components k was selected by minimizing the Akiake Information Criterion (“AIC”).

One classification procedure was developed as follows.
NMR spectra for Cancer and Normals were visually evaluated for outliers with an overlay plot. Outliers removed.
Each NMR spectrum was normalized to unit area and then converted to 1810 variables by binning (binwidth=0.004 ppm. Bins cover range 8.00 to 0.00 excluding the water peak (5.10, 4.34).
Each bin was mean-centered and Pareto-scaled.
Standard PCA was computed. First 10 PCs graphed to discover outliers. Outliers removed. [166 spectra remained]

PCA was recomputed on reduced data set. PCA is used to summarize the relationships among the different regions of the spectrum. It is an unsupervised method (i.e., analysis performed without use of knowledge of the sample class) that (1) reduces the dimensionality of the data input while (2) expressing much of the original high-dimensional variance in a low-dimensional map. This is accomplished through a statistical grouping of variables (in this case spectral signals) that have strong correlations with one another into a smaller set of variables known as factors or components. The components themselves are not correlated and thus represent distinct patterns of metabolic signals. Principal Components are formed from optimal linear combinations of the original spectra and include the maximum variation in the fewest number of components.

Logistic regression was used to predict sample class (Cancer or Normal) based on the first PC. If the coefficient of the first PC was statistically significant (Wald test), the model was refit with two PCs. This stepwise procedure was continued until adding a PC did not result in a statistically significant coefficient.

The accuracy of the model was estimated by splitting the original dataset into two datasets, Training and Test. The above steps were carried out on only the Training dataset. The resulting model was used to make predictions (Cancer or Normal) on each spectrum in the Test dataset. Accuracy was measured as the number of correct predictions out of all predictions.

PCA with Logistic Regression is a routine statistical method that is able to classify correctly are high percentage of early-stage ovarian cancer patients and healthy controls. Other more advanced multivariate statistical methods also have discriminating power that could be substituted for the statistical method used here. For example, we have Partial Least Square-Discriminant Analysis (“PLS-DA”), orthogonal signal corrected PLS-DA, and hierarchical cluster analysis could provide potentially similar results. Other machine learning algorithms such as support vector machines, genetic algorithms, and so on can also be used to classify the samples.

All statistical analyses were performed in R (R Development Core Team, http://www.R-project.org). Additional R packages used include pls, ellipse, chemometrics, epicalc, and multcomp.

Based on the evidence that the NMR spectral profiles allow accurate diagnosis of early stage ovarian cancer, NMR signals assignments allow identification of metabolites ‘driving’ the statistical separation. This paves the way to establish non-NMR based assays to diagnose early stage ovarian cancer.

Techniques to diagnose ovarian cancer can be used to monitor a patient's response to cancer treatment. Techniques to diagnose ovarian cancer can be used to monitor a patient's response to cancer treatment.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of generating a predictive model for diagnosing early-stage epithelial ovarian cancer using a plurality of biological samples, each sample being taken from a different individual having a known disease state of either diseased (“EOC”), benign ovarian cyst (“benign”), or healthy (“healthy”), the method comprising the steps of:
obtaining a mass spectrum of each of the plurality of biological samples;
segmenting each spectrum along the mass-to-charge axis to provide a plurality of bins;
determining a plurality of relationships between two or more groups of bins, each group of bins comprising one or more bins;
identifying one or more statistically significant factors based on the plurality of relationships; and
generating a predictive model, wherein the predictive model is a function of the one or more factors.

2. The method of claim 1, further comprising the steps of:
obtaining a set of one or more types of nuclear magnetic resonance (“NMR”) frequency domain spectra of each of the plurality of biological samples;
segmenting the frequency domain spectra to provide a plurality of bins; and
wherein the plurality of relationships between two or more groups of bins is determined using both the mass spectrum bins and the NMR spectra bins.

3. The method of claim 2, wherein the NMR spectra are obtained using one or more 1D NMR experiments and/or 2D NMR experiments.

4. The method of claim 3, wherein the 1D NMR spectra are selected from the group consisting of DIRE, DOSY, skyline projection of 2D J-resolved, CPMG, and NOESY.

5. The method of claim 3, wherein the 2D NMR spectra are selected from the group consisting of 2D J-resolved and TOCSY.

6. The method of claim 1, further comprising the step of mean-centering and Pareto-scaling the plurality of bins.

7. The method of claim 1, wherein the plurality of relationships is determined using principal component analysis.

8. The method of claim 7, wherein the step of determining a plurality of relationships between two or more groups of bins further comprises the sub-step of determining a plurality of relationships between two or more groups of bins from the biological samples of the EOC and healthy individuals.

9. The method of claim 7, wherein the step of determining a plurality of relationships between two or more groups of bins further comprises the sub-step of determining a plurality of relationships between two or more groups of bins from the biological samples of the EOC and benign individuals.

10. The method of claim 7, wherein the step of determining a plurality of relationships between two or more groups of bins further comprises the sub-step of determining a plurality of relationships between two or more groups of bins from the biological samples of the healthy and benign individuals.

11. The method of claim 1, wherein the plurality of relationships is determined using partial least squares discriminant analysis.

12. The method of claim 1, wherein the one or more statistically significant factors are identified using logistic regression.

13. The method of claim 1, further comprising the steps of confirming the predictive model using a second plurality of biological samples from individuals having a known disease states.

14. A method of identifying the presence or absence of early-stage epithelial ovarian cancer (“EOC”) indicated by a biological sample, the method comprising the steps of:
receiving a pre-determined model capable of predicting whether the biological sample indicates EOC, benign ovarian cysts, or neither EOC nor benign ovarian cysts, wherein the model is based on segmented bins of mass spectra data and the model comprises a set of predictive factors;
obtaining a mass spectrum of the biological sample;
segmenting the spectrum along the mass-to-charge axis to provide a plurality of bins corresponding to the bins of the model to generate a sample vector; and
applying the predictive factors of the pre-determined model to the sample vector in order to identify the presence or absence of early stage EOC indicated by the biological sample.

15. The method of claim 14, wherein the pre-determined model is further based on segmented bins of NMR frequency domain spectra, and the method further comprising the steps of:
obtaining a set of one or more types of NMR frequency domain spectra of the biological sample; and
segmenting the frequency domain spectra to provide a plurality of bins corresponding to the NMR bins of the model.

16. The method of claim 14, further comprising the step of identifying the biological sample as indicating EOC, benign ovarian cysts, or neither EOC nor benign ovarian cysts.

17. The method of claim 14, wherein the received pre-determined model was generated using a method according to claim 1.

18. The method of claim 14, wherein the received pre-determined model was generated using PCA and logistic regression and the step of applying the predictive factors to the sample vector comprises the substep of multiplying the predictive model by the sample vector.
